(19) United States
(12) Patent Application Publication
(10) Pub. No.: US 2025/0054310 A1
(43) Pub. Date: Feb. 13, 2025

(54) SYSTEM AND METHODS FOR SELF-SERVICE SETUP OF MONITORING OPERATIONS IN AN AREA OF REAL SPACE

(71) Applicant: Standard Cognition, Corp., San Francisco, CA (US)

(72) Inventors: Aniruddha MARU, San Ramon, CA (US); Namrata PARIKH, Sammamish, WA (US); Luis Yoich MORALES SAIKI, Fremont, CA (US); Nagasrikanth KALLAKURI, Dublin, CA (US); David WOOLLARD, Highland Park, IL (US); Peter RENNERT, Dunblane, Scotland (GB)

(73) Assignee: Standard Cognition, Corp., San Francisco, CA (US)

(21) Appl. No.: 18/799,962

(22) Filed: Aug. 9, 2024

Related U.S. Application Data
(60) Provisional application No. 63/532,282, filed on Aug. 11, 2023.
(60) Provisional application No. 63/532,277, filed on Aug. 11, 2023.

(51) Int. Cl. G06V 20/52; G06Q 10/087; G06T 7/80; G06V 10/25

(52) U.S. Cl. CPC G06V 20/52; G06Q 10/087; G06T 7/80; G06V 10/25

(57) ABSTRACT

The technology disclosed teaches systems and methods for self-service installation of monitoring operations in an area of real space, the method including scanning the area of real space to generate a 3D representation of the area of real space, placing a camera at an initial location and orientation for monitoring a zone within the area of real space, configuring a computing device to be connected to a cloud network hosting an image processing service and couplable to the camera, coupling the camera to the computing device via a local connection using a unique identifier associated with the camera, and finetuning the camera placement to a calibrated location and orientation, wherein the finetuning is assisted by information received from a cloud-based application associated with the image processing service.

### PRIORITY APPLICATION

This application claims the benefit of U.S. Provisional Patent Application No. 63/532,282 filed 11 Aug. 2023 and U.S. Provisional Patent Application No. 63/532,277 filed 11 Aug. 2023. Both Provisional applications are incorporated herein by reference.

### BACKGROUND

### Field

The present invention relates to systems for self-service setup of monitoring operations within an area of real space.

### Description of Related Art

Technologies have been developed to apply image processing to monitor areas of real space and detect events occurring within a monitored area. Computer vision-based monitoring systems are being deployed in commercial environments such as retail stores, shipping operations, and banking, as well as residential use for “smart home” Internet-of-Things (IoT) systems. Image processing systems and methods can be leveraged in a range of security and surveillance applications as well.

One or more cameras (or alternatively, 2D and 3D sensors) with corresponding fields of view can monitor an area of real space and events occurring within the area of real space, as described above. Positioning of cameras installed in a real space is subject to variability due to various factors (e.g., errors in measurement, inaccuracies in tools, errors by installers, etc.). Further, because one or more cameras can drift and monitored environments change over time, cameras may need to be recalibrated. The cameras need to be accurately calibrated for the correct processing of images, Therefore, an opportunity arises to develop systems and methods to install cameras, including placement, configuration, and calibration of cameras during installation, as well as to update the placement, configuration, or calibration of the cameras without impacting the operations of the monitoring system. Setting up cameras in the area of real space as well as updating cameras or sensors can require considerable effort and time.

For example, in retail stores, image processing and monitoring systems and methods can be deployed to improve monitoring of the store's inventory stocking operations, such as maintaining a consistent organization scheme for the location of respective inventory items and tracking inventory item stock levels for identification of low and out of stock items. Processing interactions between inventory items and subjects, tracking the location and quantity of items on inventory displays, and identifying items that are incorrectly stocked, low in stock, out-of-stock, and other poor shelf conditions require processing logic and reliable communication network. Therefore, a monitoring system for the area of real space requires setup of various subsystems or processing components to operate. In some cases, the setup and operations of the monitoring system for the area of real space may not be possible due to lack of availability of required human or technological resources.

It is desirable to provide a technology that solves technological challenges to effectively and automatically setup the monitoring system for the area of real space. It is also desirable to provide the technology that can automatically setup monitoring operations with minimal human intervention.

### SUMMARY

A system, and method for self-service installation of a monitoring system in an area of real space is described. The disclosed method can include scanning the area of real space to generate a 3D representation of the area of real space. For a region within the area of real space, the method further includes placing a camera at an initial location and orientation for monitoring the region within the area of real space, configuring a computing device to be (i) connected to a cloud network hosting an image processing service and (ii) couplable to the camera via a local connection, wherein the configuring enables the computing device to mediate communications between the image processing service and the camera, coupling the camera to the computing device in dependence upon the local connection and a unique identifier associated with the camera, and calibrating the camera to a calibrated location and orientation, wherein the calibrating is assisted by information received from a cloud-based application associated with the image processing service.

A system including one or more processors and memory accessible by the processors is also described. The memory can be loaded with computer instructions which can be executed on the processors. The computer instructions when executed on the processors can implement the method for self-service installation of a monitoring system in an area of real space is described. Computer program products which can be executed by computer systems are also described herein.

Other aspects and advantages of the present invention can be seen on review of the drawings, the detailed description and the claims, which follow.

### BRIEF DESCRIPTION OF THE DRAWINGS

FIG. 1 illustrates an architectural level schematic of a system in which a self-service engine implements self-service logic to setup monitoring operations in an area of real space.

FIG. 2A is a side view of an aisle in a store illustrating a camera arrangement.

FIG. 2B is a perspective view of a subject interacting with items on shelves in an inventory display structure in the area of real space.

FIG. 3 illustrates a 3-D and a 2-D view of an inventory display structure (or a shelf unit).

FIG. 4A illustrates input, output and convolution layers in an example convolutional neural network to classify joints of subjects in sequences of images.

FIG. 4B is an example data structure for storing joint information.

FIG. 5A presents visualizations showing all possible camera locations in an area of real space.

FIG. 5B presents an example multi-camera environment in which the cameras can be calibrated using the camera calibration engine (or camera calibration tool) of FIG. 1.

FIG. 6 presents example operations for extrinsic camera calibration.

FIGS. 7A and 7B present examples of images from two cameras with overlapping fields of view.

FIG. 8 is an example of using Fiducial markers to calibrate cameras.

FIG. 9 shows selected lines across two images from two separate cameras or sensors that indicate a successful match of feature descriptors between the two images.

FIG. 10 is a flowchart presenting detailed process operations for the camera calibration process of FIG. 6.

FIG. 11A presents two images taken from the same sensor at different times indicating drift of the camera.

FIG. 11B presents selected lines indicating successful matching of feature descriptors across two images.

FIG. 12 presents an example data structure for storing a subject including the data of associated joints.

FIG. 13A is a flowchart for calibrating cameras and tracking subjects by the system of FIG. 1.

FIG. 13B is a flowchart showing more detailed operations for a camera calibration operation of FIG. 13A.

FIG. 13C is a flowchart presenting process operations for using extrinsic calibration tool to perform initial calibration of cameras in the area of real space.

FIGS. 14, 15A, and 15B are flowcharts showing detailed operations for a video process operation of FIG. 13A.

FIG. 16A is an example architecture for combining an event stream from location-based put and take detection with an event stream from region proposals-based (WhatCNN and WhenCNN) put and take detection.

FIG. 16B is an example architecture for combining an event stream from location-based put and take detection with an event stream from semantic diffing-based put and take detection.

FIG. 16C shows multiple image channels from multiple cameras and coordination logic for the subjects and their respective shopping cart data structures.

FIG. 16D is an example data structure including locations of inventory caches for storing inventory items.

FIG. 17 is a flowchart illustrating process operations for identifying and updating subjects in the real space.

FIG. 18 is a flowchart showing process operations for processing hand joints (or moving inventory caches) of subjects to identify inventory items.

FIG. 19 is a flowchart showing process operations for a time series analysis of the inventory items per hand joint (or moving inventory cache) to create a shopping cart data structure per subject.

FIG. 20 is a flowchart presenting process operations for detecting proximity events.

FIG. 21 is a flowchart presenting process operations for detecting an item associated with the proximity event detected in FIG. 21.

FIG. 22 is a process flowchart presenting operations for setting up and operating one or more cameras configured for performing monitoring tasks, such as inventory stock monitoring.

FIG. 23A is a process flowchart presenting an installation process associated with setting up and operating the one or more cameras configured to perform monitoring tasks, such as inventory stock monitoring.

FIG. 23B is a schematic diagram of an out-of-stock detection process.

FIG. 23C is a schematic diagram of a region-of-interest update process.

FIG. 23D is a block diagram for example on-premise software architecture.

FIG. 23E is a schematic diagram of an example on-premise hardware configuration.

FIG. 23F is a schematic diagram of an example setup process involving a third party installer.

FIG. 24 is an example of a computer system architecture implementing the proximity events detection logic.

FIG. 25 illustrates an architectural level schematic of a system configured for tracking subjects and items in an area of real space, wherein the system is further configured to verify ages of the subjects in relation to items associated with age restrictions.

FIG. 26 is a hardware arrangement configured for hosting the subject re-identification engine of FIG. 25.

FIGS. 27 and 28 show a side view and top view, respectively, of an aisle in a store illustrating a subject with a mobile computing device and a camera arrangement.

FIG. 29 is an entity-relationship diagram describing the relationship between entities interacting with the subject age verification engine of FIG. 25.

FIG. 30A is a flow chart describing a method for verifying the age of a subject.

FIG. 30B is a flow chart describing a method for managing subject access to an age-restricted function.

FIGS. 31A, 31B, 31C and FIG. 32 show example user interfaces for subject age verification while shopping.

FIG. 33 is a hardware arrangement configured for hosting the subject age verification engine of FIG. 25.

FIG. 34 is a flow chart describing a method for injecting items into a subject inventory cache.

FIG. 35 is a schematic diagram describing a method for injecting items into a subject inventory cache.

FIG. 36A shows an example cart injection interface for use by a customer service representative device.

FIG. 36B shows an example cart injection interface for use by a subject device.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown but is to be accorded the widest scope consistent with the principles and features disclosed herein.

System Overview: Self-Service Logic to Set Up and Operate Monitoring of Inventory within a Shopping Store

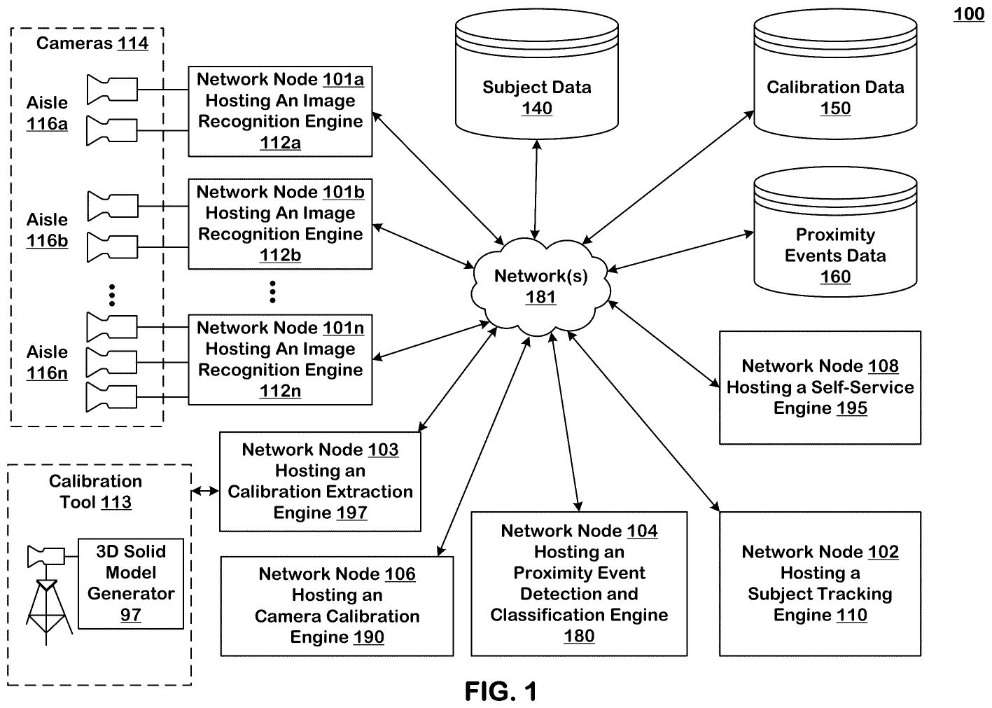

A system and various implementations of the setup and operations of a store are described with reference to FIGS. 1-24. The system and processes are described with reference to FIG. 1, an architectural level schematic of a system in accordance with an implementation. Because FIG. 1 is an architectural diagram, certain details are omitted to improve the clarity of the description.

FIG. 1 provides a block diagram level illustration of a system 100. The system 100 includes cameras 114, network nodes hosting image recognition engines 112a, 112b, and 112n, a subject tracking engine 110 deployed in a network node 102 (or nodes) on the network, a proximity event detection and classification engine 180 deployed in a network node 104 (or nodes), a camera calibration engine 190 deployed in a network node (or nodes) 106, a self-service engine 195 deployed in a network node (or nodes) 108, a calibration extraction engine 197 deployed in a network node (or nodes) 103, a subject database 140, a calibration database 150, a proximity (or location) events database 160 and a communication network or networks 181. The network nodes can host only one image recognition engine, or several image recognition engines as described herein. Also depicted is an external calibration tool 113 comprised of portable camera(s) and coupled 3D solid model generator 97. The network node 103 hosts the calibration extraction engine 197 that determines calibration information including positions of cameras 114 using 3D point cloud information from 3D solid model generator 97 of calibration tool 113. Calibration tool 113 can be a commercially available tool such as Matterport or the like. The system also includes a database containing feature descriptors and keypoints (not shown in FIG. 1) and a camera coverage maps database (not shown in FIG. 1). The system can also include other databases such as a layout and maps database, an inventory database, a catalog database, a joints heuristics database and other supporting data. The system can include additional processing engines such as a camera placement engine (not illustrated) implementing logic to determine placement of cameras in the area of real space given the map of the area of real space including constraints such as structures on the ceiling where cameras cannot be placed. Examples of constraints can include places in the area of real space where lighting fixtures, air conditioning and heating pipes and vents are located. Cameras cannot be placed at such places and therefore, the camera placement technique does not place cameras at such places when generating camera placement plan. The self-service engine 195 implements the logic to use a camera placement plan generated by the camera placement generation engine for an area of real space for placement of cameras in the area of real space. The cameras once placed or installed in the area of real space are then automatically calibrated using the camera calibration engine 190.

As used herein, a network node is an addressable hardware device or virtual device that is attached to a network, and is capable of sending, receiving, or forwarding information over a communications channel to or from other network nodes, including channels using TCP/IP sockets for example. Examples of electronic devices which can be deployed as hardware network nodes having media access layer addresses, and supporting one or more network layer addresses, include all varieties of computers, workstations, laptop computers, handheld computers, and smartphones. Network nodes can be implemented in a cloud-based server system. More than one virtual device configured as a network node can be implemented using a single physical device. For the sake of clarity, only three network nodes hosting image recognition engines are shown in the system 100. However, any number of network nodes hosting image recognition engines can be connected to the tracking engine 110 through the network(s) 181. Also, the image recognition engine, the tracking engine, the proximity event detection engine and other processing engines described herein can execute using more than one network node in a distributed architecture.

The interconnection of the elements of system 100 will now be described. The network(s) 181 couples the network nodes 101a, 101b, and 101n, respectively, hosting image recognition engines 112a, 112b, and 112n, the network node 102 hosting the tracking engine 110, the network node 103 hosting the calibration extraction engine 197, the network node 104 hosting the proximity event detection and classification engine 180, the network node 106 hosting the camera calibration engine 190, the network node 108 hosting the self-service engine 195, the subject database 140, the calibration database 150, the proximity events database 160, the feature descriptors and keypoints database (not shown in FIG. 1) and the camera coverage maps database (not shown in FIG. 1). Cameras 114 are connected to the tracking engine 110 through network nodes hosting image recognition engines 112a, 112b, and 112n. In one implementation, the cameras 114 are installed in a store (such as a supermarket) such that sets of cameras 114 (two or more) with overlapping fields of view are positioned over each aisle to capture images of real space in the store. In FIG. 1, two cameras are arranged over aisle 116a, two cameras are arranged over aisle 116b, and three cameras are arranged over aisle 116n. The cameras 114 are installed over aisles with overlapping fields of view. In such an implementation, the cameras are configured with the goal that customers moving in the aisles of the store are present in the field of view of two or more cameras at any moment in time. The calibration tool 113 is connected to the network node 103 hosting the calibration extraction engine 197.

The technology disclosed presents a self-service method for setting up and calibrating the cameras in the area of real space to support monitoring of inventory stock (i.e., qualitative and quantitative monitoring) within a store. The self-service method can be used by the management of a store to convert their existing store (or a new store) to deploy monitoring. The self-service method can be used to setup monitoring in a store in any location with minimal effort and time. For example, the technology disclosed can be used to setup monitoring in a store in a permanent location as well as to setup monitoring in a store in temporary locations such as at a fair, conference, etc. The self-service engine 195 can use the camera placement map generated by the camera placement engine to identify to the store management the locations for installing cameras or other types of sensors in the area of real space. The camera placement engine can access the floor plan and layout plan of an area of real space from the maps database. The self-service engine 195 can use the physical constraints and maps of the area of real space to generate an optimized camera placement plan. The technology disclosed can generate a plurality of camera placement plans and the store management can select one of the camera placement plans for installing cameras in the area of real space. The store management can install the cameras on ceiling or other structures that are fixedly attached to the floor, ceiling, walls, etc. at the locations identified in the camera placement plan.

After the cameras are installed according to the camera placement plan, the self-service engine 195 can invoke the camera calibration engine 190 and the camera calibration extraction engine 197 to calibrate and/or recalibrate the cameras installed in the area of real space. The technology disclosed can automatically calibrate or re-calibrate cameras without disrupting operations of the store or the monitoring operations. After the cameras are installed and calibrated, the technology disclosed includes logic to process images captured by the cameras to track subjects in the area of real space and detect actions performed by the tracked subjects such as takes of items and puts of items on shelves or other types of inventory display structures.

The technology disclosed can also be leveraged to deploy monitoring within an area of real space for a store. The cameras 114 of system 100 can be placed to monitor one or more particular regions of interest (also referred to as zoned monitoring). A region of interest is a 3D space on an inventory display structure, such as a shelving unit, in which respective inventory items (i.e., a particular inventory item being identified by a stock keeping unit (SKU) identifier; herein, inventory items may be referred to synonymously by their corresponding SKU are expected to be stocked at certain locations. The region of interest, for example, may be represented as a bounding box within an image plane of a camera 114, associated with the expected SKU within the bounding box as populated by visual verification or a planogram.

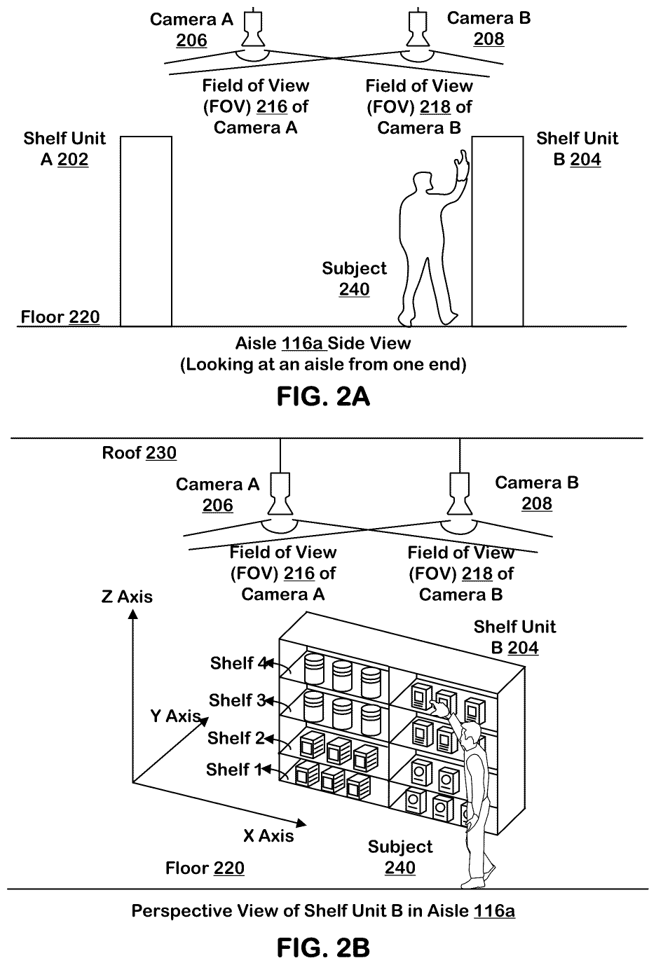

The inventory items, identified by corresponding SKUs, can be arranged in the retail store according to a planogram. The planogram is a map identifying a configuration of units of volume at a particular location which correlate with SKUs expected at the particular location on the inventory display structures in the area of real space. Each unit of volume can be defined, for example, by starting and ending positions along three axes of real space. Planograms can be 2D or 3D. Planograms can store locations of all inventory display structure locations, expected SKU locations, and other locations within the store such as entrances and exits. The items in the store can be arranged, in some implementations, according to a planogram which identifies the inventory locations (such as locations on shelves) on which a particular item is planned to be placed. For example, as shown in FIG. 2B, a left half portion of shelf 3 and shelf 4 are designated for a SKU (which is stocked in the form of cans).

The technology disclosed can be implemented for planogram compliance, or monitoring associated with processing the true inventory stock states within one or more monitored regions of interest and the corresponding planogram for the one or more monitored regions of interest. For example, the planogram compliance can comprise the generation of a report including data associated with the number of regions of interest that are correctly stocked (as defined by the expected SKU(s) within the one or more regions) or incorrectly stocked, one or more SKUs or regions of interest identified as containing a stocking discrepancy from the planogram, and/or other data associated with poor shelf conditions such as incorrectly stocked items, low stock items, or out of stock items.

The technology disclosed can be deployed to detect empty facing regions of interest, wherein an empty facing region of interest is a region of interest that is not stocked with a SKU. The technology disclosed can be deployed to detect out-of-stock SKUs, wherein an out-of-stock SKU is detected in response to all expected facings of a particular SKU in a store are determined to be empty facing. In many implementations of the technology disclosed, one or more types of data obtained in association with the monitoring operations are presented towards a user, such as an employee or a manager of the store, via a graphical display. The user can be notified, via the graphical display, of one or more detected states within the store, such as incorrectly stocked or out-of-stock SKUs.

In one implementation, the self-service engine 195 can be used to setup and operate monitoring within a store without having access to the Internet at the location of the store. In such an implementation, the subject tracking and action detection or inventory events data are stored in a local data storage at the location of the store. In some cases, selected videos or images of from the videos can also be stored at the local data storage. In such an implementation, the data stored is anonymized such as by blurring or removing portions of images or videos which correspond to facial data of the subject tracked in the area of real space. The anonymized data is then provided in a memory stick or another type of data storage device to another location which has Internet. The technology disclosed can then process the locally stored data in a batch at the end of the day or during the day.

Cameras 114 can be synchronized in time with each other, so that images are captured at the same time, or close in time, and at the same image capture rate. The cameras 114 can send respective continuous streams of images at a predetermined rate to network nodes hosting image recognition engines 112a-112n. Images captured in all the cameras covering an area of real space at the same time, or close in time, are synchronized in the sense that the synchronized images can be identified in the processing engines as representing different views of subjects having fixed positions in the real space. For example, in one implementation, the cameras send image frames at the rate of 30 frames per second (fps) to respective network nodes hosting image recognition engines 112a-112n. Each frame has a timestamp, identity of the camera (abbreviated as “camera_id”), and a frame identity (abbreviated as “frame_id”) along with the image data. Other implementations of the technology disclosed can use different types of sensors such as infrared image sensors, RF image sensors, ultrasound sensors, thermal sensors, Lidars, etc., to generate this data. Multiple types of sensors can be used, including for example ultrasound or RF sensors in addition to the cameras 114 that generate RGB color output. Multiple sensors can be synchronized in time with each other, so that frames are captured by the sensors at the same time, or close in time, and at the same frame capture rate. In all of the implementations described herein, sensors other than cameras, or sensors of multiple types, can be used to produce the sequences of images utilized. The images output by the sensors have a native resolution, where the resolution is defined by a number of pixels per row and a number of pixels per column, and by a quantization of the data of each pixel. For example, an image can have a resolution of 1280 columns by 720 rows of pixels over the full field of view, where each pixel includes one byte of data representing each of red, green and blue RGB colors.

Cameras installed over an aisle are connected to respective image recognition engines. For example, in FIG. 1, the two cameras installed over the aisle 116a are connected to the network node 101a hosting an image recognition engine 112a. Likewise, the two cameras installed over the aisle 116b are connected to the network node 101b hosting an image recognition engine 112b. Each image recognition engine 112a-112n hosted in a network node or nodes 101a-101n, separately processes the image frames received from one camera each in the illustrated example.

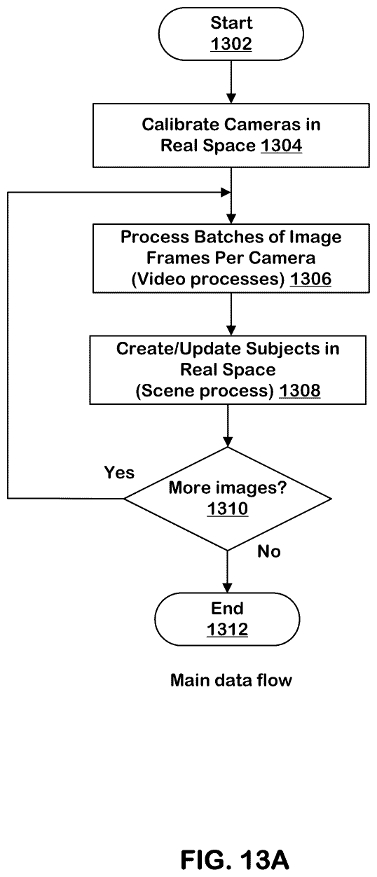

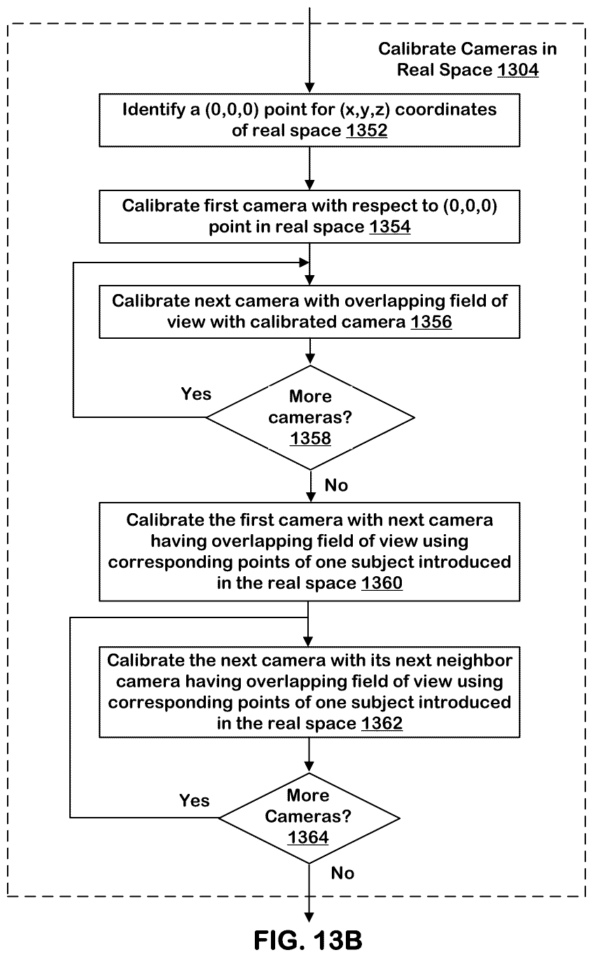

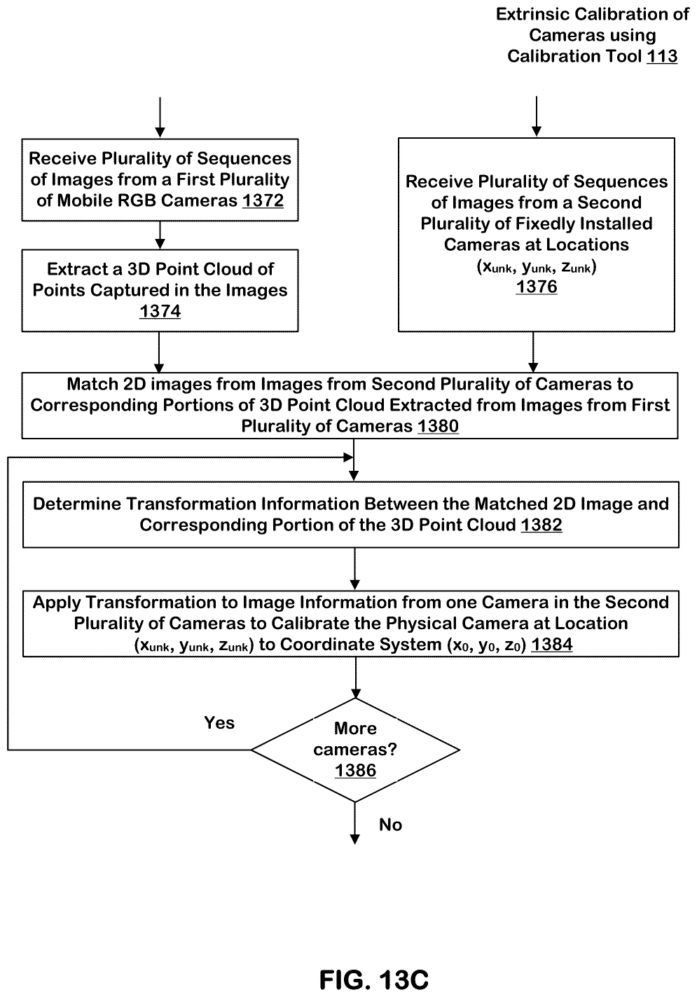

A challenge in operating monitoring systems within a store with a multiple-cameras setup is to make sure the cameras are always extrinsically calibrated. An example process for performing initial calibration of cameras in the area of real space is presented in FIG. 13B. An example process for using extrinsic calibration tool 113 to obtain positions of cameras in the area of real space to perform the initial calibration of cameras in the area of real space is presented in FIG. 13C. The calibration data can be stored in the calibration database 150. In real world environments the cameras drift from initial poses due to vibrations in the building, accidental displacement while cleaning, intentional displacement of the cameras, etc. In order to fix the displacement of the cameras, the current and most commonly used method is to perform calibration again for the entire store using fiducial markers to obtain the accurate calibration between the cameras. However, it is practically not possible to frequently perform the calibration using existing calibration techniques such as fiducial markers.

The technology disclosed includes a camera calibration engine (or camera calibration tool) 190 that includes logic to recalibrate cameras periodically. The system can maintain a global calibration of the system in the calibration database 150. As the one or more cameras drift, the system can recalibrate the drifted cameras and update the global calibration. The updated calibration data is then used for processing images from the cameras. The method for recalibration implemented by the technology disclosed can include processing one or more selected images selected from a plurality of sequences of images received from a plurality of cameras calibrated using a set of calibration images that were used to calibrate the cameras previously. Images in the plurality of sequences of images have respective fields of view in the real space. The method for recalibration can include the following processing operations. The method can include extracting a plurality of feature descriptors from the images. The one or more extracted feature descriptors from the selected images are matched with feature descriptors extracted from the set of calibration images that were used to calibrate the cameras previously. The system can store the images from a plurality of cameras in an image buffer or an image database. The recalibration method can calculate transformation information between the selected images and the set of calibration images that were used to calibrate the cameras previously. The transformation can be calculated using the matched feature descriptors. The recalibration method can then compare the transformation information as calculated with a threshold. The calibration of a camera can be updated with the transformation information whenever the transformation information for the camera meets or exceeds the threshold. The feature descriptors (or keypoints or landmarks) can correspond to points located at displays or structures that remain substantially immobile. Examples of structures in a real space can include inventory display structures such as shelves, bins, stands, etc. The feature descriptors can be extracted using existing techniques or a trained neural network classifier.

Referring back to FIG. 1, in one implementation, each image recognition engine 112a, 112b, and 112n is implemented as a deep learning algorithm such as a convolutional neural network (abbreviated CNN). In such an implementation, the CNN is trained using a training database. In an implementation described herein, image recognition of subjects in the real space is based on identifying and grouping joints recognizable in the images, where the groups of joints can be attributed to an individual subject. For this joints-based analysis, the training database has a large collection of images for each of the different types of joints for subjects. In the example implementation of a store, the subjects are the customers moving in the aisles between the shelves. In an example implementation, during training of the CNN, the system 100 is referred to as a “training system”. After training the CNN using the training database, the CNN is switched to production mode to process images of customers in the store in real time. In an example implementation, during production, the system 100 is referred to as a runtime system (also referred to as an inference system). The CNN in each image recognition engine produces arrays of joints data structures for images in its respective stream of images. In an implementation as described herein, an array of joints data structures is produced for each processed image, so that each image recognition engine 112a-112n produces an output stream of arrays of joints data structures. These arrays of joints data structures from cameras having overlapping fields of view are further processed to form groups of joints, and to identify such groups of joints as subjects.

The cameras 114 are calibrated before switching the CNN to production mode. The technology disclosed can include a calibrator including a logic to calibrate the cameras and store the calibration data in a calibration database.

The tracking engine 110, hosted on the network node 102, receives continuous streams of arrays of joints data structures for the subjects from image recognition engines 112a-112n. The tracking engine 110 processes the arrays of joints data structures and translates the coordinates of the elements in the arrays of joints data structures corresponding to images in different sequences into candidate joints having coordinates in the real space. For each set of synchronized images, the combination of candidate joints identified throughout the real space can be considered, for the purposes of analogy, to be like a galaxy of candidate joints. For each succeeding point in time, movement of the candidate joints is recorded so that the galaxy changes over time. The output of the tracking engine 110 is stored in the subject database 40.

The tracking engine 110 uses logic to identify groups or sets of candidate joints having coordinates in real space as subjects in the real space. For the purposes of analogy, each set of candidate joints is like a constellation of candidate joints at each point in time. The constellations of candidate joints can move over time. The logic to identify sets of candidate joints comprises heuristic functions based on physical relationships amongst joints of subjects in real space. These heuristic functions are used to identify sets of candidate joints as subjects. The heuristic functions are stored in a heuristics database. The output of the subject tracking engine 110 is stored in the subject database 140. Thus, the sets of candidate joints comprise individual candidate joints that have relationships according to the heuristic parameters with other individual candidate joints and subsets of candidate joints in a given set that has been identified, or can be identified, as an individual subject.

In the example of a store, shoppers (also referred to as customers or subjects) move in the aisles and in open spaces. The shoppers can take items from shelves in inventory display structures. In one example of inventory display structures, shelves are arranged at different levels (or heights) from the floor and inventory items are stocked on the shelves. The shelves can be fixed to a wall or placed as freestanding shelves forming aisles in the store. Other examples of inventory display structures include pegboard shelves, magazine shelves, lazy susan shelves, warehouse shelves, and refrigerated shelving units. The inventory items can also be stocked in other types of inventory display structures such as stacking wire baskets, dump bins, etc. The customers can also put items back on the same shelves from where they were taken or on another shelf. The system can include a maps database in which locations of inventory caches on inventory display structures in the area of real space are stored. In one implementation, 3D maps of inventory display structures are stored that include the width, height, and depth information of display structures along with their positions in the area of real space. In one implementation, the system can include or have access to memory storing a planogram identifying inventory locations in the area of real space and inventory items to be positioned on inventory locations. The planogram can also include information about portions of inventory locations designated for particular inventory items. The planogram can be produced based on a plan for the arrangement of inventory items on the inventory locations in the area of real space.

As the shoppers (or subjects) move in the store, they can exchange items with other shoppers in the store. For example, a first shopper can hand-off an item to a second shopper in the store. The second shopper who takes the item from the first shopper can then in turn put that item in her shopping basket or shopping cart, or simply keep the item in her hand. The second shopper can also put the item back on a shelf. The technology disclosed can detect a “proximity event” in which a moving inventory cache is positioned close to another inventory cache which can be moving or fixed, such that a distance between them is less than a threshold (e.g., 10 cm). Different values of the threshold can be used greater than or less than 10 cm. In one implementation, the technology disclosed uses locations of joints to locate inventory caches linked to shoppers to detect the proximity event. For example, the system can detect a proximity event when a left or a right hand joint of a shopper is positioned closer than the threshold to a left or right hand joint of another shopper or a shelf location. The system can also use positions of other joints such as elbow joints, or shoulder joints of a subject to detect proximity events. The proximity event detection and classification engine 180 includes the logic to detect proximity events in the area of real space. The system can store the proximity events in the proximity events database 160.

The technology disclosed can process the proximity events to detect puts and takes of inventory items. For example, when an item is handed-off from the first shopper to the second shopper, the technology disclosed can detect the proximity event. Following this, the technology disclosed can detect the type of the proximity event, e.g., a put, take or touch type event. When an item is exchanged between two shoppers, the technology disclosed detects a put type event for the source shopper (or source subject) and a take type event for the sink shopper (or sink subject). The system can then process the put and take events to determine the item exchanged in the proximity event. This information is then used by the system to update the log data structures (or shopping cart data structures) of the source and sink shoppers. For example, the item exchanged is removed from the log data structure of the source shopper and added to the log data structure of the sink shopper. The system can apply the same processing logic when shoppers take items from shelves and put items back on the shelves. In this case, the exchange of items takes place between a shopper and a shelf. The system determines the item taken from the shelf or put on the shelf in the proximity event. The system then updates the log data structures of the shopper and the shelf accordingly.

The technology disclosed includes logic to detect a same event in the area of real space using multiple parallel image processing pipelines or subsystems or procedures. These redundant event detection subsystems provide robust event detection and increase the confidence detection of puts and takes by matching events in multiple event streams. The system can then fuse events from multiple event streams using a weighted combination of items classified in event streams. In case one image processing pipeline cannot detect an event, the system can use the results from other image processing pipelines to update the log data structure of the shoppers. These events of puts and takes in the area of real space can be referred to as “inventory events”. An inventory event can include information about the source and sink, classification of the item, a timestamp, a frame identifier, and a location in three dimensions in the area of real space. The multiple streams of inventory events can include a stream of location based-events, a stream of region proposals-based events, and a stream of semantic diffing-based events. Details of the system architecture are provided, including the machine learning models, system components, and processing operations in the three image processing pipelines, respectively producing the three event streams. Logic to fuse the events in a plurality of event streams is also described.

The technology disclosed can include logic to perform the recalibration process and the subject tracking and event detection processes substantially contemporaneously, thereby enabling cameras to be calibrated without clearing subjects from the real space or interrupting tracking puts and takes of items by subjects. In one implementation, the one or more operations of the self-service store such as subject identification, subject tracking, subject re-identification (RE-ID), pose detection and/or inventory event detection (or action detection) can be performed locally at the location of the store without sending the images/videos to a server such as a cloud-based server. In one implementation, the one or more operations of the store, listed above, can be performed per camera (or per sensor) or per subset of cameras (or per subset of sensors). For example, in such an implementation, the camera can include processing logic to process images captured by the camera to detect a pose of the subject or re-identify a subject that was missing in one or more previous subject identification time intervals. Similarly, in such an implementation, action detection techniques can be delegated to the camera such that inventory events are detected per camera.

In some operations, such as for subject tracking, images from two or more cameras with overlapping fields of view are processed to generate 3D geometry for determining the depth of the subject in the area of real space or to locate the subject in coordinates of the 3D area of real space. In such an implementation, the technology disclosed can include a master-slave arrangement of cameras to track subjects on master cameras by combining videos/images from one or more slave cameras with overlapping fields of view with the master camera. Therefore, the technology disclosed can implement the operations of the store with low Internet bandwidth availability. The store can also operate when there is intermittent Internet availability. In such an implementation, the images/videos are processed locally on-premises of the store and inventory monitoring data are sent to a central server or a cloud-based server for further processing. In some cases, the store can operate with no Internet availability. In such an implementation, the inventory monitoring data are stored on a storage device and uploaded to the server for sending to shoppers from another location where the Internet is available. The processing can be performed at the other location after regular time intervals such as every three hours, every six hours or at the end of the business day.

The actual communication path through the network 181 can be point-to-point over public and/or private networks. The communications can occur over a variety of networks 181, e.g., private networks, VPN, MPLS circuit, or Internet, and can use appropriate application programming interfaces (APIs) and data interchange formats, e.g., Representational State Transfer (REST), JavaScript™ Object Notation (JSON), Extensible Markup Language (XML), Simple Object Access Protocol (SOAP), Java™ Message Service (JMS), and/or Java Platform Module System. All of the communications can be encrypted. The communication is generally over a network such as a LAN (local area network), WAN (wide area network), telephone network (Public Switched Telephone Network (PSTN), Session Initiation Protocol (SIP), wireless network, point-to-point network, star network, token ring network, hub network, and Internet, inclusive of the mobile Internet, via protocols such as EDGE, 3G, 4G LTE, Wi-Fi, and WiMAX. Additionally, a variety of authorization and authentication techniques, such as username/password, Open Authorization (OAuth), Kerberos, SecureID, digital certificates and more, can be used to secure the communications.

The technology disclosed herein can be implemented in the context of any computer-implemented system including a database system, a multi-tenant environment, or a relational database implementation like an Oracle™ compatible database implementation, an IBM DB2 Enterprise Server™ compatible relational database implementation, a MySQL™ or PostgreSQL™ compatible relational database implementation or a Microsoft SQL Server™ compatible relational database implementation, or a NoSQL™ non-relational database implementation such as a Vampire™ compatible non-relational database implementation, an Apache Cassandra™ compatible non-relational database implementation, a BigTable™ compatible non-relational database implementation or an HBase™ or DynamoDB™ compatible non-relational database implementation. In addition, the technology disclosed can be implemented using different programming models like MapReduce™, bulk synchronous programming. MPI primitives, etc. or different scalable batch and stream management systems like Apache Storm™. Apache Spark™. Apache Kafka™. Apache Flink™. Truviso™. Amazon Elasticsearch Service™. Amazon Web Services™ (AWS). IBM Info-Sphere™. Borealis™, and Yahoo! S4™. Camera arrangement in a multi-camera environment to track subjects and detect proximity events is described below.

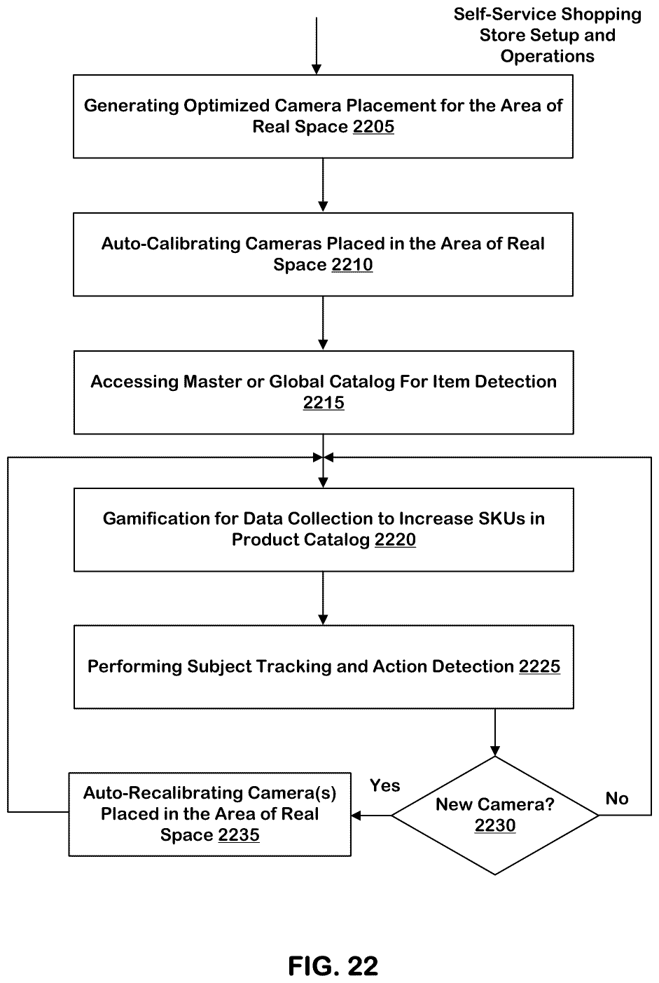

In the following description details various techniques and subsystems for setup and operations of monitoring within a store are presented. Examples of the techniques presented below include automatic generation of a camera placement plan for the area of real space, auto-calibration of cameras and auto-recalibration techniques, subject tracking, action detection or inventory events detection techniques and use of master or global product catalogs. These techniques are used by the self-service engine 195 to automatically setup and manage operations of monitoring within the store. A process flowchart including operations for setting up and operating monitoring within the store is presented in FIG. 22.

### Camera Arrangement

The cameras 114 are arranged to track multi-joint entities (or subjects) in a 3D real space. In the example implementation of the store, the real space can include the area of the store where items for sale are stacked in shelves. A point in the real space can be represented by an (x, y, z) coordinate system. Each point in the area of real space for which the system is deployed is covered by the fields of view of two or more cameras 114.

In a store, the shelves and other inventory display structures can be arranged in a variety of manners, such as along the walls of the store, or in rows forming aisles or a combination of the two arrangements. FIG. 2A shows an arrangement of shelves, forming an aisle 116a, viewed from one end of the aisle 116a. Two cameras, camera A 206 and camera B 208, are positioned over the aisle 116a at a predetermined distance from a roof 230 and a floor 220 of the store above the inventory display structures such as shelves. The cameras 114 comprise cameras disposed over and having fields of view encompassing respective parts of the inventory display structures and floor area in the real space. If the arrangement of cameras is viewed from the top, the camera A 206 is positioned at a predetermined distance from the shelf A 202 and the camera B 208 is positioned at a predetermined distance from the shelf B 204. In another implementation, in which more than two cameras are positioned over an aisle, the cameras are positioned at equal distances from each other. In such an implementation, two cameras are positioned close to the opposite ends and a third camera is positioned in the middle of the aisle. It is understood that a number of different camera arrangements are possible.

The coordinates in real space of members of a set of candidate joints, identified as a subject, identify locations in the floor area of the subject. In the example implementation of the store, the real space can include all of the floor 220 in the store from which inventory can be accessed. Cameras 114 are placed and oriented such that areas of the floor 220 and shelves can be seen by at least two cameras. The cameras 114 also cover at least part of the shelves 202 and 204 and floor space in front of the shelves 202 and 204. Camera angles are selected to have both steep perspectives, straight down, and angled perspectives that give more full body images of the customers. In one example implementation, the cameras 114 are configured at an eight (8) foot height or higher throughout the store. FIG. 13 presents an illustration of such an implementation.

In FIG. 2A, the cameras 206 and 208 have overlapping fields of view, covering the space between a shelf A 202 and a shelf B 204 with overlapping fields of view 216 and 218, respectively. A location in the real space is represented as an (x, y, z) point of the real space coordinate system. “x” and “y” represent positions on a 2D plane which can be the floor 220 of the store. The value “z” is the height of the point above the 2D plane at the floor 220 in one configuration.

FIG. 2B is a perspective view of the shelf unit B 204 with four shelves, shelf 1, shelf 2, shelf 3, and shelf 4, positioned at different levels from the floor. The inventory items are stocked on the shelves. A subject 240 is reaching out to take an item from the right-hand side portion of the shelf 4. A location in the real space is represented as an (x, y, z) point of the real space coordinate system. “x” and “y” represent positions on a 2D plane which can be the floor 220 of the store. The value “z” is the height of the point above the 2D plane at floor 220 in one configuration.

On a particular shelf, a region of interest can be defined as a 3D space on a shelf in which a particular SKU is expected to be stocked. The region of interest can be represented as a bounding box in the image plane of one or more cameras showing the 3D space. A particular SKU is expected to be located within the region of interest, as defined by visual verification or a planogram.

### Camera Calibration

The system can perform two types of calibrations: internal and external. In internal calibration, the internal parameters of the cameras 114 are calibrated. Examples of internal camera parameters include focal length, principal point, skew, fisheye coefficients, etc. A variety of techniques for internal camera calibration can be used. One such technique is presented by Zhang in “A flexible new technique for camera calibration” published in IEEE Transactions on Pattern Analysis and Machine Intelligence, Volume 22, No. 11, November 2000. In external calibration, the external camera parameters are calibrated in order to generate mapping parameters for translating the 2D image data into 3D coordinates in real space. In one implementation, one subject, such as a person, is introduced into the real space. The subject moves through the real space on a path that passes through the field of view of each of the cameras 114. At any given point in the real space, the subject is present in the fields of view of at least two cameras forming a 3D scene. The two cameras, however, have a different view of the same 3D scene in their respective 2D image planes. A feature in the 3D scene such as a left-wrist of the subject is viewed by two cameras at different positions in their respective 2D image planes.

A point correspondence is established between every pair of cameras with overlapping fields of view for a given scene. Since each camera has a different view of the same 3D scene, a point correspondence is two pixel locations (one location from each camera with an overlapping field of view) that represent the projection of the same point in the 3D scene. Many point correspondences are identified for each 3D scene using the results of the image recognition engines 112a-112n for the purposes of the external calibration. The image recognition engines identify the position of a joint as (x, y) coordinates, such as row and column numbers, of pixels in the 2D image planes of the respective cameras 114. In one implementation, a joint is one of 19 different types of joints of the subject. As the subject moves through the fields of view of different cameras, the tracking engine 110 receives (x, y) coordinates of each of the 19 different types of joints of the subject per image from the cameras 114 used for the calibration.

For example, consider an image from a camera A and an image from a camera B both taken at the same moment in time and with overlapping fields of view. There are pixels in an image from camera A that correspond to pixels in a synchronized image from camera B. Consider that there is a specific point of some object or surface in view of both camera A and camera B and that point is captured in a pixel of both image frames. In external camera calibration, a multitude of such points are identified and referred to as corresponding points. Since there is one subject in the field of view of camera A and camera B during calibration, key joints of this subject are identified, for example, the center of the left wrist. If these key joints are visible in image frames from both camera A and camera B then it is assumed that these represent corresponding points. This process is repeated for many image frames to build up a large collection of corresponding points for all pairs of cameras with overlapping fields of view. In one implementation, images are streamed off of all cameras at a rate of 30 FPS (frames per second) or more and a resolution of 1280 by 720 pixels in full RGB (red, green, and blue) color. These images are in the form of 1D arrays (also referred to as flat arrays).

In some implementations, the resolution of the images is reduced before applying the images to the inference engines used to detect the joints in the images, such as by dropping every other pixel in a row, reducing the size of the data for each pixel, or otherwise, so the input images at the inference engine have smaller amounts of data, and so the inference engines can operate faster.

The large number of images collected above for a subject can be used to determine corresponding points between cameras with overlapping fields of view. Consider two cameras A and B with overlapping fields of view. The plane passing through the camera centers of cameras A and B and the joint location (also referred to as the feature point) in the 3D scene is called the “epipolar plane”. The intersection of the epipolar plane with the 2D image planes of the cameras A and B defines the “epipolar line”. Given these corresponding points, a transformation is determined that can accurately map a corresponding point from camera A to an epipolar line in camera B's field of view that is guaranteed to intersect the corresponding point in the image frame of camera B. Using the image frames collected above for a subject, the transformation is generated. It is known in the art that this transformation is non-linear. The general form is furthermore known to require compensation for the radial distortion of each camera's lens, as well as the non-linear coordinate transformation moving to and from the projected space. In external camera calibration, an approximation to the ideal non-linear transformation is determined by solving a non-linear optimization problem. This non-linear optimization function is used by the tracking engine 110 to identify the same joints in outputs (arrays of joints data structures) of different image recognition engines 112a-112n, processing images of the cameras 114 with overlapping fields of view. The results of the internal and external camera calibration are stored in the calibration database 150.

A variety of techniques for determining the relative positions of the points in images of cameras 114 in the real space can be used. For example, Longuet-Higgins published. “A computer algorithm for reconstructing a scene from two projections” in Nature. Volume 293, 10 Sep. 1981. This paper presents computing a 3D structure of a scene from a correlated pair of perspective projections when the spatial relationship between the two projections is unknown. The Longuet-Higgins paper presents a technique to determine the position of each camera in the real space with respect to other cameras. Additionally, their technique allows the triangulation of a subject in the real space, identifying the value of the z-coordinate (height from the floor) using images from cameras 114 with overlapping fields of view. An arbitrary point in the real space, for example, the end of a shelf in one corner of the real space, is designated as a (0, 0, 0) point on the (x, y, z) coordinate system of the real space.

In an implementation of the technology, the parameters of the external calibration are stored in two data structures. The first data structure stores intrinsic parameters. The intrinsic parameters represent a projective transformation from the 3D coordinates into 2D image coordinates. The first data structure contains intrinsic parameters per camera as shown below. The data values are all numeric floating point numbers. This data structure stores a 3×3 intrinsic matrix, represented as “K” and distortion coefficients. The distortion coefficients include six radial distortion coefficients and two tangential distortion coefficients. Radial distortion occurs when light rays bend more near the edges of a lens than they do at its optical center. Tangential distortion occurs when the lens and the image plane are not parallel. The following data structure shows values for the first camera only. Similar data is stored for all the cameras 114.

```
{
  1: {
    K: [[x, x, x], [x, x, x], [x, x, x]],
    distortion _coefficients: [x, x, x, x, x, x, x, x]
  },
  ......
}
```

The camera recalibration method can be applied to 360 degree or high field of view cameras. The radial distortion parameters described above can model the (barrel) distortion of a 360 degree camera. The intrinsic and extrinsic calibration process described here can be applied to the 360 degree cameras. However, the camera model using these intrinsic calibration parameters (data elements of K and distortion coefficients) can be different.

The second data structure stores extrinsic calibration parameters per pair of cameras: a 3×3 fundamental matrix (F), a 3×3 essential matrix (E), a 3×4 projection matrix (P), a 3×3 rotation matrix (R) and a 3×1 translation vector (t). This data is used to convert points in one camera's reference frame to another camera's reference frame. For each pair of cameras, eight homography coefficients are also stored to map the plane of the floor 220 from one camera to another. A fundamental matrix is a relationship between two images of the same scene that constrains where the projection of points from the scene can occur in both images. An essential matrix is also a relationship between two images of the same scene with the condition that the cameras are calibrated. The projection matrix gives a vector space projection from the 3D real space to a subspace. The rotation matrix is used to perform a rotation in Euclidean space. The translation vector “t” represents a geometric transformation that moves every point of a figure or a space by the same distance in a given direction. In one implementation, the technology disclosed can use rotation and translation parameters for recalibration of cameras. In other implementations, other extrinsic calibration parameters can also be used in recalibration of cameras. The homography_floor_coefficients are used to combine images of features of subjects on the floor 220 viewed by cameras with overlapping fields of views. The second data structure is shown below. Similar data is stored for all pairs of cameras. As indicated previously, the x's represents numeric floating point numbers.

```
{
  1: {
    2: {
      F: [[x, x, x], [x, x, x], [x, x, x]],
      E: [[x, x, x], [x, x, x], [x, x, x]],
      P: [[x, x, x, x], [x, x, x, x], [x, x, x, x]],
      R: [[x, x, x], [x, x, x], [x, x, x]],
      t: [x, x, x],
      homography_floor_coefficients: [x, x, x, x, x, x, x, x]
    }
  },
  .......
}
```

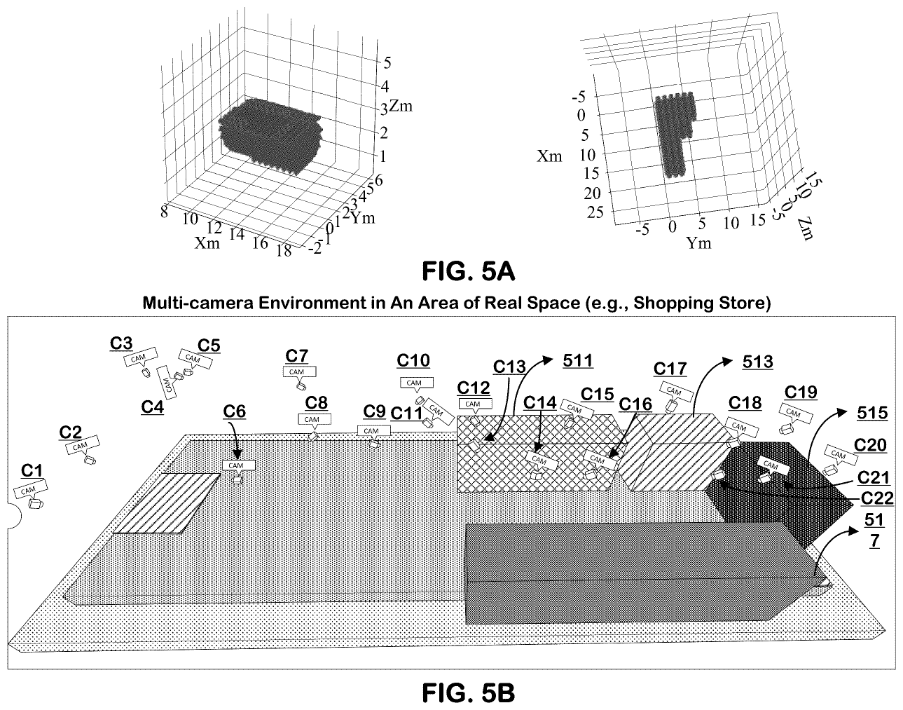

The system can also use Fiducial markers for initial calibration of cameras in the area of real space. Examples of calibrating cameras using Fiducial markers are provided below, as well as the process to perform recalibration of cameras in FIGS. 5 to 11B.

### Two-Dimensional and Three-Dimensional Maps

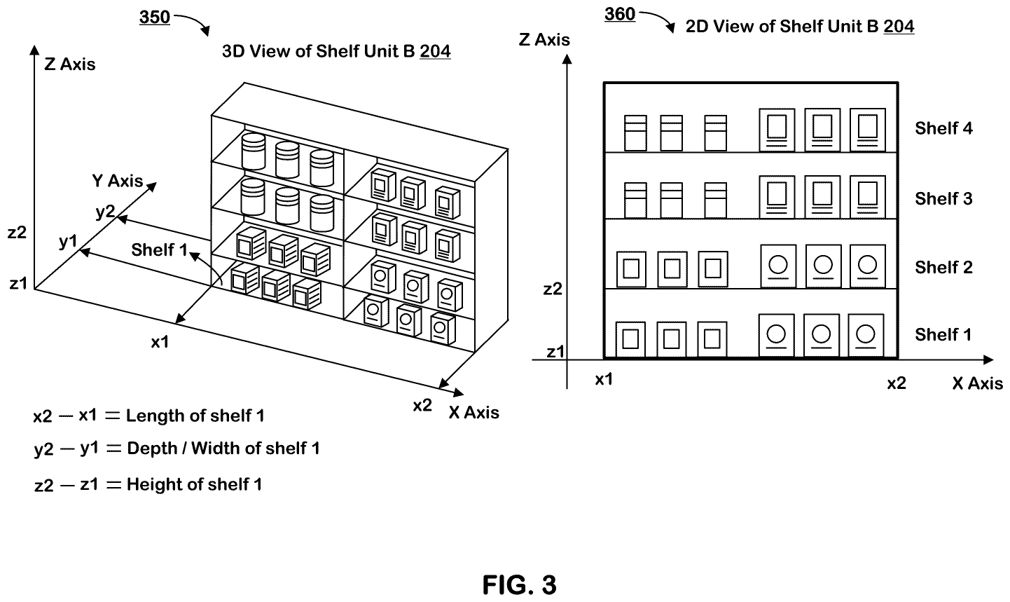

FIG. 3 presents creation of 2D and 3D maps. An inventory cache, such as a location on a shelf, in a store can be identified by a unique identifier in a map database (e.g., shelf_id). Similarly, a store can also be identified by a unique identifier (e.g., store_id) in a map database. The 2D and 3D maps database 150 identifies locations of inventory caches in the area of real space along the respective coordinates. For example, in a 2D map, the locations in the maps define 2D regions on the plane formed perpendicular to the floor 220 i.e., the XZ plane as shown in illustration 360 in FIG. 3. The map defines an area for inventory locations or shelves where inventory items are positioned. In FIG. 3, a 2D location of the shelf unit shows an area formed by four coordinate positions (×1, y1), (×1, y2), (×2, y2), and (×2, y1). These coordinate positions define a 2D region on the floor 220 where the shelf is located. Similar 2D areas are defined for all inventory display structure locations, entrances, exits, and designated unmonitored locations in the store. This information is stored in the maps database.

In a 3D map, the locations in the map define 3D regions in the 3D real space defined by X, Y, and Z coordinates. The map defines a volume for inventory locations where inventory items are positioned. In illustration 350 in FIG. 3, a 3D view 350 of shelf 1, at the bottom of shelf unit B 204, shows a volume formed by eight coordinate positions (×1, y1, z1), (×1, y1, z2), (×1, y2, z1), (×1, y2, z2), (×2, y1, z1), (×2, y1, z2), (×2, y2, z1), (×2, y2, z2) defining a 3D region in which inventory items are positioned on the shelf 1. Similar 3D regions are defined for inventory locations in all shelf units in the store and stored as a 3D map of the real space (store) in the maps database. The coordinate positions along the three axes can be used to calculate length, depth and height of the inventory locations as shown in FIG. 3.

In one implementation, the map identifies a configuration of units of volume which correlate with portions of inventory locations on the inventory display structures in the area of real space. Each portion is defined by starting and ending positions along the three axes of the real space. Like 2D maps, the 3D maps can also store locations of all inventory display structure locations, entrances, exits and designated unmonitored locations in the store. The items in a store are arranged in some implementations according to a planogram which identifies the inventory locations (such as shelves) on which a particular item is planned to be placed. For example, as shown in an illustration 250 in FIG. 2B, the left half portions of shelf 3 and shelf 4 are designated for an item (which is stocked in the form of cans). The system can include pre-defined planograms for the store which include positions of items on the shelves in the store. The planograms can be stored in the maps database. In one implementation, the system can include logic to update the positions of items on shelves in real time or near real time.

### Convolutional Neural Network

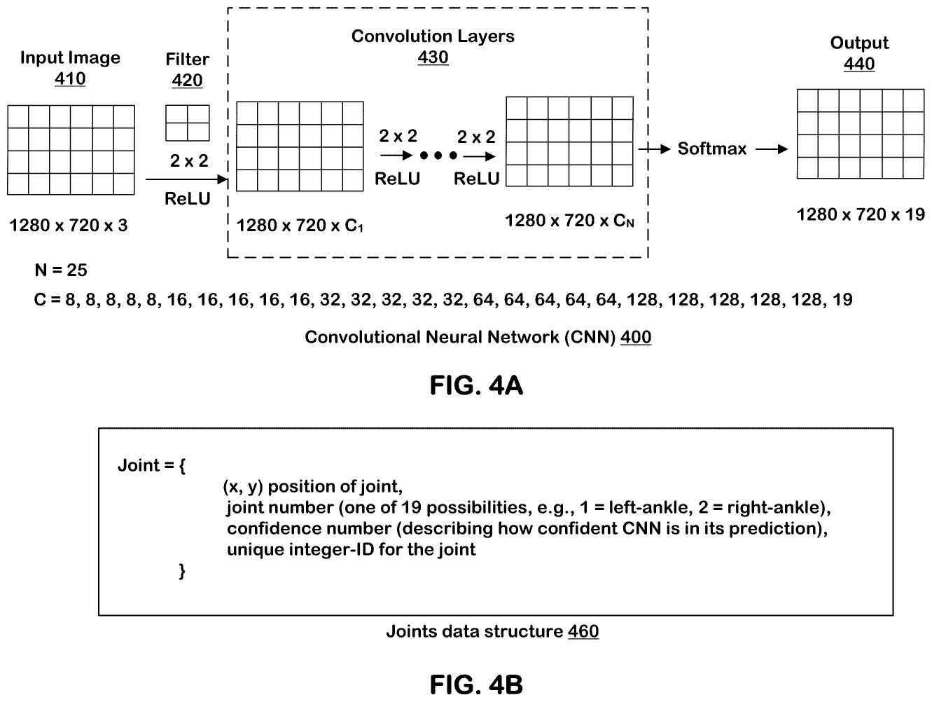

The image recognition engines in the processing platforms receive a continuous stream of images at a predetermined rate. In one implementation, the image recognition engines comprise convolutional neural networks (abbreviated CNN). FIG. 4A illustrates the processing of image frames by an example CNN referred to by a numeral 400. The input image 410 is a matrix consisting of image pixels arranged in rows and columns. In one implementation, the input image 410 has a width of 1280 pixels, a height of 720 pixels and 3 channels, red, blue, and green also referred to as RGB. The channels can be imagined as three 1280×720 2D images stacked over one another. Therefore, the input image has dimensions of 1280×720×3 as shown in FIG. 4A. As mentioned above, in some implementations, the images are filtered to provide images with reduced resolution for input to the CNN.

A 2×2 filter 420 is convolved with the input image 410. In this implementation, no padding is applied when the filter is convolved with the input. Following this, a nonlinearity function is applied to the convolved image. In the present implementation, rectified linear unit (ReLU) activations are used. Other examples of nonlinear functions include sigmoid, hyperbolic tangent (tanh) and variations of ReLU such as leaky ReLU. A search is performed to find hyper-parameter values. The hyper-parameters are C₁, C₂, . . . , CN where CN means the number of channels for convolution layer “N”. Typical values of N and C are shown in FIG. 4A. There are twenty-five (25) layers in the CNN as represented by N equals 25. The values of C are the number of channels in each convolution layer for layers 1 to 25. In other implementations, additional features are added to the CNN 400 such as residual connections, squeeze-excitation modules, and multiple resolutions.

In typical CNNs used for image classification, the size of the image (width and height dimensions) is reduced as the image is processed through convolution layers. That is helpful in feature identification as the goal is to predict a class for the input image. However, in the illustrated implementation, the size of the input image (i.e. image width and height dimensions) is not reduced, as the goal is not only to identify a joint (also referred to as a feature) in the image frame, but also to identify its location in the image so it can be mapped to coordinates in the real space. Therefore, as shown FIG. 5, the width and height dimensions of the image remain unchanged relative to the input images (with full or reduced resolution) as the processing proceeds through convolution layers of the CNN, in this example.

In one implementation, the CNN 400 identifies one of the 19 possible joints of the subjects at each element of the image. The possible joints can be grouped in two categories: foot joints and non-foot joints. The 19th type of joint classification is for all non-joint features of the subject (i.e. elements of the image not classified as a joint). Foot joints can include the left and right ankle joints. Non-foot joints can include the neck, nose, left and right eyes, left and right ears, left and right shoulders, left and right elbows, left and right wrists, left and right hips, left and right knees, and “not a joint.” As can be seen, a “joint” for the purposes of this description is a trackable feature of a subject in the real space. A joint may correspond to physiological joints on the subjects, or other features such as the eyes, or nose.

The first set of analyses on the stream of input images identifies trackable features of subjects in real space. In one implementation, this is referred to as a “joints analysis”. In such an implementation, the CNN used for joints analysis is referred to as a “joints CNN”. In one implementation, the joints analysis is performed thirty times per second over the thirty frames per second received from the corresponding camera. The analysis is synchronized in time i.e., at 1/30^{th} of a second, images from all cameras 114 are analyzed in the corresponding joints CNNs to identify joints of all subjects in the real space. The results of this analysis of the images from a single moment in time from plural cameras are stored as a “snapshot”.

A snapshot can be in the form of a dictionary containing arrays of joints data structures from images of all cameras 114 at a moment in time, representing a constellation of candidate joints within the area of real space covered by the system. In one implementation, the snapshot is stored in the subject database 140. In this example CNN, a softmax function is applied to every element of the image in the final layer of convolution layers 430. The softmax function transforms a K-dimensional vector of arbitrary real values to a K-dimensional vector of real values in the range [0, 1] that add up to 1. In one implementation, an element of an image is a single pixel. The softmax function converts the 19-dimensional array (also referred to a 19-dimensional vector) of arbitrary real values for each pixel to a 19-dimensional confidence array of real values in the range [0, 1] that add up to 1. The 19 dimensions of a pixel in the image frame correspond to the 19 channels in the final layer of the CNN which further correspond to the 19 types of joints of the subjects.

A large number of picture elements can be classified as one of each of the 19 types of joints in one image depending on the number of subjects in the field of view of the source camera for that image. The image recognition engines 112a-112n process images to generate confidence arrays for elements of the image. A confidence array for a particular element of an image includes confidence values for a plurality of joint types for the particular element. Each one of the image recognition engines 112a-112n, respectively, generates an output matrix 440 of confidence arrays per image. Finally, each image recognition engine generates arrays of joints data structures corresponding to each output matrix 440 of confidence arrays per image. The arrays of joints data structures corresponding to particular images classify elements of the particular images by joint type, time of the particular image, and coordinates of the element in the particular image. A joint type for the joints data structure of the particular elements in each image is selected based on the values of the confidence array.

Each joint of the subjects can be considered to be distributed in the output matrix 440 as a heat map. The heat map can be resolved to show image elements having the highest values (peak) for each joint type. Ideally, for a given picture element having high values of a particular joint type, surrounding picture elements outside a range from the given picture element will have lower values for that joint type, so that a location for a particular joint having that joint type can be identified in the image space coordinates. Correspondingly, the confidence array for that image element will have the highest confidence value for that joint and lower confidence values for the remaining 18 types of joints.

In one implementation, batches of images from each camera 114 are processed by respective image recognition engines. For example, six contiguously timestamped images are processed sequentially in a batch to take advantage of cache coherence. The parameters for one layer of the CNN 400 are loaded in memory and applied to the batch of six image frames. Then the parameters for the next layer are loaded in memory and applied to the batch of six images. This is repeated for all convolution layers 430 in the CNN 400. The cache coherence reduces processing time and improves the performance of the image recognition engines. In one such implementation, referred to as 3D convolution, a further improvement in performance of the CNN 400 is achieved by sharing information across image frames in the batch. This helps in more precise identification of joints and reduces false positives. For examples, features in the image frames for which pixel values do not change across the multiple image frames in a given batch are likely static objects such as a shelf. The change of values for the same pixel across image frames in a given batch indicates that this pixel is likely a joint. Therefore, the CNN 400 can focus more on processing that pixel to accurately identify the joint identified by that pixel.

### Joints Data Structure

The output of the CNN 400 is a matrix of confidence arrays for each image per camera. The matrix of confidence arrays is transformed into an array of joints data structures. A joints data structure 460 as shown in FIG. 4B is used to store the information of each joint. The joints data structure 460 identifies x and y positions of the element in the particular image in the 2D image space of the camera from which the image is received. A joint number identifies the type of joint identified. For example, in one implementation, the values range from 1 to 19. A value of 1 indicates that the joint is a left-ankle, a value of 2 indicates the joint is a right-ankle and so on. The type of joint is selected using the confidence array for that element in the output matrix 440. For example, in one implementation, if the value corresponding to the left-ankle joint is highest in the confidence array for that image element, then the value of the joint number is “1”. A confidence number indicates the degree of confidence of the CNN 400 in predicting that joint. If the value of the confidence number is high, it means the CNN is confident in its prediction. An integer-Id is assigned to the joints data structure to uniquely identify it. Following the above mapping, the output matrix 440 of confidence arrays per image is converted into an array of joints data structures for each image. The image recognition engines 112a-112n receive the sequences of images from the cameras 114 and process the images to generate corresponding arrays of joints data structures as described above. An array of joints data structures for a particular image classifies elements of the particular image by joint type, time of the particular image, and the coordinates of the elements in the particular image. In one implementation, the image recognition engines 112a-112n are convolutional neural networks CNN 400, the joint type is one of the 19 types of joints of the subjects, the time of the particular image is the timestamp of the image generated by the source camera 114 for the particular image, and the coordinates (x, y) identify the position of the element on a 2D image plane.

In one implementation, the joints analysis includes performing a combination of k-nearest neighbors, mixture of Gaussians, various image morphology transformations, and joints CNN on each input image. The result comprises arrays of joints data structures which can be stored in the form of a bit mask in a ring buffer that maps image numbers to bit masks at each moment in time. The process to track subjects in the area of real space using the tracking engine is described below.

### Tracking Engine

The technology disclosed can use the calibrated cameras to perform monitoring operations of a store. The system can include logic to process sequences of images of the plurality of sequences of images, to track puts and takes of items by subjects within respective fields of view in the real space. The technology disclosed can include logic to perform the recalibration process and the subject tracking and event detection processes substantially contemporaneously, thereby enabling cameras to be calibrated without clearing subjects from the real space or interrupting tracking puts and takes of items by subjects.

The subject tracking engine 110 is configured to receive arrays of joints data structures generated by the image recognition engines 112a-112n corresponding to images in sequences of images from cameras having overlapping fields of view. The arrays of joints data structures per image are sent by image recognition engines 112a-112n to the tracking engine 110 via the network(s) 181 as shown in FIG. 1. The subject tracking engine 110 translates the coordinates of the elements in the arrays of joints data structures corresponding to images in different sequences into candidate joints having coordinates in the real space. The tracking engine 110 comprises logic to identify sets of candidate joints having coordinates in real space (constellations of joints) as subjects in the real space. In one implementation, the subject tracking engine 110 accumulates arrays of joints data structures from the image recognition engines for all the cameras at a given moment in time and stores this information as a dictionary in the subject database 140, to be used for identifying a constellation of candidate joints. The dictionary can be arranged in the form of key-value pairs, where keys are camera ids and values are arrays of joints data structures from the camera. In such an implementation, this dictionary is used in heuristics-based analysis to determine candidate joints and for the assignment of joints to subjects. In such an implementation, a high-level example of the input, processing and output of the subject tracking engine 110 is now described. The inputs can include arrays of joints data structures per image and for each joints data structure (i.e., a unique ID, confidence number, joint number, and coordinate position). The processing can include creating a joints dictionary and re-projecting joint positions in the fields of view of cameras with overlapping fields of view to candidate joints. The output can include a list of subjects in the real space at a moment in time.

### Grouping Candidate Joints

The subject tracking engine 110 receives arrays of joints data structures along two dimensions: time and space. Along the time dimension, the tracking engine receives sequentially timestamped arrays of joints data structures processed by the image recognition engines 112a-112n per camera. The joints data structures include multiple instances of the same joint of the same subject over a period of time in images from cameras having overlapping fields of view. The (x, y) coordinates of the element in the particular image will usually be different in sequentially timestamped arrays of joints data structures because of the movement of the subject to which the particular joint belongs. For example, twenty picture elements classified as left-wrist joints can appear in many sequentially timestamped images from a particular camera, each left-wrist joint having a position in real space that can be changing or unchanging from image to image. As a result, twenty left-wrist joints data structures 460 in many sequentially timestamped arrays of joints data structures can represent the same twenty joints in real space over time.

Because multiple cameras having overlapping fields of view cover each location in the real space, at any given moment in time, the same joint can appear in images of more than one of the cameras 114. The cameras 114 are synchronized in time, therefore, the subject tracking engine 110 receives joints data structures for a particular joint from multiple cameras having overlapping fields of view, at any given moment in time. This is the space dimension, the second of the two dimensions: time and space, along which the subject tracking engine 110 receives data in arrays of joints data structures.

The subject tracking engine 110 uses an initial set of heuristics stored in a heuristics database to identify candidate joints data structures from the arrays of joints data structures. The goal is to minimize a global metric over a period of time. A global metric calculator can calculate the global metric. The global metric is a summation of multiple values described below. Intuitively, the value of the global metric is at a minimum when the joints in arrays of joints data structures received by the subject tracking engine 110 along the time and space dimensions are correctly assigned to their respective subjects. For example, consider the implementation of the store with customers moving in the aisles. If the left-wrist of a customer A is incorrectly assigned to a customer B, then the value of the global metric will increase. Therefore, minimizing the global metric for each joint for each customer is an optimization problem. One option to solve this problem is to try all possible connections of joints. However, this can become intractable as the number of customers increases.

A second approach to solve this problem is to use heuristics to reduce possible combinations of joints identified as members of a set of candidate joints for a single subject. For example, a left-wrist joint cannot belong to a subject far apart in space from other joints of the subject because of known physiological characteristics of the relative positions of joints. Similarly, a left-wrist joint having a small change in position from image to image is less likely to belong to a subject having the same joint at the same position from an image far apart in time, because the subjects are not expected to move at a very high speed. These initial heuristics are used to build boundaries in time and space for constellations of candidate joints that can be classified as a particular subject. The joints in the joints data structures within a particular time and space boundary are considered as “candidate joints” for assignment to sets of candidate joints as subjects present in the real space. These candidate joints include joints identified in arrays of joints data structures from multiple images from a same camera over a period of time (time dimension) and across different cameras with overlapping fields of view (space dimension).

The joints can be divided for the purposes of a procedure for grouping the joints into constellations, into foot and non-foot joints as shown above in the list of joints. The left and right-ankle joint types in the current example are considered foot joints for the purpose of this procedure. The subject tracking engine 110 can start the identification of sets of candidate joints of particular subjects using foot joints. In the implementation of the store, the feet of the customers are on the floor 220 as shown in FIG. 2A. The distance of the cameras 114 to the floor 220 is known. Therefore, when combining the joints data structures of foot joints from arrays of joints data structures corresponding to images of cameras with overlapping fields of view, the subject tracking engine 110 can assume a known depth (distance along z axis). The value depth for foot joints is zero i.e. (x, y, 0) in the (x, y, z) coordinate system of the real space. Using this information, the subject tracking engine 110 applies homographic mapping to combine joints data structures of foot joints from cameras with overlapping fields of view to identify the candidate foot joint. Using this mapping, the location of the joint in (x, y) coordinates in the image space is converted to the location in the (x, y, z) coordinates in the real space, resulting in a candidate foot joint. This process is performed separately to identify candidate left and right foot joints using respective joints data structures.

Following this, the subject tracking engine 110 can combine a candidate left foot joint and a candidate right foot joint (assign them to a set of candidate joints) to create a subject. Other joints from the galaxy of candidate joints can be linked to the subject to build a constellation of some or all of the joint types for the created subject.

If there is only one left candidate foot joint and one right candidate foot joint then it means there is only one subject in the particular space at the particular time. The tracking engine 110 creates a new subject having the left and the right candidate foot joints belonging to its set of joints. The subject is saved in the subject database 140. If there are multiple candidate left and right foot joints, then the global metric calculator attempts to combine each candidate left foot joint to each candidate right foot joint to create subjects such that the value of the global metric is minimized.

To identify candidate non-foot joints from arrays of joints data structures within a particular time and space boundary, the subject tracking engine 110 uses the non-linear transformation (also referred to as a fundamental matrix) from any given camera A to its neighboring camera B with overlapping fields of view. The non-linear transformations are calculated using a single multi-joint subject and stored in a calibration database as described above. For example, for two cameras A and B with overlapping fields of view, the candidate non-foot joints are identified as follows. The non-foot joints in arrays of joints data structures corresponding to elements in image frames from camera A are mapped to epipolar lines in synchronized image frames from camera B. A joint (also referred to as a feature in machine vision literature) identified by a joints data structure in an array of joints data structures of a particular image of camera A will appear on a corresponding epipolar line if it appears in the image of camera B. For example, if the joint in the joints data structure from camera A is a left-wrist joint, then a left-wrist joint on the epipolar line in the image of camera B represents the same left-wrist joint from the perspective of camera B. These two points in the images of cameras A and B are projections of the same point in the 3D scene in real space and are referred to as a “conjugate pair”.

Machine vision techniques such as the technique by Longuet-Higgins published in the paper, titled. “A computer algorithm for reconstructing a scene from two projections” in Nature. Volume 293, 10 Sep. 1981, are applied to conjugate pairs of corresponding points to determine the heights of joints from the floor 220 in the real space.

Application of the above method requires predetermined mapping between cameras with overlapping fields of view. That data can be stored in a calibration database as non-linear functions determined during the calibration of the cameras 114 described above.

The subject tracking engine 110 receives the arrays of joints data structures corresponding to images in sequences of images from cameras having overlapping fields of view, and translates the coordinates of the elements in the arrays of joints data structures corresponding to images in different sequences into candidate non-foot joints having coordinates in the real space. The identified candidate non-foot joints are grouped into sets of subjects having coordinates in real space using a global metric calculator. The global metric calculator can calculate the global metric value and attempt to minimize the value by checking different combinations of non-foot joints. In one implementation, the global metric is a sum of heuristics organized in four categories. The logic to identify sets of candidate joints comprises heuristic functions based on physical relationships among the joints of subjects in real space to identify sets of candidate joints as subjects. Examples of physical relationships among joints are considered in the heuristics as described below.

The first category of heuristics includes metrics to ascertain the similarity between two proposed subject-joint locations in the same camera view at the same or different moments in time. In one implementation, these metrics are floating point values, where higher values mean two lists of joints are likely to belong to the same subject. Consider the example implementation of the store: the metrics determine the distance between a customer's same joints in one camera from one image to the next image along the time dimension. Given a customer A in the field of view of the camera, the first set of metrics determines the distance between each of person A's joints from one image from the camera to the next image from the same camera. The metrics are applied to joints data structures 460 in arrays of joints data structures per image from the cameras 114.

In one implementation, two example metrics in the first category of heuristics include: the inverse of the Euclidean 2D coordinate distance (using x, y coordinate values for a particular image from a particular camera) between the left ankle-joint of two subjects on the floor and the right ankle-joint of the two subjects on the floor summed together; and the sum of the inverse of the Euclidean 2D coordinate distance between every pair of non-foot joints of subjects in the image frame.

The second category of heuristics includes metrics to the ascertain similarity between two proposed subject-joint locations from the fields of view of multiple cameras at the same moment in time. In one implementation, these metrics are floating point values, where higher values mean two lists of joints are likely to belong to the same subject. Consider the example implementation of the store, the second set of metrics determines the distance between a customer's same joints in image frames from two or more cameras (with overlapping fields of view) at the same moment in time. In one implementation, two example metrics in the second category of heuristics include: (1) the inverse of the Euclidean 2D coordinate distance (using x, y coordinate values for a particular image from a particular camera) between the left ankle-joint of two subjects on the floor and the right ankle-joint of the two subjects on the floor summed together and (2) the sum of all pairs of joints of the inverse of the Euclidean 2D coordinate distance between a line and a point, where the line is the epipolar line of a joint of an image from a first camera having a first subject in its field of view to a second camera with a second subject in its field of view and the point is the joint of the second subject in the image from the second camera.

The third category of heuristics includes metrics to ascertain the similarity between all joints of a proposed subject-joint location in the same camera view at the same moment in time. Consider the example implementation of the store; this category of metrics determines the distance between joints of a customer in one frame from one camera.

The fourth category of heuristics includes metrics to ascertain the dissimilarity between proposed subject-joint locations. In one implementation, these metrics are floating point values. Higher values mean two lists of joints are more likely to not be the same subject. In one implementation, two example metrics in this category include the distance between neck joints of two proposed subjects and the sum of the distance between pairs of joints between two subjects.

In one implementation, various thresholds which can be determined empirically are applied to the above listed metrics can include: thresholds to decide when metric values are small enough to consider that a joint belongs to a known subject; thresholds to determine when there are too many potential candidate subjects that a joint can belong to with too good of a metric similarity score; thresholds to determine when collections of joints over time have high enough metric similarity to be considered a new subject, previously not present in the real space; thresholds to determine when a subject is no longer in the real space; and thresholds to determine when the tracking engine 110 has made a mistake and has confused two subjects.

The subject tracking engine 110 includes logic to store the sets of joints identified as subjects. The logic to identify sets of candidate joints includes logic to determine whether a candidate joint identified in images taken at a particular time corresponds with a member of one of the sets of candidate joints identified as subjects in preceding images. In one implementation, the subject tracking engine 110 compares the current joint-locations of a subject with previously recorded joint-locations of the same subject at regular intervals. This comparison allows the tracking engine 110 to update the joint locations of subjects in the real space. Additionally, using this, the subject tracking engine 110 identifies false positives (i.e., falsely identified subjects) and removes subjects no longer present in the real space.

Consider the example of the store implementation, in which the subject tracking engine 110 created a customer (subject) at an earlier moment in time, however, after some time, the subject tracking engine 110 does not have current joint-locations for that particular customer. It means that the customer was incorrectly created. The subject tracking engine 110 deletes incorrectly generated subjects from the subject database 140. In one implementation, the subject tracking engine 110 also removes positively identified subjects from the real space using the above described process. Consider in the example of the store, when a customer leaves the store, the subject tracking engine 110 deletes the corresponding customer record from the subject database 140. In one such implementation, the subject tracking engine 110 updates this customer's record in the subject database 140 to indicate that “the customer has left the store”.

In one implementation, the subject tracking engine 110 attempts to identify subjects by applying the foot and non-foot heuristics simultaneously. This results in “islands” of connected joints of the subjects. As the subject tracking engine 110 processes further arrays of joints data structures along the time and space dimensions, the size of the islands increases. Eventually, the islands of joints merge to other islands of joints forming subjects which are then stored in the subject database 140. In one implementation, the subject tracking engine 110 maintains a record of unassigned joints for a predetermined period of time. During this time, the tracking engine attempts to assign the unassigned joints to existing subjects or create new multi-joint entities from these unassigned joints. The tracking engine 110 discards the unassigned joints after a predetermined period of time. It is understood that, in other implementations, different heuristics than the ones listed above are used to identify and track subjects.

In one implementation, a user interface output device connected to the node 102 hosting the subject tracking engine 110 displays the position of each subject in the real spaces. In one such implementation, the display of the output device is refreshed with new locations of the subjects at regular intervals.

### Detecting Proximity Events

The technology disclosed can detect proximity events when the distance between a source and a sink is below a threshold. A proximity event can be detected when the distance between a source and a sink falls below the threshold distance. Note that for a second proximity event to be detected for the same source and the same sink, the distance between the source and sink needs to increase above the threshold distance. A source and a sink can be an inventory cache linked to a subject (such as a shopper) in the area of real space or an inventory cache having a location on a shelf in an inventory display structure. Therefore, the technology disclosed can not only detect item puts and takes from shelves on inventory display structures but also item hand-offs or item exchanges between shoppers in the store.

In one implementation, the technology disclosed uses the positions of hand joints of subjects and positions of shelves to detect proximity events. For example, the system can calculate the distance of left hand and right hand joints, or joints corresponding to hands, of every subject to left hand and right hand joints of every other subject in the area of real space or to shelf locations at every time interval. The system can calculate these distances at every second or at a less than one second time interval. In one implementation, the system can calculate the distances between hand joints of subjects and shelves per aisle or per portion of the area of real space to improve computational efficiency as the subjects can hand off items to other subjects that are positioned close to each other. The system can also use other joints of subjects to detect proximity events; for example, if one or both hand joints of a subject are occluded, the system can use the left and right elbow joints of this subject when calculating the distance to hand joints of other subjects and shelves. If the elbow joints of the subject are also occluded, then the system can use the left and right shoulder joints of the subject to calculate their distance from other subjects and shelves. The system can use the positions of shelves and other static objects such as bins, etc. from the location data stored in the maps database.

The technology disclosed includes logic that can indicate the type of the proximity event. A first type of proximity event can be a “put” event in which the item is handed off from a source to a sink. For example, a subject (source) who is holding the item prior to the proximity event can give the item to another subject (sink) or place it on a shelf (sink) following the proximity event. A second type of proximity event can be a “take” event in which a subject (sink) who is not holding the item prior to the proximity event can take an item from another subject (source) or a shelf (source) following the event. A third type of proximity event is a “touch” event in which there is no exchange of items between a source and a sink. Example of touch events can include a subject holding the item on a shelf for a moment and then putting the item back on the shelf and moving away from the shelf. Another example of a touch event can occur when the hands of two subjects move closer to each other such that the distance between the hands of the two subjects is less than the threshold distance. However, there is no exchange of items from the source (the subject who is holding the item prior to the proximity event) to the sink (the subject who is not holding the item prior to the proximity event). Further details of the camera placement tool for the multi-camera environment are provided below.

### Multi-Camera Environment for Automatic Camera Placement

The first step and the prerequisite for the process of defining the optimal camera placement is obtaining a 3D geometric map of the environment. Some of the ways of creating such maps include: Photogrammetry-based approaches using images taken from multiple viewpoints, Simultaneous Localization and Mapping (SLAM) based methods by using the Lidar sensor data in the environment and/or just using a rendering of the space using a 3D designer computer-aided design (CAD) tool. The map can be consumed as a mesh file or a point cloud file. Once the map is created, the map is used to extract the viewpoints of the cameras and the region of the maps seen by the cameras.

An example of such a 3D map of an area of real space built using a SLAM and photogrammetry-based approach is provided herein. Cameras can be placed on the ceiling, looking downwards at different orientations. Each camera is identified by a camera identifier. The initial camera poses can be calculated in various ways. For example, a first method to determine camera poses is using human assisted approximate positions. A second method is to generate a random initialization i.e., placing cameras at random positions in the area of real space subject to constraints. Other techniques can be applied to generate an initial placement of cameras. The initial constraints for the camera placement are taken into consideration in the initialization step. For example, if the cameras are to be placed in the ceiling, the initial positions of the cameras are placed approximately at the ceiling height. Additional constraints can also be provided as input for initial camera placement. These constraints are described in the following sections.

### Camera Model and Coverage Map

The camera model consists of the camera intrinsic matrix and the distortion values of the lens used on the camera. These values are required to understand the camera field-of-view. The distortion parameters are used to rectify and undistort the image frames obtained from the respective camera. Further details of the intrinsic and extrinsic camera parameters are described earlier in camera calibration related discussion. After the camera model and the initial camera poses are defined, the coverage for each camera can be calculated using the following high-level process operations: (1) calculating the line of sight vectors for each pixel on the image plane; (2) ray casting from each of these pixels in the 3D geometric map and obtaining the first occupied voxel hit by the ray; and (3) creation of a point cloud/voxel set that are within the view of the camera.

After the camera coverage for individual cameras is calculated, the system aggregates the coverage of all these cameras to obtain the overall coverage of all the cameras within the 3D map. This can be performed using the following high-level process steps: (1) a voxel grid of a predetermined voxel size is initiated from the given 3D geometric map of the environment; (2) each voxel within the grid is initialized with a feature vector which can contain the following fields: (2a) occupancy of the voxel; (2b) voxel category-shelf vs wall vs exit vs other; (2c) number of cameras that have the voxel in the view; (2d) list of cameras that have the voxels within view; (2e) angle of incidence from each of the cameras; and/or (2f) distance between each of the cameras and the center of the voxel; and (3) all the voxels are updated with the coverage metrics to create the coverage map. Occupancy of the voxel can indicate whether this voxel is positioned on or in a physical object such as a display structure, a table, a counter, or other types of physical objects in the area of real space etc. If the voxel is not positioned on (or in) a physical object in the area of real space then it can be classified as a non-occupied voxel representing a volume of empty space.

### Camera Coverage Constraints and Physical Placement Constraints

The camera placement generation engine generates camera placement plans for the multi-camera environment subject to constraints depending on both the generic and unique features of the environment. The following sections present further details of these constraints. Some of the physical constraints for the camera placement include fixtures on the ceiling, presence of lighting fixtures, presence of speakers, presence of heating or air conditioning (HVAC) vents etc. These physical constraints make placing cameras at certain positions challenging. The technology disclosed provides capability for automatically detecting these physical constraints and determines possible locations for placement of the cameras.

The camera placement generation engine can detect physical constraints using a combination of methods. To detect obstructions such as pipes and light fixtures, normal estimation can be used to differentiate these constraints from the flat ceiling surface. To detect obstructions such as air conditioning vents and speakers, etc. the system can use a learning-based method to automatically detect these and avoid placing cameras in these regions.

The coverage requirements can include rules that are needed for the system to perform its operations. The coverage constraints can include a number of cameras having a voxel in a structure or display holding inventory within view, or a number of cameras having a voxel in a tracking zone of volume in which subjects are tracked within view. The coverage constrains can also include a difference in angles of incidence between cameras having a voxel within view, or an overall coverage of the 3D real space, etc. For example, in order to perform triangulation for tracking, at least two cameras looking at each voxel in the tracking zone is required. Similarly, cameras looking into the shelves are required to predict the items in the shelves. It is understood that different coverage requirements can be set for different areas of real space or different deployments of the system. The technology disclosed can determine an improved camera placement plan by considering the coverage constraints set for the particular deployment in an area of real space. Following are some examples of coverage constraints that can be used when determining camera placement: (1) each voxel in the shelf is seen by at least three cameras; (2) each voxel in the tracking zone is seen by two or more cameras with at least 60 degrees difference in angle of incidence; (3) the overall coverage of the store is more than 80% with simulated people walking in the store.

Using the coverage metrics indicating the camera coverage and the physical and coverage constraints, the technology disclosed can define an objective function that maximizes the coverage score while minimizing the number of cameras. Optimization of this objective function can provide the top few camera placement setups which can be verified and finalized before installation.

Other examples of constraints can include: shelves are seen at an angle of approximately 90 degrees, the neck plane (the plane at which neck joints are tracked) be observed with a camera angle of at least 45 degrees with respect to ceiling (or roof), two cameras be placed at positions at least 25 centimeters apart, etc. In some stores, large items may be placed on shelves which can block view of aisles or other display structures positioned behind the shelves containing large or tall items on top shelves. The camera placement generation engine can consider the impact of such items when calculating the camera coverage. In such cases, additional cameras may be needed to provide coverage of display structures or aisle obstructed by tall or large items. In one implementation, the camera placement generation engine can include logic to determine an improved camera coverage for a particular camera placement plan in the area of real space by changing positions of display structures including shelves, bins and other types of containers that can contain items in the area of real space. The system can include logic to improve the camera coverage for display structures and subject tracking by rearranging or moving the display structures in the area of real space.

The camera placement generation engine can also determine the coverage of 360-degree cameras (omnidirectional cameras). These cameras are modeled with larger fields of view in comparison to traditional rectilinear lens cameras. The camera model of these cameras can have a field of view of 360 degrees horizontal and 180 degrees vertical. As the cameras are omnidirectional the computation of orientation is not required. The orientation of 360-degree cameras is determined by the surface to which they are attached to. The positions of the cameras are added in the search space and the method disclosed can compute the optimal positions and number of cameras to fulfill the required coverage constraints. The final camera placement is defined as a set of 6D poses for the cameras with respect to the defined store origin. Each camera pose has the position (x,y,z) and the orientation (rx, ry, rz). Also, each camera position is accompanied by an expected view from the camera for ease of installation.

### Process for Determining Camera Placement

The technology disclosed presents a tool to estimate the number of cameras in the area of real space to support tracking subjects and detecting item take and puts. Calculating the number of cameras required to have optimal coverage in an environment is a challenge. For a multi-camera computer vision system, having proper coverage is important for operations of the monitoring system.

The technology disclosed can provide a coverage plan for an area of real space. The system can include the following features: (1) optimize for a particular system for monitoring, or other systems, the number of cameras for maximum coverage of a space respecting the constraints of where and how cameras can be installed; (2) automatically provide camera coverage analysis in indoor spaces suited for a particular system for monitoring, or other systems; (3) take into account various constraints such as number of cameras to be viewing a specific point in space, angle at which the cameras should see a point, etc. for a particular system for monitoring, or other systems; and (4) determine scores on the coverage quality with simulated people walking in the space with different shopper personas for a particular system for monitoring, or other systems.

The camera placement generation engine can determine camera coverage maps for subjects, shelves and other objects of interest in the area of real space. The camera placement generation engine includes logic to determine a set of camera coverage maps per camera including one of a set of occupied voxels representing positions of simulated subjects on a plane at some height above a floor of the 3D real space through which simulated subjects would move through. In one implementation, the system can track subject using neck positions or neck joints at a plane 1.5 meters above the floor. Other values of height above the floor can be used to detect subjects. Other feature types such as eyes, nose or other joints of subjects can be used to detect subjects. The system can then aggregate camera coverage maps to obtain aggregate coverage map based upon the set of occupied voxels.

The camera placement generation engine includes logic to determine a set of camera coverage maps per camera including one of a set of occupied voxels representing positions on a shelf in field of view. The system can then aggregate camera coverage maps to obtain aggregate coverage map for the shelf based upon the set of occupied voxels. The system can combine coverage maps for subjects and shelves to create overall coverage maps. The system can apply various threshold based on the constraints to select particular coverage maps per camera or aggregate coverage maps. For example, the system can apply coverage threshold to shelf coverage maps. The threshold can comprise at least 3 cameras visiting voxels representing positions on a shelf in field of view. Other threshold values above or below 3 cameras visiting voxels in shelves can be applied to select coverage maps. The system can apply to the aggregate coverage map, a coverage threshold comprising a range of 80% or greater of a plane at some height above a floor of the 3D real space through which simulated subjects would move through. It is understood that other values of threshold above or below 80% can be used to select coverage maps. The system can apply to aggregate coverage map, a coverage threshold comprising at least 2 cameras with at least 60 degrees angle of incidence covering select portions of a plane at some height above a floor of the 3D real space through which simulated subjects would move through. Other values of threshold greater than or less than 60 degrees angle of incidence can be used to select coverage maps.

In one implementation, the technology disclosed determines a set of camera location and orientation pairs in each iteration of the process flow described here such that the physical and coverage constraints are guaranteed. The objective function can be formulated to assign scores to camera placement plans based on coverage of shelves, coverage of tracking zones in which subjects can move, etc. The technology disclosed can determine camera placement plans using various criteria. For example, using a camera minimization criterion, the system can generate camera placement plans that reduce (or minimize) the number of cameras which satisfy the coverage and physical/placement constraints. Using a coverage maximization criterion, the system can generate camera placement plans that increase (or maximize) the camera coverage while keeping the number of cameras as fixed. The objective function can assign scores to camera placement plans generated by different criteria and select a top 3 or top 5 camera placement plans. A camera placement plan from these plans can be selected to install the cameras in the area of real space.

In another implementation, the camera placement generation engine can generate different camera placement plans such that each plan improve coverage of either shelves or tracking subjects. In this implementation, the camera placement generation engine generates an improved camera placement plans in two steps. For examples, in a first operation, the system iteratively generates a camera placement plan that provides improved coverage of shelves. Then this camera placement plan is provided as input to a second operation in which this camera placement plan is further iteratively adjusted to provide improved coverage of subject tracking in the area of real space.

FIG. 5A presents visualizations showing all possible camera locations in an area of real space in blue color. The orientation of cameras at all possible locations in the area of real space are indicated in red color. In this example, the cameras are assumed to be positioned at or near the ceiling of the area of real space and orientation of cameras are towards the floor and shelves positioned in the area of the real space. The red colors in the illustrations represent direction vectors from cameras with respective orientations. Further details of generation of automatic generation of camera placement plan for an area of real space is presented in U.S. patent application Ser. No. 17/358,864, entitled. “Systems and Method for Automated Design of Camera Placement and Cameras Arrangements for Autonomous Checkout.” filed on 25 Jun. 2021, now issued as U.S. Pat. No. 11,303,853 which is fully incorporated into this application by reference. The following description presents details of the automatic calibration and recalibration of cameras in the multi-camera environment.

### Multi-Camera Environment for Automatic Camera Re-Calibration

FIG. 5B presents an example of multi-camera (or multi-sensor) environment. The illustration shows multiple inventory display structures 511, 513, 515, and 517 in the store and cameras C1, C2, C3, C4, C5, C6, C7, C8, C9, C10, C11, C12, C13, C14, C15, C16, C17, C18, C19, C20, C21, and C22, positioned at different places with respective orientations. In the following section, details of the camera calibration engine (or camera calibration tool) implementing automatic extrinsic camera calibration and recalibration are presented. The camera calibration tool can be used to automatically calibrate a camera which drifts over a period of time after the initial calibration.

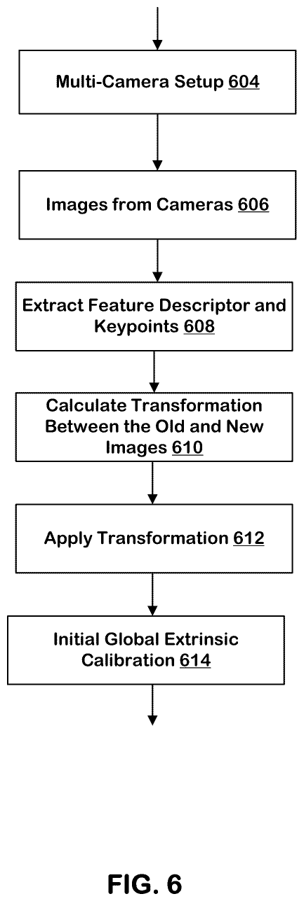

FIG. 6 presents an overview of the automatic extrinsic camera calibration method implemented by the proposed camera calibration engine or camera calibration tool of FIG. 1. The camera calibration tool is applied to determine the extrinsic calibration of cameras. In one implementation, the autonomous checkout environment presented herein can include classification engines to process sequences of images generated by cameras to predict joints of subjects as described above. The system can then project the positions of joints in three dimensions by using overlapping images from cameras to determine positions of joints in the area of real space. The system includes logic to combine joints of a subject to form a subject as a galaxy of joints in the area of real space. The system then processes sequences of images over time and updates the positions of subjects as they move in the area of real space. Further details of subject tracking are presented in U.S. patent application Ser. No. 15/847,796, entitled. “Subject Identification and Tracking Using Image Recognition Engine.” filed on 19 Dec. 2017, now issued as U.S. Pat. No. 10,055,853, which is fully incorporated into this application by reference.

The monitoring system includes logic to process sequences of images to detect items taken by subjects from inventory display structures or items put by subjects on inventory display structures. The system can detect takes and puts of items by subjects in the area of real space. The system can include multiple image processing pipelines to detect inventory events that can indicate items taken by subjects or items put on shelves by the subjects. For example, in a first image processing pipeline, the system can process hand images of subjects to detect items in hands and classify the images to detect which item is related to the inventory event. The system can include a second image processing pipeline that can detect inventory events by processing images of shelves and detecting items taken from or put on the shelves. The system can also include a third image processing pipeline that can process location events when a source and a sink are positioned closer to each other than a threshold distance. Examples of sources and sinks can include subjects, shelves, or other display structures that can hold inventory items. Further details how sources and sinks of inventory items are used to detect inventory events are presented in U.S. patent application Ser. No. 17/314,415, entitled, “Systems and Method for Detecting Proximity Events.” filed on May 7, 2021 which is fully incorporated into this application by reference.

Detecting takes and puts of inventory items by using multiple image processing pipelines increases the reliability of detected inventory events. The system can combine results from two or more take/put techniques to update the shopping cart data structures or log data structures of subjects. For example, the technique described above using sources and sinks of inventory items to detect inventory events can be used in combination with semantic diffing technique for detecting inventory events. Further details of semantic diffing technique are presented in in U.S. patent application Ser. No. 15/945,466, entitled. “Predicting Inventory Events using Semantic Diffing.” filed on 4 Apr. 2018, now issued as U.S. Pat. No. 10,127,438, and U.S. patent application Ser. No. 15/945,473, entitled, “Predicting Inventory Events using Foreground/Background Processing.” filed on 4 Apr. 2018, now issued as U.S. Pat. No. 10,474,988, both of which are fully incorporated into this application by reference.

The camera calibration engine or the camera calibration tool can estimate the extrinsic calibration of cameras in the area of real space to support tracking subjects and detecting item takes and puts. FIG. 6 is a high-level process flow that indicates inputs, processing operations and outputs from the proposed tool. The process starts with an existing multi-camera setup in the area of real space (operation 604). The system can also provide a camera model as an input to the process. The camera model consists of a camera intrinsic matrix and the distortion values of the lens as presented above.

The system then processes images (operation 606) from a camera in the real space and extracts feature descriptors and keypoints (or landmarks) (operation 608). A keypoint can be a group of pixels in the image. The feature descriptors can correspond to points located at displays or structures that remain substantially immobile. Examples of structures in a real space can include inventory display structures such as shelves, bins, stands, etc. The structures can also include other types of objects or fixtures such as pipes, outlets, air-conditioning and/or heating vents, speakers, cash registers, point of sale (POS) units, hinges, exit or other signs, art on the wall, handles on windows or doors, etc. Thus, items in shelves of bins that can be frequently taken or placed at different locations during operation of the store are not used as feature descriptors or keypoints.

The system then calculates the transformation between the old image and new image from the same camera using the descriptors or keypoints (operation 610). The system then applies the transformation for each camera with respect to a store origin (operation 612). A store origin can be any point that is selected as a reference point for calibration. For example, reference point can be a corner of the store or a corner of a shelf in the store. The transformation results in an initial global extrinsic calibration (operation 614) and can be stored in the calibration database 150. After the initial calibration of the cameras, it is a challenge to maintain the calibration of multiple cameras in the area of real space due to multiple external factors that can drift or move cameras. For example, the one or more cameras in the multi-camera environment can drift due to vibrations in the building, due to cleaning or due to intentional displacement. The drift in one or more cameras can change the extrinsic calibration values, thus requiring recalibration. For a multi-camera computer vision system, camera extrinsic calibration is critical for the reliable tracking of subjects and detection of takes and puts of items during operations of the autonomous checkout. Ensuring that the cameras are calibrated during the operation of the store is important for the implementation of systems like monitoring, autonomous checkout, security and surveillance etc.

The technology disclosed can keep the cameras calibrated over time during the operation of store (or monitoring) using an automated recalibration method given an initial extrinsic calibration of the cameras. The system can include logic to periodically compare the current camera image frame to the image frame from the same camera used to previously calibrate, and the transformation between the two frames (if any) is then applied to the global pose of the camera in order to obtain the updated extrinsic calibration. This helps keep the multi-camera systems continuously calibrated to assist in the systems performance. The technology disclosed can include a robust feature descriptor extraction logic for indoor environments using machine learning, automated periodic camera recalibration and logic to keep extrinsic calibration of multi-camera setups, up to date.

### Camera Model and Camera Calibration

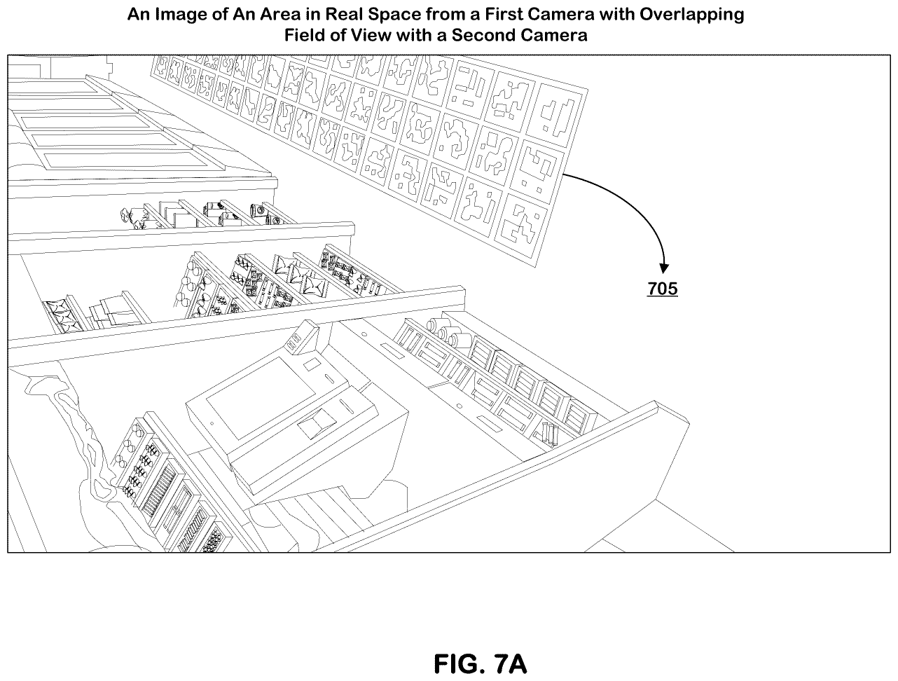

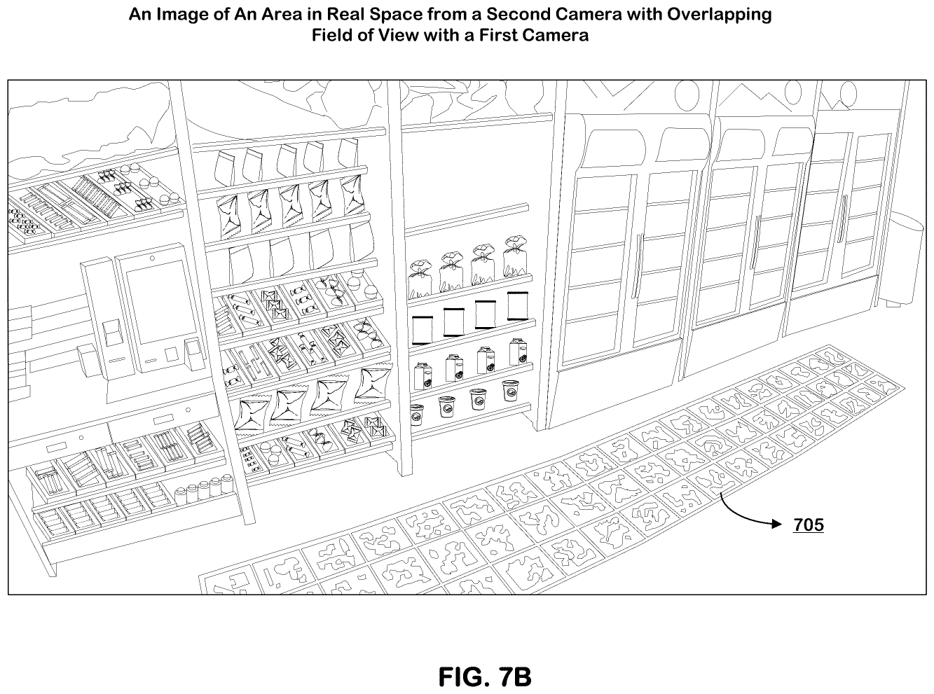

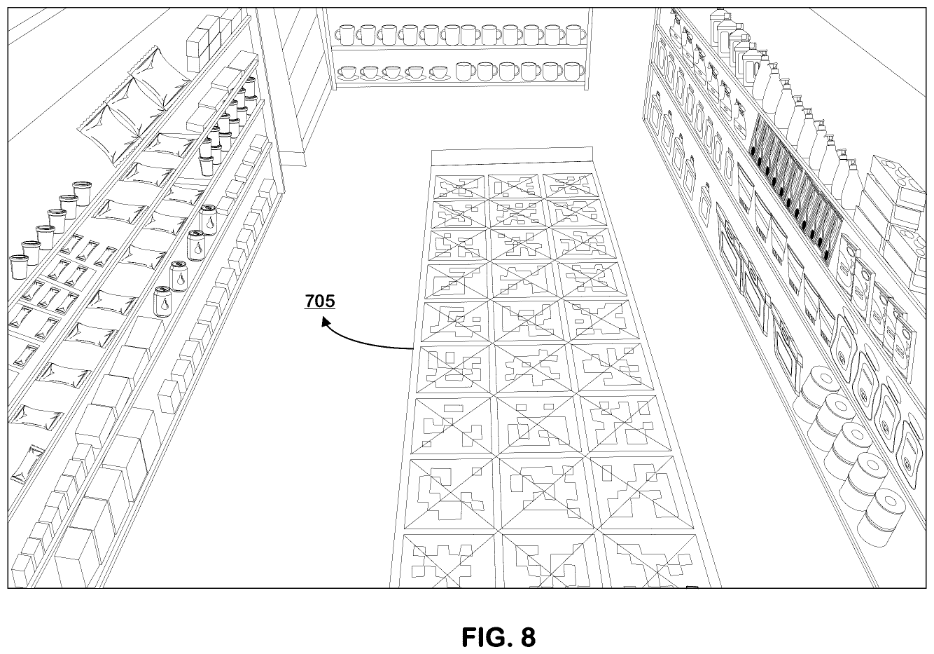

The camera model consists of the camera intrinsic matrix and the distortion values of the lens used on the camera. These values are required to understand the camera field-of-view and the distortion parameters that will be used to rectify and undistort the image frames obtained from the respective camera. Existing methods for performing extrinsic calibration in a multi-camera setup consist of the use of Fiducial markers like ArUco patterns, April tags, etc. The dimensions of these markers are predetermined and when a particular marker is observed in multiple cameras, the transformation between the two cameras is calculated based on the scale, position and orientation of the markers in each of the camera views. FIG. 7A shows an image from a first camera in the area of real space and FIG. 7B presents an image from a second camera with Fiducial markers 705 positioned on the floor for the calibration of the cameras. We can see that the orientations of the two cameras are different but they have overlapping fields of view. FIG. 8 presents an image from another camera, which includes Fiducial markers 705 placed on the floor of the store. In the following sections, we present further details of our proposed tool to calibrate and recalibrate the cameras in the area of real space.

### Camera Calibration Tool

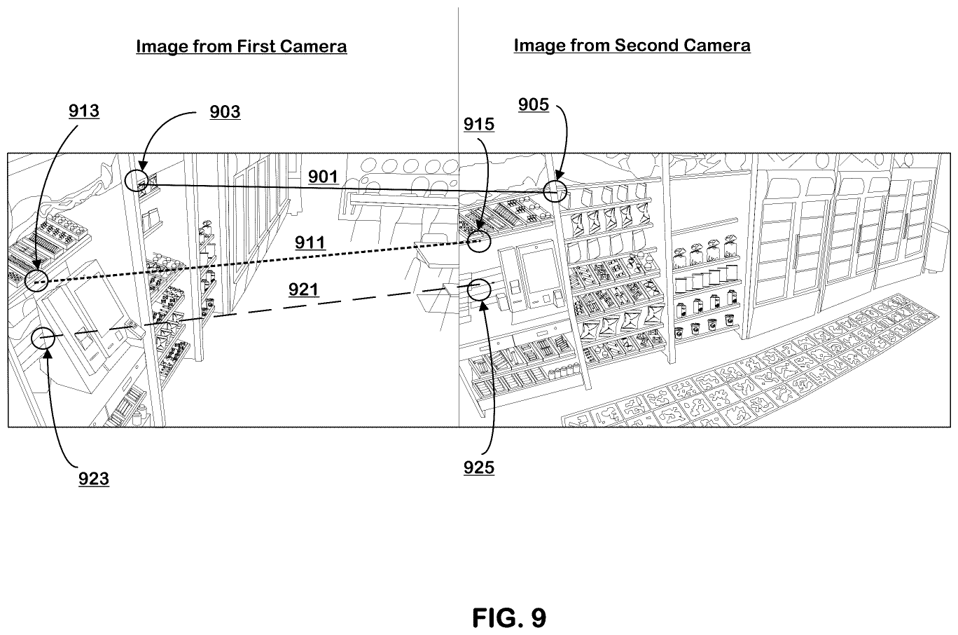

The camera calibration tool or camera calibration engine 190 can use learned keypoints and feature descriptors detected in each of the camera images and then perform feature matching to obtain the transformation between each pair of cameras. For example, FIG. 9 presents two images from two separate cameras or sensors with overlapping fields of view. The lines across the two images indicate a successful match of a feature descriptor between the two images. An image from a first camera is shown on the left and an image from a second camera is shown on the right. We show only three lines 901, 911, and 921 to illustrate the matching of keypoints or feature descriptors across the two images. In practice, hundreds or more keypoints or feature descriptors can be matched across images. The line 901 matches keypoints 903 and 905 across the two images. Both keypoints represent the same location in the area of real space. Similarly, line 911 matches keypoints 913 and 915 and line 921 matches keypoints 923 and 925 respectively. The technology disclosed includes one implementation that can match features descriptors (or keypoints) in the range of about one hundred to one million feature descriptors. In some implementations, the technology disclosed employs less than one hundred feature descriptors but greater than one. In some implementations, greater than one million feature descriptors can be used. In some implementations, feature descriptors in other ranges such as about one thousand to about one million or about ten to about one million feature descriptors can be matched.

Once the transformations between individual pairs of cameras are calculated, the tool performs a graph search to generate the transformations of all the cameras with respect to a single origin coordinate. Two example techniques that can be used by the technology disclosed to match images by using extracted feature descriptors are presented here. It is understood that other techniques can also be used for this purposed. A first technique uses traditional feature descriptor extraction-like Scale Invariant Feature Transform (SIFT) features. This method is fast and easier to implement. However, it may not be robust to changes in the angles of incidence and large differences between the camera views. The second technique is to learn keypoint detection and feature descriptor extraction using machine learning methods. Further details of this technique are presented in the following section. Once the individual transformations between the images are obtained, we can have multiple transformations between pairs of cameras. The camera calibration tool can then initialize a graph with these transformations and solve the graph to extract the most robust extrinsic calibration among all the possibilities.

### Learned Feature Descriptor Extraction

A neural network classifier can be trained to extract feature descriptors. The neural network can be trained using a synthetic shapes dataset. The neural network can be trained using a plurality of synthetic shapes having no ambiguity in interest point locations. The synthetic shapes can comprise 3D models created automatically. A plurality of viewpoints can be generated for the 3D models for matching features extracted from the set of calibration images. Three-dimensional models can be finetuned by data collected from like real space environments having matching features annotated between different images captured from different viewpoints.

Various architectures can be applied to learn robust keypoint and feature descriptor extraction for feature matching between cameras in store environments. One such approach is presented by DeTone et al. in their paper titled, “Superpoint: Self-supervised interest point detection and description” available at <arxiv.org/abs/1712.07629>. We have adapted hyperparameters presented in this paper for training our model. Examples of hyperparameters that have been adapted include batch size, learning rate, number of iterations or epochs, etc. In one implementation, the values of these hyperparamters are batch_size=64, learning_rate=le⁻³, number_of_iterations/epochs=200,000.

Two types of training data can be used for model training. The first is open source datasets for keypoint detection like the MS COCO dataset available at http://cocodataset.org/#home. The second type of training data is the synthetic shapes dataset created by a tool developed for this purpose. The tool can generate various types of training data using commands such as ‘draw_lines’. ‘draw polygon’. ‘draw_multiple_polygons’. ‘draw_ellipses’. ‘draw_star “. ‘draw_checkerboard’. ‘draw_stripes’. ‘draw_cube’. ‘gaussian_noise’, etc. The synthetic shapes can be 3D models created automatically, and various viewpoints are generated for these models and used for matching features. These models are further fine-tuned by the data collected from store environments with annotated matching features between different images captured from different viewpoints. The final camera setup is defined as a set of six-dimensional (6D) transformations for the cameras with respect to the defined store origin. Each camera transformation gives information about the position (x,y,z) and the orientation (rx, ry, rz) of the camera.

### Camera Recalibration Process

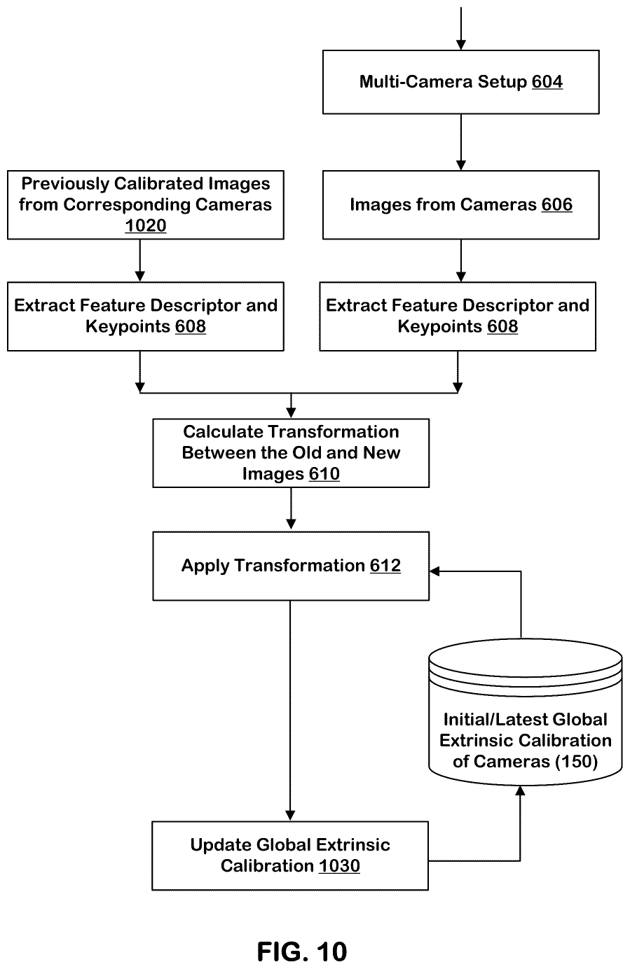

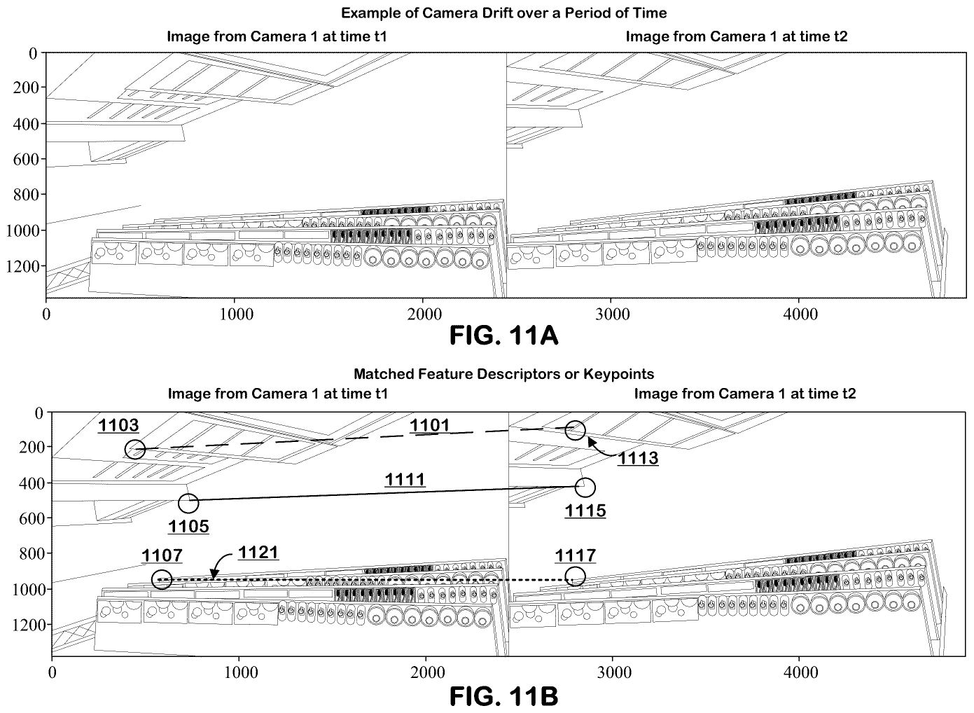

In real world environments the cameras drift from their initial poses due to vibrations in the building, accidental displacement while cleaning, intentional displacement of the cameras, etc. In order to fix the displacement of the cameras, the current and most commonly used method is to perform calibration again for the entire store using fiducial markers to obtain the accurate calibration between the cameras. The automatic recalibration method (presented in FIG. 10) can help keep the cameras consistently calibrated by periodically performing the feature extraction from each image and comparing it with the image captured at a previous calibration measurement. The process starts with a multi-camera setup 604, followed by receiving images from cameras (606) and extraction of feature descriptors and keypoints (608).

For each camera, the transformation between the old and new images is calculated and if the rotation or translation of the camera is above a predetermined threshold value (usually 1 degree in rotation or 1 centimeter in translation), then the extrinsic calibration parameters of the cameras are updated by applying the newly obtained drift added to the original pose. The system can access previously calibrated images from corresponding cameras from a database in a operation 1020. Transformation can be calculated using the feature descriptors or keypoints of new and old images at a operation 610. The changes in rotation can occur in +/−1 degree to +/−5 degrees increments. The system can handle incremental rotation changes up to a 30 degree change in rotation values along any one of the three axes. If the change is more than this value then a manual reset of the camera may be required to achieve desired overlap of field of view the camera with other cameras. Some system implementations can handle changes in rotation that are less than +/−1 degree increments. The final camera setup is defined as a set of 6D transformations for the cameras with respect to the defined store origin. Each camera transformation gives information about the position (x,y,z) and the orientation (rx, ry, rz) of the camera.

The technology disclosed compares the feature descriptors or keypoints from the current image to the same from previously calibrated images from corresponding cameras. The system then calculates the transformation between the old images and the new images from respective cameras. For each camera, the system can then compare the change in the transformation between the new and old image and compare the difference with a threshold (612) to determine whether to apply the transformation to existing calibration data. For example, if the difference in rotation is one tenth of a degree or difference in translation is greater than 1 mm, then the system can determine that the camera has moved as compared to its previous position when it was calibrated. It is understood that the system can use different values of thresholds for determining the displacement of the camera with respect to its previous position and orientation. If it is determined that the camera has drifted (or moved) with respect to its previous position, the system applies the transformation for the camera with respect to the store origin.

Note that, when one camera drifts, the system does not make changes to the calibration of other cameras which have not drifted. The system updates the global extrinsic calibration (1030) using the delta of the position of the camera which has drifted. The system uses the delta indicating how much the camera has moved with respect to its previous position and uses the delta to update the transformation between the camera and the store origin. The updated global extrinsic calibration replaces the initial or current global extrinsic calibration of the cameras stored in the calibration database 150. In a next iteration of a recalibration process, the updated global extrinsic calibration of cameras is used as the current global extrinsic calibration of cameras. An example of the recalibration process using images from a store is presented below. FIG. 11A shows the images obtained from the same camera on two different days. The first image was captured during the initial calibration of the cameras and the second after a few days. It can be seen that the camera has drifted or displaced (towards the right) and the transformation of the camera obtained previously is no longer valid. The proposed method captures the feature descriptors from both images and calculates the drift of the camera in the 6 dimensions (x,y,z,rx,ry,rz) and then applies this to the original transformation to keep the pose of the camera accurate with respect to the store origin.

FIG. 11B presents lines that match feature descriptors across two images in FIG. 11A. When selecting the keypoints (or feature descriptors), the system selects features that are static and not dynamic. For example, the system can select features that are outside shelves or on the inventory display structures. The features corresponding to items on shelves can be dynamic as the items can be taken or placed on shelves by subjects (such as customers). In one implementation, about hundred to about one million or more feature descriptor or keypoints can be selected for matching. As described above, however, some implementations of the system can use less than a hundred or more than one million feature descriptors for matching. In FIG. 11B we show only three matching feature descriptors or keypoints for two images i.e., image at time t1 and image at time t2 from a same camera. Matched feature descriptors are connected by lines 1101, 1111, and 1121. The lines match corresponding feature descriptors in the two images. The feature descriptor 1103 is matched to feature descriptor 1113 via the line 1101. The feature descriptor 1105 is matched to feature descriptor 1115 via the line 1111 and the feature descriptor 1107 is matched to feature descriptor 1117 via the line 1121. The images captured by calibrated (and recalibrated) cameras are used by the autonomous checkout system of FIG. 1 to track subjects in the area of real space and detect proximity events. We now present the subject data structures and process operations for subject tracking. Following this, we present the details of the joints CNN model that can be used to identify and track subjects in the area of real space. An example initial camera calibration process and event detection process are also presented in the following sections.

### Subject Data Structure

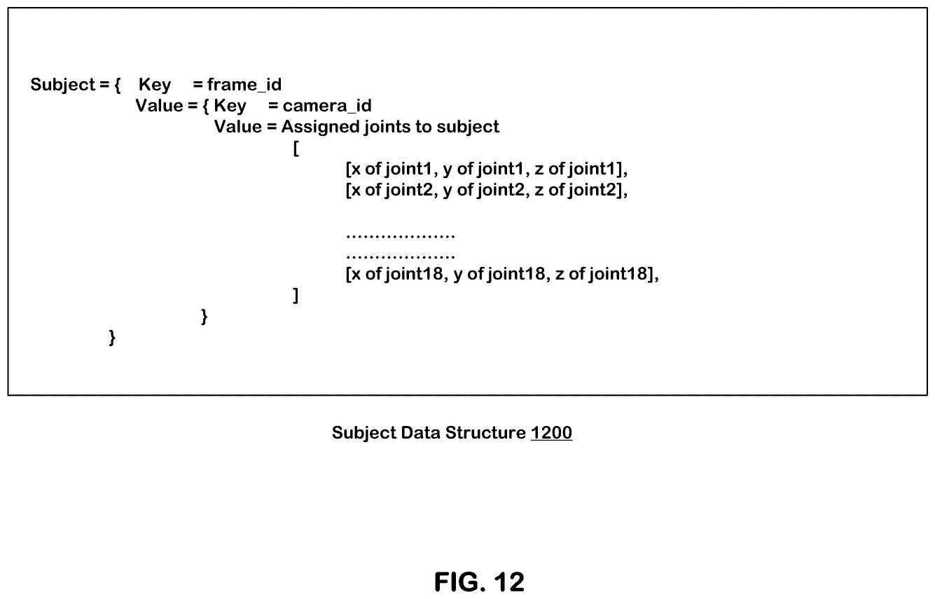

The joints of the subjects are connected to each other using the metrics described above. In doing so, the subject tracking engine 110 creates new subjects and updates the locations of existing subjects by updating their respective joint locations. FIG. 12 shows the subject data structure 1200 to store the subjects in the area of real space. The data structure 1200 stores the subject-related data as a key-value dictionary. The key is a frame_number and the value is another key-value dictionary where the key is the camera_id and the value is a list of 18 joints (of the subject) with their locations in the real space. The subject data can be stored in the subject database 140. Every new subject is also assigned a unique identifier that is used to access the subject's data in the subject database 140.

In one implementation, the system identifies joints of a subject and creates a skeleton of the subject. The skeleton is projected into the real space indicating the position and orientation of the subject in the real space. This is also referred to as “pose estimation” in the field of machine vision. In one implementation, the system displays orientations and positions of subjects in the real space on a graphical user interface (GUI). In one implementation, the image analysis is anonymous, i.e., a unique identifier assigned to a subject created through joints analysis does not identify personal identification details (such as names, email addresses, mailing addresses, credit card numbers, bank account numbers, driver's license number, etc.) of any specific subject in the real space.

### Process Flow of Subject Tracking

A number of flowcharts illustrating subject detection and tracking logic are described herein. The logic can be implemented using processors configured as described above programmed using computer programs stored in memory accessible and executable by the processors, and in other configurations, by dedicated logic hardware, including field programmable integrated circuits, and by combinations of dedicated logic hardware and computer programs. With all flowcharts herein, it will be appreciated that many of the operations can be combined, performed in parallel, or performed in a different sequence, without affecting the functions achieved. In some cases, as the reader will appreciate, a rearrangement of operations will achieve the same results only if certain other changes are made as well. In other cases, as the reader will appreciate, a rearrangement of operations will achieve the same results only if certain conditions are satisfied. Furthermore, it will be appreciated that the flow charts herein show only operations that are pertinent to an understanding of the implementations, and it will be understood that numerous additional operations for accomplishing other functions can be performed before, after and between those shown.

FIG. 13A is a flowchart illustrating process operations for tracking subjects. The process starts at an operation 1302. The cameras 114 having fields of view in an area of the real space are calibrated in process operation 1304. The calibration process can include identifying a (0, 0, 0) point for (x, y, z) coordinates of the real space. A first camera with the location (0, 0, 0) in its field of view is calibrated. More details of camera calibration are presented earlier in this application. Following this, a next camera with an overlapping field of view with the first camera is calibrated. The process is repeated at operation 1304 until all cameras 114 are calibrated. In a next process operation of camera calibration, a subject is introduced in the real space to identify conjugate pairs of corresponding points between cameras with overlapping fields of view. Some details of this process are described above. The process is repeated for every pair of overlapping cameras. The calibration process ends if there are no more cameras to calibrate.

Video processes are performed at an operation 1306 by image recognition engines 112a-112n. In one implementation, the video process is performed per camera to process batches of image frames received from respective cameras. The output of all or some of the video processes from respective image recognition engines 112a-112n is given as input to a scene process performed by the tracking engine 110 at an operation 1308. The scene process identifies new subjects and updates the joint locations of existing subjects. At an operation 1310, it is checked whether there are more image frames to be processed. If there are more image frames, the process continues at an operation 1306, otherwise the process ends at an operation 1312.

More detailed process steps of the process operation 1304 “calibrate cameras in real space” are presented in a flowchart in FIG. 13B. The calibration process starts at operation 1352 by identifying a (0, 0, 0) point for (x, y, z) coordinates of the real space. At operation 1354, a first camera with the location (0, 0, 0) in its field of view is calibrated. More details of camera calibration are presented earlier in this application. At operation 1356, a next camera with an overlapping field of view with the first camera is calibrated. At operation 1358, it is checked whether there are more cameras to calibrate. The process is repeated at operation 1356 until all cameras 114 are calibrated. In a next process operation 1360, a subject is introduced in the real space to identify conjugate pairs of corresponding points between cameras with overlapping fields of view. Some details of this process are described above. The process is repeated for every pair of overlapping cameras at operation 1362. The process ends if there are no more cameras (operation 1364).

### Camera Calibration Using Extrinsic Calibration Tool

FIG. 13C presents process operations for using the extrinsic calibration tool 113 to perform initial calibration of cameras in the area of real space. The process operations are performed for external calibration of cameras in the area of real space. The area of real space can be a store in which shoppers can move around in open spaces and in aisle between inventory display structures. The shoppers can take items from shelves or other types of inventory display structures. Traditional extrinsic camera calibration techniques can require placement of special markers in the store which may not be feasible due to presence of customers. Therefore, existing extrinsic camera calibration techniques can disrupt store operations. The technology disclosed presents calibration techniques that can be used for extrinsic calibration of cameras without requiring any special markers and thus do not disrupt store operations.

The process starts at an operation 1372 in which the system receives a first set of one or more images selected from a plurality of sequences of images received from a first plurality of cameras comprising an extrinsic calibration tool. The images in the plurality of sequences of images have respective fields of view in the real space. The first plurality of cameras are selected from one or more of mobile visual spectrum sensitive cameras, lidar, etc. The process continues at an operation 1374 in which the system extracts from the images, a 3D point cloud of points captured in the images. The points can correspond to features in the real space. The points in the 3D point cloud can correspond to points located at displays or structures that remain substantially immobile and devoid of special markers. Therefore, such points in the 3D point cloud can remain at fixed locations in the area of real space for extended periods of time such as over many days, weeks, months, etc. The 3D point cloud is aligned to a coordinate system (x₀, y₀, z₀) of the camera installation in the real space.

The method can use trained machine learning models to extract points in the 3D point cloud corresponding to points located at displays or structures that remain substantially immobile. The technology disclosed can use a trained neural network model such as 2D3D-MatchNet model. The 2D3D-Match Net can learn descriptors of the 2D and 3D keypoints extracted from an image and a point cloud. This allows mapping of keypoints across a 2D image and a 3D point cloud. An image patch can be used to represent an image keypoint and a local point cloud volume can be used to represent a 3D keypoint. The model can learn the keypoint descriptors of a given image patch and point cloud volume such that the distance in the descriptor space is small if the 2D and 3D keypoint are a matching pair, and large otherwise. The input to the model are image patches centered on the 2D image keypoints and local volume of point cloud. For further details on the 2D3D MatchNet, the skilled person may have to reference «arxiv.org/pdf/1904.09742.pdf» the entirety of which is incorporated herein by reference for all purposes. Of course, other 2D to 3D matching techniques can also be used in various implementations without departing from the scope of the present technology. The technology disclosed can also use other unsupervised learning techniques to extract features from point cloud. In one implementation, the method includes scanning a store to create the 3D point cloud.

The method includes receiving a second set of one or more images selected from a plurality of sequences of images received from a second plurality of cameras (operation 1376). The second plurality of cameras are selected from one or more of Pan-Tilt-Zoom (PTZ) cameras and 360 degree cameras fixedly installed in the real space. The cameras are positioned at locations <(xᵤₙₖ, yᵤₙₖ, zᵤₙₖ) . . . >comprising a camera installation in the real space such as a store. The images in the plurality of sequences of images received from a second plurality of cameras have respective fields of view in the real space. In one implementation, the calibration method includes obtaining input comprising a virtual placement plan describing an initial or prospective camera installation in the real space for the second plurality of cameras. The second plurality of cameras are positioned in locations <(xᵤₙₖ, yᵤₙₖ, zᵤₙₖ) . . . > in the real space in which physical cameras are installed or are to be installed.

The method includes matching a set of 2D images of the second set of one or more images received from the second plurality of cameras to corresponding portions of the 3D point cloud (operation 1380). The 2D images of the second set of one or more images are selected from the plurality of sequences of images received from the second plurality of cameras. The system can perform the matching of the 2D images to portions of 3D point cloud using a trained neural network classifier. The trained neural network classifier is trained to classify points in the point cloud as having a projection that is either within or beyond an image frustrum. An iterative algorithm may be used to determine an “optimal” or “best fit” value for camera position, including a rigid transformation with respect to the coordinate system of the 3D point cloud, in which points labeled as within the image frustrum are correctly projected into an image. In one implementation the iterative algorithm includes applying a Gauss-Newton algorithm to solve for the optimal camera position.

The method includes determining transformation information between the matched 2D image and the corresponding portion of the 3D point cloud (operation 1382). The transformation information can be determined from differences in position of at least three points <(x₁, y₁, z₁), (x₂, y₂, z₂), (x₃, y₃, z₃)> in a matched 2D image and a corresponding portion of the 3D point cloud. In one implementation, the transformation information is determined relative to an origin point that is selected as a reference point for calibration. A corner of the area of real space or another location such as a corner of an inventory display structure can be selected as the reference point and assigned origin coordinate values such as (x₀, y₀, z₀). The system can store the transformation information and images used to calibrate the cameras in a database.

The extrinsic camera calibration method includes applying the transformation information to image information from at least one of the second plurality of cameras to calibrate at least one physical camera at location (xᵤₙₖ, yᵤₙₖ, zᵤₙₖ) to the coordinate system (x₀, y₀, z₀) (operation 1384). The system checks at a process operation 1386 if there are more cameras installed in the area of real space that require external calibration. If there are more cameras that require external calibration then the process continues at a process operation 1382, otherwise, the process ends.

In one implementation, the system can include logic to determine the values for locations of cameras in the second plurality of cameras that are fixedly installed in the area of real space. The system can determine the values for locations <(xᵤₙₖ, yᵤₙₖ, zᵤₙₖ) . . . > for the second plurality of cameras in the real space from apparent positions <(xₐₚₚ, yₐₚₚ, zₐₚₚ) . . . > of the second plurality of cameras. The apparent positions of the second plurality of cameras are obtained from corresponding portions of the 3D point cloud, as matched by the trained neural network classifier to 2D images taken by the second plurality of cameras positioned in locations <(xᵤₙₖ, yᵤₙₖ, zᵤₙₖ) . . . > in the real space.

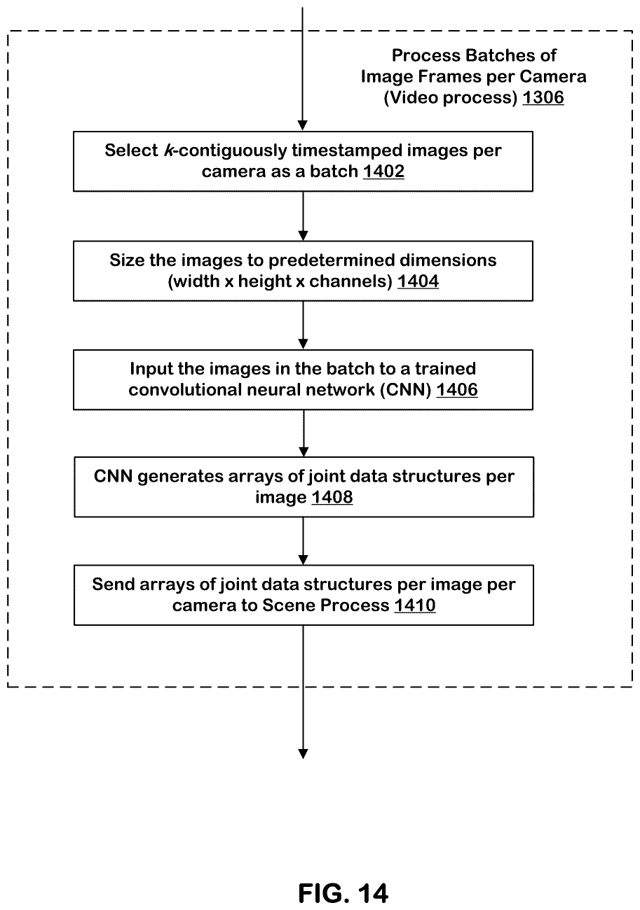

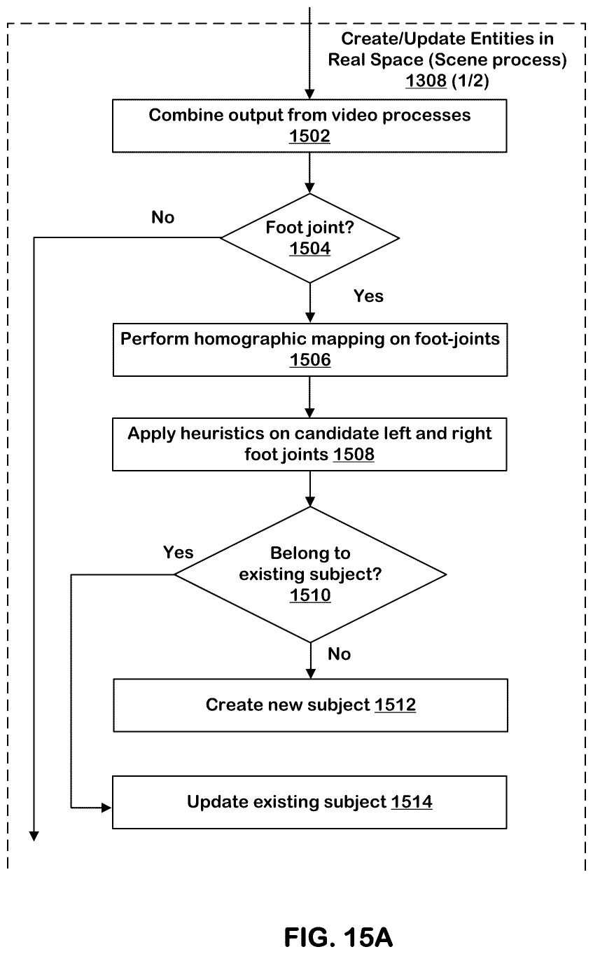

A flowchart in FIG. 14 shows more detailed operations of the “video process” operation 1306 in the flowchart of FIG. 13A. At operation 1402, k-contiguously timestamped images per camera are selected as a batch for further processing. In one implementation, the value of k=6 which is calculated based on available memory for the video process in the network nodes 101a-101n, respectively hosting image recognition engines 112a-112n. It is understood that the technology disclosed can process image batches of greater than or less than six images. In a next step 1404, the size of the images is set to appropriate dimensions. In one implementation, the images have a width of 1280 pixels, a height of 720 pixels and three channels RGB (representing red, green and blue colors). At operation 1406, a plurality of trained convolutional neural networks (CNN) process the images and generate arrays of joints data structures per image. The output of the CNNs are arrays of joints data structures per image (operation 1408). This output is sent to a scene process at operation 1410.

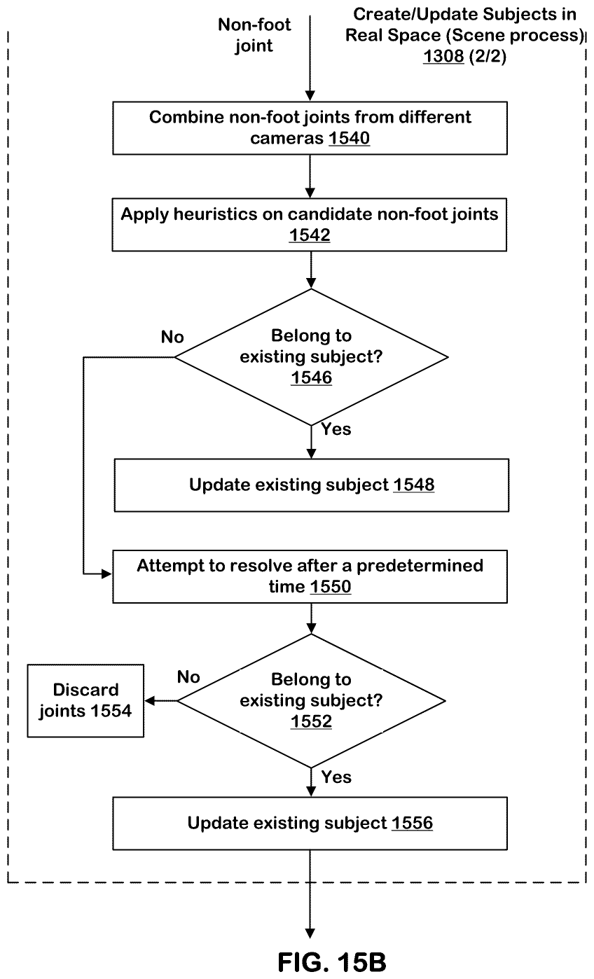

FIG. 15A is a flowchart showing a first part of more detailed operations for the “scene process” operation 1308 in FIG. 13A. The scene process combines outputs from multiple video processes at operation 1502. At operation 1504, it is checked whether a joints data structure identifies a foot joint or a non-foot joint. If the joints data structure is of a foot-joint, homographic mapping is applied to combine the joints data structures corresponding to images from cameras with overlapping fields of view at operation 1506. This process identifies candidate foot joints (left and right foot joints). At operation 1508 heuristics are applied on candidate foot joints identified in operation 1506 to identify sets of candidate foot joints as subjects. It is checked at operation 1510 whether the set of candidate foot joints belongs to an existing subject. If not, a new subject is created at operation 1512. Otherwise, the existing subject is updated at operation 1514.

A flowchart in FIG. 15B illustrates a second part of more detailed operations for the “scene process” operation 1308. At operation 1540, the data structures of non-foot joints are combined from multiple arrays of joints data structures corresponding to images in the sequence of images from cameras with overlapping fields of view. This is performed by mapping corresponding points from a first image from a first camera to a second image from a second camera with overlapping fields of view. Some details of this process are described above. Heuristics are applied at operation 1542 to candidate non-foot joints. At operation 1546 it is determined whether a candidate non-foot joint belongs to an existing subject. If so, the existing subject is updated at operation 1548. Otherwise, the candidate non-foot joint is processed again at operation 1550 after a predetermined time to match it with an existing subject. At operation 1552 it is checked whether the non-foot joint belongs to an existing subject. If true, the subject is updated at operation 1556. Otherwise, the joint is discarded at operation 1554.

In an example implementation, the processes to identify new subjects, track subjects and eliminate subjects (who have left the real space or were incorrectly generated) are implemented as part of an “entity cohesion algorithm” performed by the runtime system (also referred to as the inference system). An entity is a constellation of joints referred to as a subject above. The entity cohesion algorithm identifies entities in the real space and updates the locations of the joints in real space to track the movement of the entity.

### Classification of Proximity Events

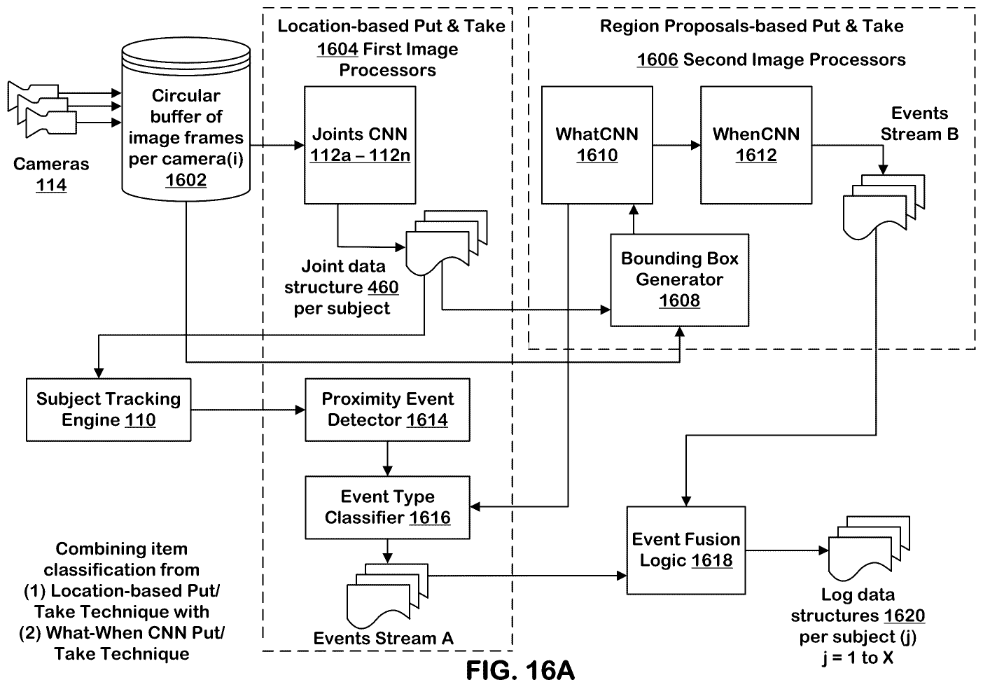

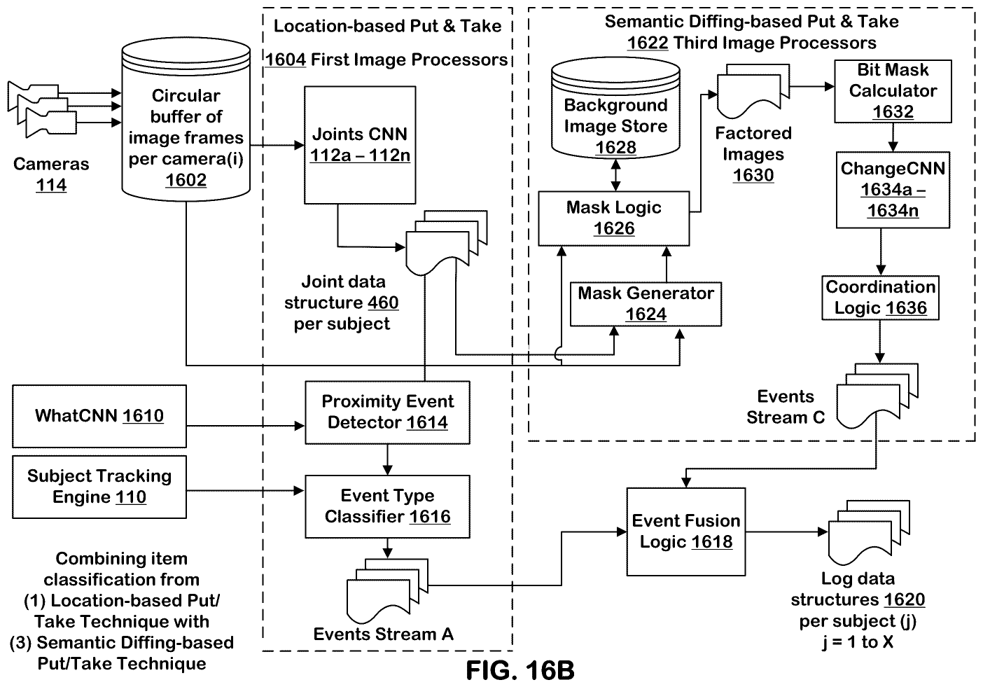

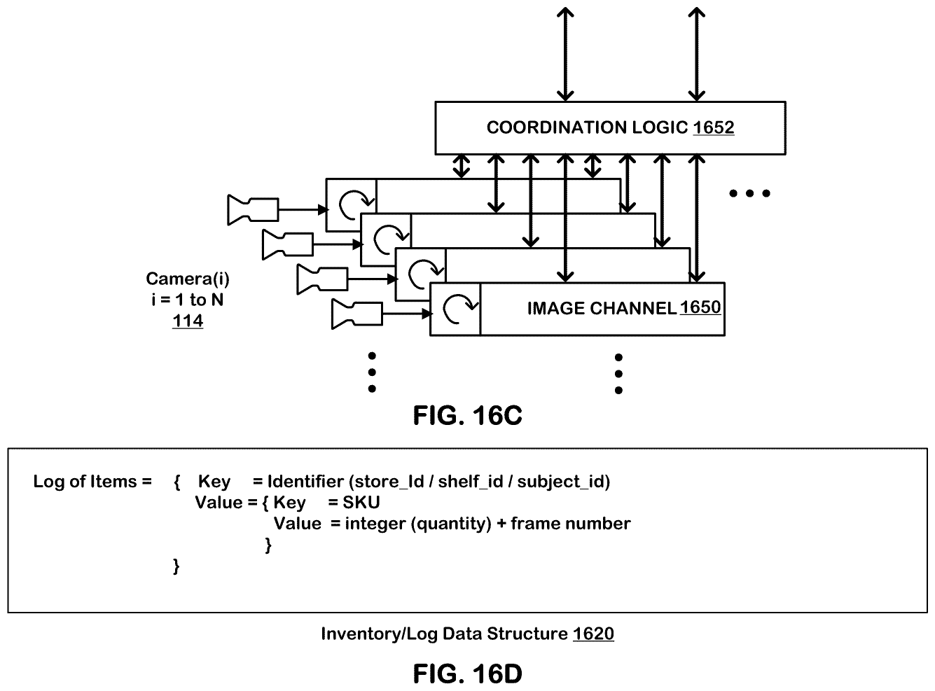

We now describe the technology to identify the type of a proximity event by classifying the detected proximity events. The proximity event can be a take event, a put event, a hand-off event or a touch event. The technology disclosed can further identify an item associated with the identified event. A system and various implementations for tracking exchanges of inventory items between sources and sinks in an area of real space are described with reference to FIGS. 16A and 16B. The system and processes are described with reference to FIGS. 16A and 16B, which are architectural level schematics of a system in accordance with an implementation. Because FIGS. 16A and 16B are architectural diagrams, certain details are omitted to improve the clarity of the description.

The technology disclosed comprises multiple image processors that can detect put and take events in parallel. We can also refer to these image processors as image processing pipelines that process the sequences of images from the cameras 114. The system can then fuse the outputs from two or more image processors to generate an output identifying the event type and the item associated with the event. The multiple processing pipelines for detecting put and take events increase the robustness of the system as the technology disclosed can predict a take and put of an item in an area of real space using the output of one of the image processors when the other image processors cannot generate a reliable output for that event. The first image processors 1604 use locations of subjects and locations of inventory display structures to detect “proximity events” which are further processed to detect put and take events. The second image processors 1606 use bounding boxes of hand images of subjects in the area of real space and perform time series analysis of the classification of hand images to detect region proposals-based put and take events. The third images processors 1622 can use masks to remove foreground objects (such as subjects or shoppers) from images and process background images (of shelves) to detect change events (or diff events) indicating puts and takes of items. The put and take events (or exchanges of items between sources and sinks) detected by the three image processors can be referred to as “inventory events”.

The same cameras and the same sequences of images are used by the first image processors 1604 (predicting location-based inventory events), the second image processors 1606 (predicting region proposals-based inventory events) and the third image processors 1622 (predicting semantic diffing-based inventory events), in one implementation. As a result, detections of puts, takes, transfers (exchanges), or touches of inventory items are performed by multiple subsystems (or procedures) using the same input data allowing for high confidence, and high accuracy, in the resulting data. In FIG. 16A, we present the system architecture illustrating the first and the second image processors and fusion logic to combine their respective outputs. In FIG. 16B, we present a system architecture illustrating the first and the third image processors and fusion logic to combine their respective outputs. It should be noted that all three image processors can operate in parallel and the outputs of any combination of the two or more image processors can be combined. The system can also detect inventory events using one of the image processors.

### Location-based Events and Region Proposals-based Events

FIG. 16A is a high-level architecture of two pipelines of neural networks processing image frames received from cameras 114 to generate shopping cart data structures for subjects in the real space. The system described here includes per-camera image recognition engines as described above for identifying and tracking multi-joint subjects. Alternative image recognition engines can be used, including examples in which only one “joint” is recognized and tracked per individual, or other features or other types of image data over space and time are utilized to recognize and track subjects in the real space being processed. The processing pipelines run in parallel per camera, moving images from respective cameras to image recognition engines 112a-112n via circular buffers 1602 per camera. In one implementation, the first image processors subsystem 1604 includes image recognition engines 112a-112n implemented as convolutional neural networks (CNNs) and referred to as joint CNNs 112a-112n. As described in relation to FIG. 1, the cameras 114 can be synchronized in time with each other, so that images are captured at the same time, or close in time, and at the same image capture rate. Images captured in all the cameras covering an area of real space at the same time, or close in time, are synchronized in the sense that the synchronized images can be identified in the processing engines as representing different views at a moment in time of subjects having fixed positions in the real space.

In one implementation, the cameras 114 are installed in a store (such as a supermarket) such that sets of cameras (two or more) with overlapping fields of view are positioned over each aisle to capture images of real space in the store. There are N cameras in the real space, represented as camera (i) where the value of i ranges from 1 to N. Each camera produces a sequence of images of real space corresponding to its respective field of view. In one implementation, the image frames corresponding to sequences of images from each camera are sent at the rate of 30 frames per second (fps) to respective image recognition engines 112a-112n. Each image frame has a timestamp, an identity of the camera (abbreviated as “camera_id”), and a frame identity (abbreviated as “frame_id”) along with the image data. The image frames are stored in a circular buffer 1502 (also referred to as a ring buffer) per camera 114. Circular buffers 1602 store a set of consecutively timestamped image frames from respective cameras 114. In some implementations, an image resolution reduction process, such as downsampling or decimation, is applied to images output from the circular buffers 1602, before their input to the Joints CNN 122a-122n.

A Joints CNN processes sequences of image frames per camera and identifies the 18 different types of joints of each subject present in its respective field of view. The outputs of joints CNNs 112a-112n corresponding to cameras with overlapping fields of view are combined to map the locations of joints from the 2D image coordinates of each camera to the 3D coordinates of real space. The joints data structures 460 per subject (j) where j equals 1 to x, identify locations of joints of a subject (j) in the real space. The details of the subject data structure 460 are presented in FIG. 4B. In one example implementation, the joints data structure 460 is a two level key-value dictionary of the joints of each subject. A first key is the frame_number and the value is a second key-value dictionary with the key as the camera_id and the value as the list of joints assigned to a subject.

The data sets comprising subjects identified by the joints data structures 460 and corresponding image frames from sequences of image frames per camera are given as input to a bounding box generator 1608 in the second image processors subsystem 1606 (or the second processing pipeline). The second image processors produce a stream of region proposals-based events, shown as events stream B in FIG. 16A. The second image processors subsystem further comprises foreground image recognition engines. In one implementation, the foreground image recognition engines recognize semantically significant objects in the foreground (i.e. shoppers, their hands and inventory items) as they relate to puts and takes of inventory items, for example, over time in the images from each camera. In the example implementation shown in FIG. 16A, the foreground image recognition engines are implemented as WhatCNN 1610 and WhenCNN 1612. The bounding box generator 1608 implements the logic to process data sets to specify bounding boxes which include images of hands of identified subjects in images in the sequences of images. The bounding box generator 1608 identifies locations of hand joints in each source image frame per camera using locations of hand joints in the multi-joints data structures (also referred to as subject data structures) 1200 corresponding to the respective source image frame. In one implementation, in which the coordinates of the joints in the subject data structure indicate the locations of joints in 3D real space coordinates, the bounding box generator maps the joint locations from 3D real space coordinates to 2D coordinates in the image frames of respective source images.

The bounding box generator 1608 creates bounding boxes for hand joints in image frames in a circular buffer per camera 114. In some implementations, the image frames output from the circular buffer to the bounding box generator has full resolution, without downsampling or decimation, alternatively with a resolution higher than that applied to the joints CNN. In one implementation, the bounding box is a 128 pixels (width) by 128 pixels (height) portion of the image frame with the hand joint located in the center of the bounding box. In other implementations, the size of the bounding box is 64 pixels×64 pixels or 32 pixels×32 pixels. For m subjects in an image frame from a camera, there can be a maximum of 2m hand joints, thus 2m bounding boxes. However, in practice fewer than 2m hands are visible in an image frame because of occlusions due to other subjects or other objects. In one example implementation, the hand locations of subjects are inferred from locations of elbow and wrist joints. For example, the right hand location of a subject is extrapolated using the location of the right elbow (identified as p1) and the right wrist (identified as p2) as extrapolation_amount*(p2−p1)+p2 where extrapolation_amount equals 0.4. In another implementation, the joints CNN 112a-112n are trained using left and right hand images. Therefore, in such an implementation, the joints CNN 112a-112n directly identify locations of hand joints in image frames per camera. The hand locations per image frame are used by the bounding box generator 1608 to create a bounding box per identified hand joint.

The WhatCNN 1610 is a convolutional neural network trained to process the specified bounding boxes in the images to generate the classification of hands of the identified subjects. One trained WhatCNN 1610 processes image frames from one camera. In the example implementation of the store, for each hand joint in each image frame, the WhatCNN 1610 identifies whether the hand joint is empty. The WhatCNN 1610 also identifies a SKU number of the inventory item in the hand joint, a confidence value indicating the item in the hand joint is a non-SKU item (i.e. does not belong to the store inventory) and the context of the hand joint location in the image frame.

The outputs of WhatCNN models 1610 for all cameras 114 are processed by a single WhenCNN model 1612 for a pre-determined window of time. In the example of a store, the WhenCNN 1612 performs time series analysis for both hands of subjects to identify whether each subject took a store inventory item from a shelf or put a store inventory item on a shelf. A stream of put and take events (also referred to as region proposals-based inventory events) is generated by the WhenCNN 1612 and is labeled as events stream B in FIG. 16B. The put and take events from the events stream are used to update the log data structures of subjects (also referred to as shopping cart data structures including a list of inventory items). A log data structure 1620 is created per subject to keep a record of the inventory items in a shopping cart (or basket) associated with the subject. The log data structures per shelf and per store can be generated to indicate items on shelves and in a store. The system can include an inventory database to store the log data structures of subjects, shelves and stores.

### Video Processes and Scene Process to Classify Region Proposals

In one implementation of the system, data from a so called “scene process” and multiple “video processes” are given as input to the WhatCNN model 1610 to generate hand image classifications. Note that the output of each video process is given to a separate WhatCNN model. The output from the scene process is a joints dictionary. In this dictionary, keys are unique joint identifiers and values are unique subject identifiers with which each joint is associated. If no subject is associated with a joint, then it is not included in the dictionary. Each video process receives a joints dictionary from the scene process and stores it into a ring buffer that maps frame numbers to the returned dictionary. Using the returned key-value dictionary, the video processes select subsets of the image at each moment in time that are near hands associated with identified subjects. These portions of image frames around hand joints can be referred to as region proposals.

In the example of a store, a “region proposal” is the frame image of a hand location from one or more cameras with the subject in their corresponding fields of view. A region proposal can be generated for sequences of images from all cameras in the system. It can include empty hands as well as hands carrying store inventory items and items not belonging to store inventory. Video processes select portions of image frames containing hand joints per moment in time. Similar slices of foreground masks are generated. The above (image portions of hand joints and foreground masks) are concatenated with the joints dictionary (indicating subjects to whom respective hand joints belong) to produce a multi-dimensional array. This output from video processes is given as input to the WhatCNN model.

The classification results of the WhatCNN model can be stored in the region proposal data structures. All regions for a moment in time are then given back as input to the scene process. The scene process stores the results in a key-value dictionary, where the key is a subject identifier and the value is a key-value dictionary, where the key is a camera identifier and the value is a region's logits. This aggregated data structure is then stored in a ring buffer that maps frame numbers to the aggregated structure for each moment in time. Region proposal data structures for a period of time e.g., for one second, are given as input to the scene process. In one implementation, in which cameras are taking images at the rate of 30 frames per second, the input includes 30 time periods and corresponding region proposals. The system includes logic (also referred to as a scene process) that reduces the 30 region proposals (per hand) to a single integer representing the inventory item SKU. The output of the scene process is a key-value dictionary in which the key is a subject identifier and the value is the SKU integer.

The WhenCNN model 1612 performs a time series analysis to determine the evolution of this dictionary over time. This results in the identification of items taken from shelves and put on shelves in the store. The output of the WhenCNN model is a key-value dictionary in which the key is the subject identifier and the value is logits produced by the WhenCNN. In one implementation, a set of heuristics can be used to determine the shopping cart data structure 1620 per subject. The heuristics are applied to the output of the WhenCNN, joint locations of subjects indicated by their respective joints data structures, and planograms. The heuristics can also include the planograms that are pre-computed maps of inventory items on shelves. The heuristics can determine, for each take or put, whether the inventory item is put on a shelf or taken from a shelf, whether the inventory item is put in a shopping cart (or a basket) or taken from the shopping cart (or the basket) or whether the inventory item is close to the identified subject's body.

We now refer back to FIG. 16A to present the details of the first image processors 1604 for location-based put and take detection. The first image processors can be referred to as the first image processing pipeline. It can include a proximity event detector 1614 that receives information about inventory caches linked to subjects identified by the joints data structures 460. The proximity event detector includes the logic to process positions of hand joints (left and right) of subjects, or other joints corresponding to inventory caches, to detect when a subject's position is closer to another subject than a pre-defined threshold such as 10 cm. Other values of the threshold less than or greater than 10 cm can be used. The distance between the subjects is calculated using the positions of their hands (left and right). If one or both hands of a subject are occluded, the proximity event detector can use the positions of other joints of the subjects such as an elbow joint, or shoulder joint, etc. The above positions calculation logic can be applied per hand per subject in all image frames in the sequence of image frames per camera to detect proximity events. In other implementations, the system can apply the distance calculation logic after every 3 frames, 5 frames or 10 frames in the sequence of frames. The system can use other frame intervals or time intervals to calculate the distance between subjects or the distance between subjects and shelves.

If a proximity event is detected by the proximity event detector 1614, the event type classifier 1616 processes the output from the WhatCNN 1610 to classify the event as one of a take event, a put event, a touch event, or a transfer or exchange event. The event type classifier receives the holding probability for the hand joints of subjects identified in the proximity event. The holding probability indicates a confidence score indicating whether the subject is holding an item or not. A large positive value indicates that the WhatCNN model has a high level of confidence that the subject is holding an item. A large negative value indicates that the model is confident that the subject is not holding any item. A close to zero value of the holding probability indicates that the WhatCNN model is not confident in predicting whether the subject is holding an item or not.

Referring back to FIG. 16A, the event type classifier 1616 can take the holding probability values over N frames before and after the proximity event as input to detect whether the event detected is a take event, a put event, a touch event, or a transfer or exchange event. If a take event is detected, the system can use the average item class probability from the WhatCNN over N frames after the proximity event to determine the item associated with the proximity event. The technology disclosed can include logic to detect the hand-off or exchange of an item from the source subject to the sink subject. The sink subject may also have taken the detected item from a shelf or another inventory location. This item can then be added to the log data structure of the sink subject.

The exchange or transfer of an item between two shoppers (or subjects) includes two events: a take event and a put event. For the put event, the system can take the average item class probability from the WhatCNN over N frames before the proximity event to determine the item associated with the proximity event. The item detected is handed-off from the source subject to the sink subject. The source subject may also have put the item on a shelf or another inventory location. The detected item can then be removed from the log data structure of the source subject. The system detects a take event for the sink subject and adds the item to the subject's log data structure. A touch event does not result in any changes to the log data structures of the source and sink in the proximity event.

### Methods to Detect Proximity Events

In the following sections several methods to detect proximity events are presented. One method is based on heuristics using data about the locations of joints such as hand joints, and other methods use machine learning models that process data about locations of joints. Combinations of heuristics and machine learning models can used in some implementation.

The system detects the positions of both hands of shoppers (or subjects) per frame per camera in the area of real space. Other joints or other inventory caches which move over time and are linked to shoppers can be used. The system calculates the distances of the left hand and right hand of each shopper to the left hands and right hands of other shoppers in the area of real space. In one implementation, the system calculates the distances between hands of shoppers per portion of the area of real space, for example in each aisle of the store. The system also calculates the distances of the left hand and right hand of each shopper per frame per camera to the nearest shelf in the inventory display structure. The shelves can be represented by a plane in a 3D coordinate system or by a 3D mesh. The system analyzes the time series of hand distances over time by processing sequences of image frames per camera.

The system selects a hand (left or right) per subject per frame that has a minimum distance (of the two hands) to the hand (left or right) of another shopper or to a shelf (i.e. fixed inventory cache). The system also determines if the hand is “in the shelf”. The hand is considered “in the shelf” if the (signed) distance between the hand and the shelf is below a threshold. A negative distance between the hand and shelf indicates that the hand has gone past the plane of the shelf. If the hand is in the shelf for more than a pre-defined number of frames (such as M frames), then the system detects a proximity event when the hand moves out of the shelf. The system determines that the hand has moved out of the shelf when the distance between the hand and the shelf increases above a threshold distance. The system assigns a timestamp to the proximity event which can be a midpoint between the entrance time of the hand in the shelf and the exit time of the hand from the shelf. The hand associated with the proximity event is the hand (left or right) that has the minimum distance to the shelf at the time of the proximity event. Note that the entrance time can be the timestamp of the frame in which the distance between the shelf and the hand falls below the threshold as mentioned above. The exit time can be the timestamp of the frame in which the distance between the shelf and the hand increases above the threshold.

The second method to detect proximity events uses a decision tree model that uses heuristics and/or machine learning. The heuristics-based method to detect the proximity event might not detect proximity events when one or both hands of the subjects are occluded in image frames from the sensors. This can result in missed detections of proximity events which can cause errors in updates to the log data structures of shoppers. Therefore, the system can include an additional method to detect proximity events for robust event detections. If the system cannot detect one or both hands of an identified subject in an image frame, the system can use (left or right) elbow joint positions instead. The system can apply the same logic as described above to detect the distance of the elbow joint to a shelf or a (left or right) hand of another subject to detect a proximity event, if the distance falls below a threshold distance. If the elbow of the subject is occluded as well, then the system can use a shoulder joint to detect a proximity event.

Shopping stores can use different types of shelves having different properties, e.g., depth of shelf, height of shelf, and space between shelves, etc. The distribution of occlusions of subjects (or portions of subjects) induced by shelves at different camera angles is different, and we can train one or more decision tree models using labeled data. The labeled data can include a corpus of example image data. We can train a decision tree that takes in a sequence of distances, with some missing data to simulate occlusions, of shelves to joints over a period of time. The decision tree outputs whether an event happened in the time range or not. In the case of a proximity event prediction, the decision tree also predicts the time of the proximity event (relative to the initial frame). The inputs to the decision tree can be median distances of 3D keypoints 3D keypoints to shelves. A 3D keypoint can represent a 3D position in the area of real space. The 3D position can be a position of a joint in the area of real space. The outputs from the decision tree model are event classifications, i.e., event or no event.

A third method for detecting proximity events uses an ensemble of decision trees. In one implementation, we can use the trained decision trees from the method 2 above to create the ensemble random forest. A random forest classifier (also referred to as a random decision forest) is an ensemble machine learning technique. Ensembled techniques or algorithms combine more than one technique of the same or different kind for classifying objects. The random forest classifier consists of multiple decision trees that operate as an ensemble. Each individual decision tree in a random forest acts as base classifier and outputs a class prediction. The class with the most votes becomes the random forest model's prediction. The fundamental concept behind random forests is that a large number of relatively uncorrelated models (decision trees) operating as a committee will outperform any of the individual constituent models.

The technology disclosed can generate separate event streams in parallel for the same inventory events. For example, as shown in FIG. 16A, the first image processors generate an event stream A of location-based put and take events. As described above, the first image processors can also detect touch events. As touch events do not result in a put or take, the system does not update the log data structures of sources and sinks when it detects a touch event. The event stream A can include location-based put and take events and can include the item identifier associated with each event. The location-based events in the event stream A can also include the subject identifiers of the source subjects or the sink subjects and the time and location of the events in the area of real space. In one implementation, a location-based event can also include the shelf identifier of the source shelf or the sink shelf.

The second image processors produce a second event stream B including put and take events based on hand-image processing of the WhatCNN and time series analysis of the output of the WhatCNN by the WhenCNN. The region proposals-based put and take events in the event stream B can include item identifiers, the subjects or shelves associated with the events, and the time and location of the events in the real space. The events in both the event stream A and event stream B can include confidence scores identifying the confidence of the classifier.

The technology disclosed includes event fusion logic 1618 to combine events from event stream A and event stream B to increase the robustness of event predictions in the area of real space. In one implementation, the event fusion logic determines, for each event in event stream A, if there is a matching event in event stream B. The events are matched if both events are of the same event type (put, take), if the event in event stream B has not been already matched to an event in event stream A, and if the event in event stream B is identified in a frame within a threshold number of frames preceding or following the image frame in which the proximity event is detected. As described above, the cameras 114 can be synchronized in time with each other, so that images are captured at the same time, or close in time, and at the same image capture rate. Images captured in all the cameras covering an area of real space at the same time, or close in time, are synchronized in the sense that the synchronized images can be identified in the processing engines as representing different views at a moment in time of subjects having fixed positions in the real space Therefore, if an event is detected in a frame x in event stream A, the matching logic considers events in frame x+N, where the value of N can be set as 1, 3, 5 or more. If a matching event is found in event stream B, the technology disclosed uses a weighted combination of event predictions to generate an item put or take prediction. For example, in one implementation, the technology disclosed can assign 50 percent weight to events of stream A and 50 percent weight to matching events from stream B and use the resulting output to update the log data structures 1020 of source and sinks. In another implementation, the technology disclosed can assign more weight to events from one of the streams when combining the events to predict puts and takes of items.

If the event fusion logic cannot find a matching event in event stream B for an event in event stream A, the technology disclosed can wait for a threshold number of frames to pass. For example, if the threshold is set as 5 frames, the system can wait until five frames following the frame in which the proximity event is detected are processed by the second image processors. If a matching event is not found after the threshold number of frames, the system can use the item put or take prediction from the location-based event to update the log data structure of the source and the sink. The technology disclosed can apply the same matching logic for events in the event stream B. Thus, for an event in the event stream B, if there is no matching event in the event stream A, the system can use the item put or take detection from the region proposals-based prediction to update the log data structures 1620 of the source and sink subjects. Therefore, the technology disclosed can produce robust event detections even when one of the first or the second image processors cannot predict a put or a take event or when one technique predicts a put or a take event with low confidence.

### Location-Based Events and Semantic Diffing-Based Events

We now present the third image processors 1622 (also referred to as the third image processing pipeline) and the logic to combine the item put and take predictions from this technique to item put and take predictions from the first image processors 1604. Note that item put and take predictions from third image processors can be combined with item put and take predictions from second image processors 1606 in a similar manner. FIG. 16B is a high-level architecture of pipelines of neural networks processing image frames received from the cameras 114 to generate shopping cart data structures for subjects in the real space. The system described here includes per camera image recognition engines as described above for identifying and tracking multi-joint subjects.

The processing pipelines run in parallel per camera, moving images from respective cameras to image recognition engines 112a-112n via circular buffers 1602. We have described the details of the first image processors 1004 with reference to FIG. 16A. The output from the first image processors is an events stream A. The technology disclosed includes event fusion logic 1618 to combine the events in the events stream A to matching events in an events stream C which is output from the third image processors.

A “semantic diffing” subsystem (also referred to as the third image processors 1622) includes background image recognition engines, receiving corresponding sequences of images from the plurality of cameras and recognizing semantically significant differences in the background (i.e. inventory display structures like shelves) as they relate to puts and takes of inventory items, for example, over time in the images from each camera. The third image processors receive joint data structures 460 (e.g., a data structure including information about joints of subjects) from the joints CNNs 112a-112n and image frames from the cameras 114 as input. The third image processors mask the identified subjects in the foreground to generate masked images. The masked images are generated by replacing bounding boxes that correspond with foreground subjects with background image data. Following this, the background image recognition engines process the masked images to identify and classify background changes represented in the images in the corresponding sequences of images. In one implementation, the background image recognition engines are convolutional networks.

The third image processors process identified background changes to predict takes of inventory items by identified subjects and puts of inventory items on inventory display structures by identified subjects. The set of detections of puts and takes from the semantic diffing system are also referred to as background detections of puts and takes of inventory items. In the example of a store, these detections can identify inventory items taken from the shelves or put on the shelves by customers or employees of the store. The semantic diffing subsystem includes the logic to associate identified background changes with identified subjects. We now present the details of the components of the semantic diffing subsystem or third image processors 1622 as shown inside the broken line on the right side of FIG. 16B.

The system comprises the plurality of cameras 114 producing respective sequences of images of corresponding fields of view in the real space. The field of view of each camera overlaps with the field of view of at least one other camera in the plurality of cameras as described above. In one implementation, the sequences of image frames corresponding to the images produced by the plurality of cameras 114 are stored in a circular buffer 1602 (also referred to as a ring buffer) per camera 114. Each image frame has a timestamp, an identity of the camera (abbreviated as “camera_id”), and a frame identity (abbreviated as “frame_id”) along with the image data. Circular buffers 1602 store a set of consecutively timestamped image frames from respective cameras 114. In one implementation, the cameras 114 are configured to generate synchronized sequences of images.

The first image processors 1604 include the Joints CNN 112a-112n, receiving corresponding sequences of images from the plurality of cameras 114 (with or without image resolution reduction). The technology includes subject tracking engines to process images to identify subjects represented in the images in the corresponding sequences of images. In one implementation, the subject tracking engines can include convolutional neural networks (CNNs) referred to as joints CNN 112a-112n. The outputs of the joints CNNs 112a-112n corresponding to cameras with overlapping fields of view are combined to map the locations of joints from the 2D image coordinates of each camera to the 3D coordinates of real space. The joints data structures 460 per subject (j), where j equals 1 to x, identify locations of joints of a subject (j) in the real space and in 2D space for each image. Some details of the subject data structure 1200 are presented in FIG. 12.

A background image store 1628, in the semantic diffing subsystem or third image processors 1622, stores masked images (also referred to as background images in which foreground subjects have been removed by masking) for corresponding sequences of images from the cameras 114. The background image store 1628 is also referred to as a background buffer. In one implementation, the size of the masked images is the same as the size of the image frames in the circular buffer 1602. In one implementation, a masked image is stored in the background image store 1628 corresponding to each image frame in the sequences of image frames per camera.

The semantic diffing subsystem 1622 (or the second image processors) includes a mask generator 1624 producing masks of foreground subjects represented in the images in the corresponding sequences of images from a camera. In one implementation, one mask generator processes sequences of images per camera. In the example of the store, the foreground subjects are customers or employees of the store in front of the background shelves containing items for sale.

In one implementation, the joint data structures 460 per subject and image frames from the circular buffer 1602 are given as input to the mask generator 1624. The joint data structures identify locations of foreground subjects in each image frame. The mask generator 1624 generates a bounding box per foreground subject identified in the image frame. In such an implementation, the mask generator 1624 uses the values of the x and y coordinates of joint locations in the 2D image frame to determine the four boundaries of the bounding box. A minimum value of x (from all x values of joints for a subject) defines the left vertical boundary of the bounding box for the subject. A minimum value of y (from all y values of joints for a subject) defines the bottom horizontal boundary of the bounding box. Likewise, the maximum values of x and y coordinates identify the right vertical and top horizontal boundaries of the bounding box. In a second implementation, the mask generator 1624 produces bounding boxes for foreground subjects using a convolutional neural network-based person detection and localization algorithm. In such an implementation, the mask generator 1624 does not use the joint data structures 460 to generate bounding boxes for foreground subjects.

The semantic diffing subsystem (or the third image processors 1622) includes a mask logic to process images in the sequences of images to replace foreground image data representing the identified subjects with background image data from the background images for the corresponding sequences of images to provide the masked images, resulting in a new background image for processing. As the circular buffer receives image frames from the cameras 114, the mask logic processes images in the sequences of images to replace foreground image data defined by the image masks with background image data. The background image data is taken from the background images for the corresponding sequences of images to generate the corresponding masked images.

Consider the example of the store. Initially at time t=0, when there are no customers in the store, a background image in the background image store 1628 is the same as its corresponding image frame in the sequences of images per camera. Now consider at time t=1, a customer moves in front of a shelf to buy an item in the shelf. The mask generator 1624 creates a bounding box of the customer and sends it to a mask logic component 1626. The mask logic component 1626 replaces the pixels in the image frame at t=1 inside the bounding box with corresponding pixels in the background image frame at t=0. This results in a masked image at t=1 corresponding to the image frame at t=1 in the circular buffer 1602. The masked image does not include pixels for the foreground subject (or customer) which are now replaced by pixels from the background image frame at t=0. The masked image at t=1 is stored in the background image store 1628 and acts as a background image for the next image frame at t=2 in the sequence of images from the corresponding camera.

In one implementation, the mask logic component 1626 combines, such as by averaging or summing by pixel, sets of N masked images in the sequences of images to generate sequences of factored images for each camera. In such an implementation, the second image processors identify and classify background changes by processing the sequence of factored images. A factored image can be generated, for example, by taking an average value for pixels in the N masked images in the sequence of masked images per camera. In one implementation, the value of N is equal to the frame rate of the cameras 114, for example if the frame rate is 30 FPS (frames per second), the value of N is 30. In such an implementation, the masked images for a time period of one second are combined to generate a factored image. Taking the average pixel values minimizes the pixel fluctuations due to sensor noise and luminosity changes in the area of real space.

The third image processors identify and classify background changes by processing the sequences of factored images. A factored image in the sequences of factored images is compared with the preceding factored image for the same camera by a bit mask calculator 1632. Pairs of factored images 1630 are given as input to the bit mask calculator 1632 to generate a bit mask identifying changes in corresponding pixels of the two factored images. The bit mask has Is at the pixel locations where the difference between the corresponding pixels' (current and previous factored image) RGB (red, green and blue channels) values is greater than a “difference threshold”. The value of the difference threshold is adjustable. In one implementation, the value of the difference threshold is set at 0.1. The bit mask and the pair of factored images (current and previous) from the sequences of factored images per camera are given as input to background image recognition engines. In one implementation, the background image recognition engines comprise convolutional neural networks and are referred to as ChangeCNN 1634a-1634n. A single ChangeCNN processes sequences of factored images per camera. In another implementation, the masked images from corresponding sequences of images are not combined. The bit mask is calculated from the pairs of masked images. In this implementation, the pairs of masked images and the bit mask are then given as input to the ChangeCNN.

The input to a ChangeCNN model in this example consists of seven (7) channels including three image channels (red, green and blue) per factored image and one channel for the bit mask. The ChangeCNN comprises multiple convolutional layers and one or more fully connected (FC) layers. In one implementation, the ChangeCNN comprises the same number of convolutional and FC layers as the joints CNN 112a-112n as illustrated in FIG. 4A. The background image recognition engines (ChangeCNN 1634a-1634n) identify and classify changes in the factored images and produce change data structures for the corresponding sequences of images. The change data structures include coordinates in the masked images of identified background changes, identifiers of an inventory item subject of the identified background changes and classifications of the identified background changes. The classifications of the identified background changes in the change data structures classify whether the identified inventory item has been added or removed relative to the background image.

As multiple items can be taken or put on the shelf simultaneously by one or more subjects, the ChangeCNN generates a number “B” overlapping bounding box predictions per output location. A bounding box prediction corresponds to a change in the factored image. Consider the store has a number “C” unique inventory items, each identified by a unique SKU. The ChangeCNN predicts the SKU of the inventory item subject of the change. Finally, the ChangeCNN identifies the change (or inventory event type) for every location (pixel) in the output indicating whether the item identified is taken from the shelf or put on the shelf. The above three parts of the output from the ChangeCNN are described by an expression “5*B+C+1”. Each bounding box “B” prediction comprises five (5) numbers, therefore “B” is multiplied by 5. These five numbers represent the “x” and “y” coordinates of the center of the bounding box, and the width and height of the bounding box. The fifth number represents the ChangeCNN model's confidence score for the prediction of the bounding box. “B” is a hyperparameter that can be adjusted to improve the performance of the ChangeCNN model. In one implementation, the value of “B” equals 4. Consider that the width and height (in pixels) of the output from the ChangeCNN are represented by W and H, respectively. The output of the ChangeCNN is then expressed as “W*H*(5*B+C+1)”. The bounding box output model is based on an object detection system proposed by Redmon and Farhadi in their paper, “YOLO9000: Better. Faster. Stronger” published on Dec. 25, 2016. The paper is available at <arxiv.org/pdf/1612.08242.pdf>.

The outputs of the ChangeCNN 1634a-1634n corresponding to sequences of images from cameras with overlapping fields of view are combined by a coordination logic component 1636. The coordination logic component processes change data structures from sets of cameras having overlapping fields of view to locate the identified background changes in the real space. The coordination logic component 1636 selects bounding boxes representing the inventory items having the same SKU and the same inventory event type (take or put) from multiple cameras with overlapping fields of view. The selected bounding boxes are then triangulated in the 3D real space using triangulation techniques described above to identify the location of the inventory item in the 3D real space. Locations of shelves in the real space are compared with the triangulated locations of the inventory items in the 3D real space. False positive predictions are discarded. For example, if the triangulated location of a bounding box does not map to a location of a shelf in the real space, the output is discarded. Triangulated locations of bounding boxes in the 3D real space that map to a shelf are considered true predictions of inventory events.

In one implementation, the classifications of identified background changes in the change data structures produced by the second image processors classify whether the identified inventory item has been added or removed relative to the background image. In another implementation, the classifications of identified background changes in the change data structures indicate whether the identified inventory item has been added or removed relative to the background image and the system includes logic to associate background changes with identified subjects. The system makes detections of takes of inventory items by the identified subjects and of puts of inventory items on inventory display structures by the identified subjects. A log generator component can implement the logic to associate changes identified by true predictions of changes with identified subjects near the locations of the changes. In an implementation utilizing the joints identification engine to identify subjects, the log generator can determine the positions of hand joints of subjects in the 3D real space using the joint data structures 460. A subject whose hand joint location is within a threshold distance to the location of a change at the time of the change is identified. The log generator associates the change with the identified subject.

In one implementation, as described above, N masked images are combined to generate factored images which are then given as input to the ChangeCNN. Consider that N equals the frame rate (frames per second) of the cameras 114. Thus, in such an implementation, the positions of the hands of subjects during a one second time period are compared with the locations of the changes to associate the changes with identified subjects. If more than one subject's hand joint locations are within the threshold distance to a location of a change, then association of the change with a subject is deferred to the output of the first image processors or second image processors. In one implementation, the system can store masks and unmodified images, and conditioned on an elsewhere computed region & time of interest, process the masks to determine the latest time before and earliest time after the time of interest in which the region is not occluded by a person. The system can then take the images from those two times, crop to the region of interest, and classify the background changes between those two crops. The main difference is that in this implementation, the system is not doing image processing to generate these background images, and the change detection model is only run on specific regions of interest, conditioned on times when the system determines that a shopper may have interacted with a shelf. In such an implementation, the processing can stop when a shopper is positioned in front the shelf. The processing can start when the shopper moves away and the shelf or a portion of shelf is not occluded by the shopper.

The technology disclosed can combine the events in an events stream C from the semantic diffing model with events in the events stream A from the location-based event detection model. The location-based put and take events are matched to put and take events from the semantic diffing model by the event fusion logic component 1618. As described above, the semantic diffing events (or diff events) classify items put on or taken from shelves based on background image processing. In one implementation, the diff events can be combined with existing shelf maps from the maps of shelves including item information or planograms to determine the likely items associated with pixel changes represented by diff events. The diff events may not be associated with a subject at the time of detection of the event and may not result in the update of the log data structure of any source subject or sink subject. The technology disclosed includes logic to match the diff events that may have been associated with a subject or not associated with a subject with a location-based put and take event from events stream A and a region proposals-based put and take event from events stream B.

Semantic diffing events are localized to an area in the 2D image plane in image frames from the cameras 114 and have a start time and end time associated with each of them. The event fusion logic matches the semantic diffing events from events stream C to events in events stream A and events stream B in between the start and end times of the semantic diffing events. The location-based put and take events and region proposals-based put and take events have 3D positions associated with them based on the hand joint positions in the area of real space. The technology disclosed includes logic to project the 3D positions of the location-based put and take events and region proposal-based put and take events to 2D image planes and compute the overlap with the semantic diffing-based events in the 2D image planes. The following three scenarios can result based on how many predicted events from events streams A and B overlap with a semantic diffing event (also referred to as a diff event): (1) If no events from events streams A and B overlap with a diff event in the time range of the diff event, then in this case, the technology disclosed can associate the diff event with the closest person to the shelf in the time range of the diff event; (2) If one event from events stream A or events stream B overlaps with the diff event in the time range of the diff event, then in this case, the system combines the matched event to the diff event by taking a weighted combination of the item predictions from the events stream (A or B) which predicted the event and the item prediction from diff event; (3) If two or more events from events streams A or B overlap with the diff event in the time range of the diff event, the system selects one of the matched events from events streams A or B. The event that has the closest item classification probability value to the item classification probability value in the diff event can be selected. The system can then take a weighted average of the item classification from the diff event and the item classification from the selected event from events stream A or events stream B.

FIG. 16C shows the coordination logic module 1652 combining the results of multiple WhatCNN models and giving this as input to a single WhenCNN model. As mentioned above, two or more cameras with overlapping fields of view capture images of subjects in the real space. Joints of a single subject can appear in image frames of multiple cameras in the respective image channel 1650. A separate WhatCNN model identifies SKUs of inventory items in the hands (represented by hand joints) of subjects. The coordination logic module 1652 combines the outputs of WhatCNN models into a single consolidated input for the WhenCNN model. The WhenCNN model operates on the consolidated input to generate the shopping cart of the subject.

An example inventory data structure 1620 (also referred to as a log data structure) is shown in FIG. 16D. This inventory data structure stores the inventory of a subject, a shelf or a store as a key-value dictionary. The key is the unique identifier of a subject, a shelf or a store and the value is another key value-value dictionary where the key is the item identifier such as a SKU and the value is a number identifying the quantity of the item along with the “frame_id” of the image frame that resulted in the inventory event prediction. The frame identifier (“frame_id”) can be used to identify the image frame which resulted in the identification of an inventory event resulting in the association of the inventory item with the subject, the shelf, or the store. In other implementations, a “camera_id” identifying the source camera can also be stored in combination with the frame_id in the inventory data structure 1620. In one implementation, the “frame_id” is the subject identifier because the frame has the subject's hand in the bounding box. In other implementations, other types of identifiers can be used to identify subjects such as a “subject_id” which explicitly identifies a subject in the area of real space.

When a put event is detected, the item identified by the SKU in the inventory event (such as a location-based event, region proposals-based event, or semantic diffing event) is removed from the log data structure of the source subject. Similarly, when a take event is detected, the item identified by the SKU in the inventory event is added to the log data structure of the sink subject. In an item hand-off or exchange between subjects, the log data structures of both subjects in the hand-off are updated to reflect the item exchange from the source subject to the sink subject. Similar logic can be applied when subjects take items from shelves or put items on the shelves. Log data structures of shelves can also be updated to reflect the put and take of items (e.g., planogram compliance and tracking of inventory stock levels).

When a particular item is determined to be low in stock, based on a pre-determined threshold, or out of stock, the low stock or out of stock inventory item can be communicated to a user associated with the store (e.g., an employee or manager) via a notification. For example, the notification may be communicated via a user device such as a smart phone or a computer. The notification may include one or more of the inventory item identifier(s), a quantity of the current inventory level, and a time stamp. The notification may further include data about the item's location in the store, as determined by the current updated planogram. In some implementations, a user device may display a rendered map of the monitored area of space indicating locations of inventory items, based on the planogram, and the notification can be displayed at a location of the map corresponding to the expected location of the inventory item. In one implementation, the notification includes a visual display indicator at the location of the map corresponding to the expected location of the inventory item with different visual characteristics based on present stock levels (e.g., one or more of the color green for acceptable stock levels, the color yellow for low stock levels, and the color red for out of stock items). The assignment of visual characteristics may be determined based on predefined thresholds, such as defining “low stock” as 5 or less items on the shelf at a time and out of stock as 0 items on the shelf at a time. These threshold values, and the use of color as a visual indicator, are nonlimiting examples for illustrative purposes and other classification and visualization schemes will be readily apparent to a user skilled in the art.

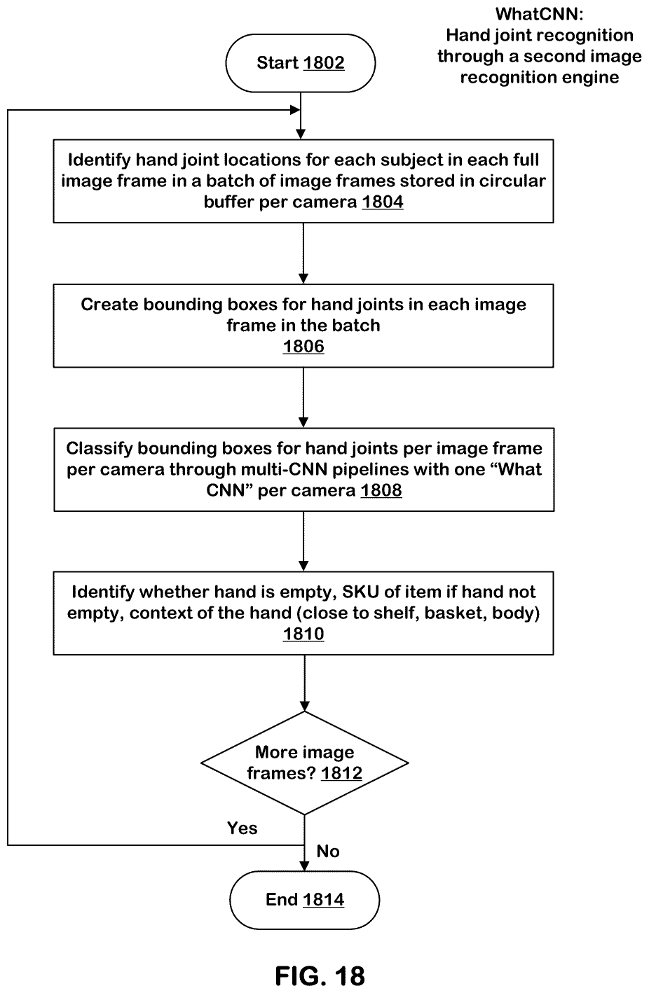

The shelf inventory data structure can be consolidated with the subject's log data structure, resulting in the reduction of shelf inventory to reflect the quantity of items taken by the customer from the shelf. If the items were put on the shelf by a shopper or an employee stocking items on the shelf, the items get added to the respective inventory locations' inventory data structures. Over a period of time, this processing results in updates to the shelf inventory data structures for all inventory locations in the store. Inventory data structures of inventory locations in the area of real space are consolidated to update the inventory data structure of the area of real space indicating the total number of items of each SKU in the store at that moment in time. In one implementation, such updates are performed after each inventory event. In another implementation, the store inventory data structures are updated periodically. In the following process flowcharts (FIGS. 18 to 22), we present process operations for subject identification using Joints CNN, hand recognition using WhatCNN, time series analysis using WhenCNN, detection of proximity events and proximity event types (put, take, touch), detection of an item in a proximity event, and fusion of multiple inventory events streams.

### Joints CNN-Identification and Update of Subjects

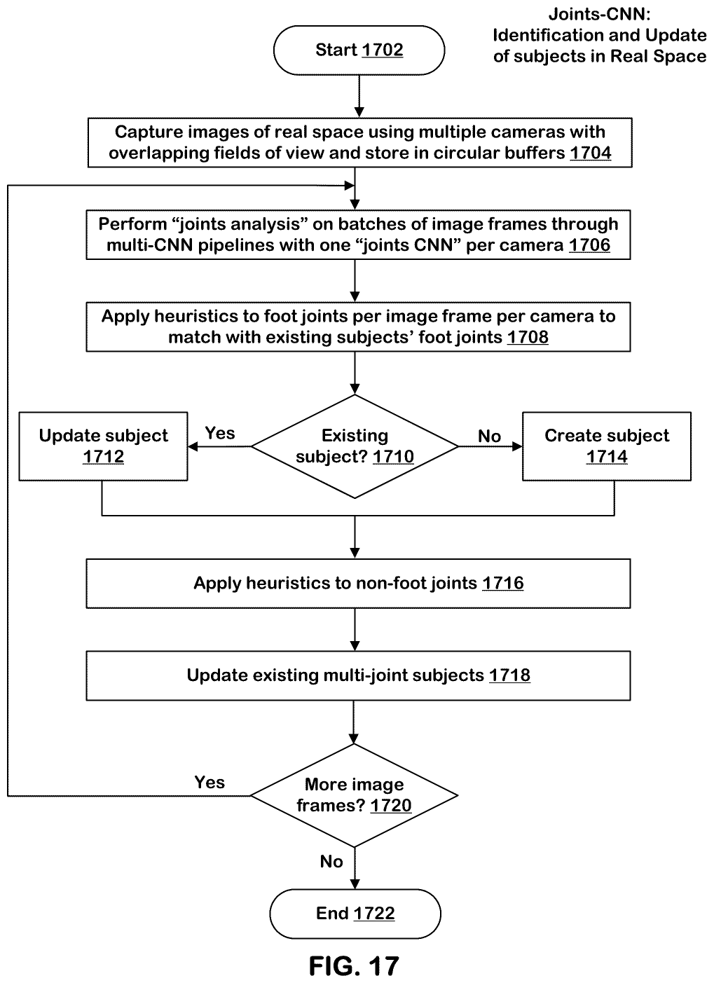

FIG. 17 is a flowchart of processing operations performed by the Joints CNN 112a-112n to identify subjects in the real space. In the example of a store, the subjects are shoppers or customers moving in the store in aisles between shelves and other open spaces. The process starts at operation 1702. Note that, as described above, the cameras are calibrated before the sequences of images from cameras are processed to identify subjects. Details of camera calibration are presented above. Cameras 114 with overlapping fields of view capture images of real space in which subjects are present (operation 1704). In one implementation, the cameras are configured to generate synchronized sequences of images. The sequences of images of each camera are stored in respective circular buffers 1602 per camera. A circular buffer (also referred to as a ring buffer) stores the sequences of images in a sliding window of time. In an implementation, a circular buffer stores 110 image frames from a corresponding camera. In another implementation, each circular buffer 1602 stores image frames for a time period of 3.5 seconds. It is understood that, in other implementations, the number of image frames (or the time period) can be greater than or less than the example values listed above.

Joints CNNs 112a-112n receive sequences of image frames from corresponding cameras 114 as output from a circular buffer, with or without resolution reduction (operation 1706). Each Joints CNN processes batches of images from a corresponding camera through multiple convolution network layers to identify joints of subjects in image frames from the corresponding camera. The architecture and processing of images by an example convolutional neural network is presented FIG. 4A. As the cameras 114 have overlapping fields of view, the joints of a subject are identified by more than one joints CNN. The 2D coordinates of joints data structures 460 produced by the Joints CNN are mapped to 3D coordinates of the real space to identify joints locations in the real space. Details of this mapping are presented above in which the subject tracking engine 110 translates the coordinates of the elements in the arrays of joints data structures corresponding to images in different sequences of images into candidate joints having coordinates in the real space.

The joints of a subject are organized in two categories (foot joints and non-foot joints) for grouping the joints into constellations, as discussed above. The left and right-ankle joint types in the current example, are considered foot joints for the purpose of this procedure. At an operation 1708, heuristics are applied to assign a candidate left foot joint and a candidate right foot joint to a set of candidate joints to create a subject. Following this, at an operation 1710, it is determined whether the newly identified subject already exists in the real space. If not, then a new subject is created at an operation 1714, otherwise, the existing subject is updated at an operation 1712.

Other joints from the galaxy of candidate joints can be linked to the subject to build a constellation of some or all of the joint types for the created subject. At step 1716, heuristics are applied to non-foot joints to assign those to the identified subjects. A global metric calculator can calculate the global metric value and attempt to minimize the value by checking different combinations of non-foot joints. In one implementation, the global metric is a sum of heuristics organized in four categories as described above.

The logic to identify sets of candidate joints comprises heuristic functions based on physical relationships among the joints of subjects in the real space to identify sets of candidate joints as subjects. At operation 1718, the existing subjects are updated using the corresponding non-foot joints. If there are more images for processing (operation 1720), operations 1706 to 1718 are repeated, otherwise the process ends at operation 1722. The first data sets are produced at the end of the process described above. The first data sets identify subjects and the locations of the identified subjects in the real space. In one implementation, the first data sets are presented above in relation to FIGS. 16A and 16B as joints data structures 460 per subject.

### WhatCNN-Classification of Hand Joints

FIG. 18 is a flowchart illustrating process operations to identify inventory items in the hands of subjects (shoppers) identified in the real space. As the subjects move in aisles and opens spaces, they pick up inventory items stocked in the shelves and put items in their shopping carts or baskets. The image recognition engines identify subjects in the sets of images in the sequences of images received from the plurality of cameras. The system includes the logic to process sets of images in the sequences of images that include the identified subjects to detect takes of inventory items by identified subjects and puts of inventory items on the shelves by identified subjects.

In one implementation, the logic to process sets of images includes, for the identified subjects, generating classifications of the images of the identified subjects. The classifications can include predicting whether an identified subject is holding an inventory item. The classifications can include a first nearness classification indicating a location of a hand of the identified subject relative to a shelf. The classifications can include a second nearness classification indicating a location of a hand of the identified subject relative to the body of the identified subject. The classifications can further include a third nearness classification indicating a location of a hand of an identified subject relative to a basket associated with the identified subject. The classification can include a fourth nearness classification of the hand that identifies a location of a hand of a subject positioned close to the hand of another subject. Finally, the classifications can include an identifier of a likely inventory item.

In another implementation, the logic to process sets of images includes, for the identified subjects, identifying bounding boxes of data representing hands in images in the sets of images of the identified subjects. The data in the bounding boxes are processed to generate classifications of data within the bounding boxes for the identified subjects. In such an implementation, the classifications can include predicting whether the identified subject is holding an inventory item. The classifications can include a first nearness classification indicating a location of a hand of the identified subject relative to a shelf. The classifications can include a second nearness classification indicating a location of a hand of the identified subject relative to the body of the identified subject. The classifications can include a third nearness classification indicating a location of a hand of the identified subject relative to a basket associated with an identified subject. The classification can include a fourth nearness classification of the hand that identifies a location of a hand of a subject positioned close to the hand of another subject. Finally, the classifications can include an identifier of a likely inventory item.

The process starts at an operation 1802. At an operation 1804, locations of hands (represented by hand joints) of subjects in image frames are identified. The bounding box generator 1804 identifies hand locations of subjects per frame from each camera using joint locations identified in the first data sets generated by the Joints CNNs 112a-112n. Following this, at an operation 1806, the bounding box generator 1608 processes the first data sets to specify bounding boxes which include images of hands of identified multi-joint subjects in images in the sequences of images. Details of the bounding box generator are presented above with reference to FIG. 16A.

A second image recognition engine receives sequences of images from the plurality of cameras and processes the specified bounding boxes in the images to generate the classification of hands of the identified subjects (operation 1908). In one implementation, each of the image recognition engines used to classify the subjects based on images of hands comprises a trained convolutional neural network referred to as a WhatCNN 1610. WhatCNNs are arranged in multi-CNN pipelines as described above in relation to FIG. 16A. In one implementation, the input to a WhatCNN is a multi-dimensional array B×W×H×C (also referred to as a B×W×H×C tensor). “B” is the batch size indicating the number of image frames in a batch of images processed by the WhatCNN. “W” and “H” indicate the width and height of the bounding boxes in pixels, and “C” is the number of channels. In one implementation, there are 30 images in a batch (B=30), so the size of the bounding boxes is 32 pixels (width) by 32 pixels (height). There can be six channels representing red, green, blue, foreground mask, forearm mask and upperarm mask, respectively. The foreground mask, forearm mask and upperarm mask are additional and optional input data sources for the WhatCNN in this example, which the CNN can include in the processing to classify information in the RGB image data. The foreground mask can be generated using a mixture of Gaussian algorithms, for example. The forearm mask can be a line between the wrist and elbow providing context produced using information in the joints data structure. Likewise, the upperarm mask can be a line between the elbow and shoulder produced using information in the joints data structure. Different values of B, W, H and C parameters can be used in other implementations. For example, in another implementation, the size of the bounding boxes is larger e.g., 64 pixels (width) by 64 pixels (height) or 128 pixels (width) by 128 pixels (height).

Each WhatCNN 1610 processes batches of images to generate classifications of hands of the identified subjects. The classifications can include whether the identified subject is holding an inventory item. The classifications can further include one or more classifications indicating locations of the hands relative to the shelves and relative to the subjects, relative to a shelf or a basket, and relative to a hand or another subject, usable to detect puts and takes. In this example, a first nearness classification indicates a location of a hand of the identified subject relative to a shelf. The classifications can include a second nearness classification indicating a location a hand of the identified subject relative to the body of the identified subject. A subject may hold an inventory item during shopping close to his or her body instead of placing the item in a shopping cart or a basket. The classifications can further include a third nearness classification indicating a location of a hand of the identified subject relative to a basket associated with an identified subject. A “basket” in this context can be a bag, a basket, a cart or other object used by the subject to hold the inventory items during shopping. The classifications can include a fourth nearness classification of the hand that identifies a location of a hand of a subject positioned close to the hand of another subject. Finally, the classifications can include an identifier of a likely inventory item. The final layer of the WhatCNN 1610 produces logits which are raw values of predictions. The logits are represented as floating point values and further processed, as described below, to generate a classification result. In one implementation, the outputs of the WhatCNN model include a multi-dimensional array B×L (also referred to as a B×L tensor). “B” is the batch size, and “L=N+5” is the number of logits output per image frame. “N” is the number of SKUs representing “N” unique inventory items for sale in the store.

The output “L” per image frame is a raw activation from the WhatCNN 1610. The logits “L” are processed at an operation 1810 to identify an inventory item and context. The first “N” logits represent the confidence that the subject is holding one of the “N” inventory items. The logits “L” include an additional five (5) logits which are explained below. The first logit represents the confidence that the image of the item in the hand of the subject is not one of the store SKU items (also referred to as a non-SKU item). The second logit indicates a confidence of whether the subject is holding an item or not. A large positive value indicates that the WhatCNN model has a high level of confidence that the subject is holding an item. A large negative value indicates that the model is confident that the subject is not holding any item. A close to zero value of the second logit indicates that the WhatCNN model is not confident in predicting whether the subject is holding an item or not. The value of the holding logit is provided as input to the proximity event detector for location-based put and take detection.

The next three logits represent first, second and third nearness classifications, including a first nearness classification indicating a location of a hand of the identified subject relative to a shelf, a second nearness classification indicating a location of a hand of the identified subject relative to the body of the identified subject, and a third nearness classification indicating a location of a hand of the identified subject relative to a basket associated with an identified subject. Thus, the three logits represent the context of the hand location with one logit each indicating the confidence that the context of the hand is near to a shelf, near to a basket (or a shopping cart), or near to the body of the subject. In one implementation, the output can include a fourth logit representing the context of the hand of a subject positioned close to a hand of another subject. In one implementation, the WhatCNN is trained using a training dataset containing hand images in the three contexts: near to a shelf, near to a basket (or a shopping cart), and near to the body of a subject. In another implementation, the WhatCNN is trained using a training dataset containing hand images in the four contexts: near to a shelf, near to a basket (or a shopping cart), near to the body of a subject, and near to a hand of another subject. In another implementation, a “nearness” parameter is used by the system to classify the context of the hand. In such an implementation, the system determines the distance of a hand of the identified subject to the shelf, basket (or a shopping cart), and body of the subject to classify the context.

The output of a WhatCNN is “L” logits comprised of N SKU logits. 1 Non-SKU logit, 1 holding logit, and 3 context logits as described above. The SKU logits (first N logits) and the non-SKU logit (the first logit following the N logits) are processed by a softmax function. As described above with reference to FIG. 4A, the softmax function transforms a K-dimensional vector of arbitrary real values to a K-dimensional vector of real values in the range [0, 1] that add up to 1. A softmax function calculates the probabilities distribution of the item over N+1 items. The output values are between 0 and 1, and the sum of all the probabilities equals one. The softmax function (for multi-class classification) returns the probabilities of each class. The class that has the highest probability is the predicted class (also referred to as the target class). The value of the predicted item class is averaged over N frames before and after the proximity event to determine the item associated with the proximity event.

The holding logit is processed by a sigmoid function. The sigmoid function takes a real number value as input and produces an output value in the range of 0 to 1. The output of the sigmoid function identifies whether the hand is empty or holding an item. The three context logits are processed by a softmax function to identify the context of the hand joint location. At an operation 1812, it is checked whether there are more images to process. If true, operations 1804-1810 are repeated, otherwise the process ends at operation 1814.

### WhenCNN-Time Series Analysis to Identify Puts and Takes of Items

In one implementation, the technology disclosed performs a time sequence analysis over the classifications of subjects to detect takes and puts by the identified subjects based on foreground image processing of the subjects. The time sequence analysis identifies gestures of the subjects and inventory items associated with the gestures represented in the sequences of images. The outputs of WhatCNNs 1610 are given as inputs to the WhenCNN 1612 which processes these inputs to detect puts and takes of items by the identified subjects. The system includes logic, responsive to the detected takes and puts, to generate a log data structure including a list of inventory items for each identified subject. In the example of a store, the log data structure is also referred to as a shopping cart data structure 1620 per subject.

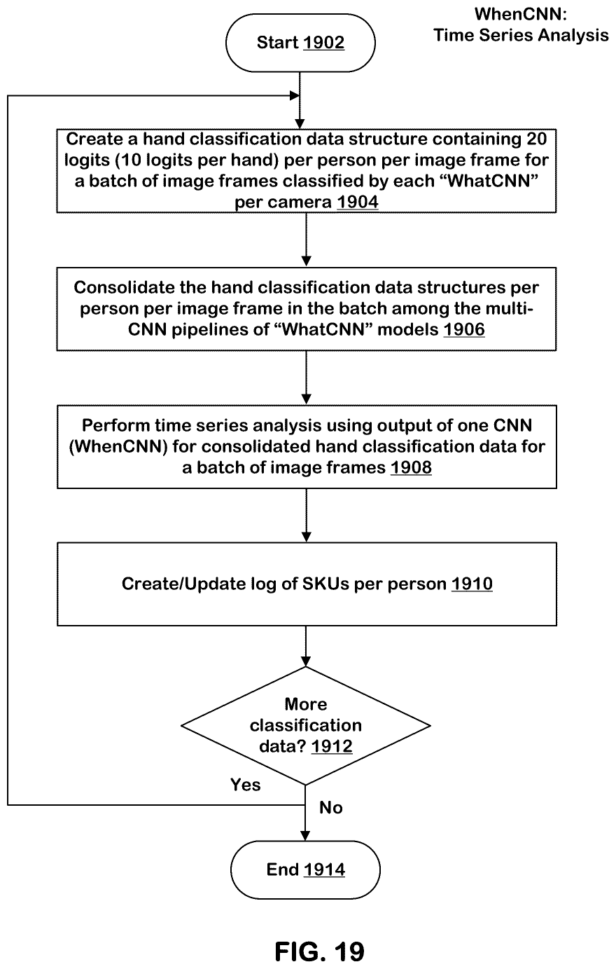

FIG. 19 presents a process implementing the logic to generate a shopping cart data structure per subject. The process starts at an operation 1902. The input to the WhenCNN 1612 is prepared at an operation 1904. The input to the WhenCNN is a multi-dimensional array B×C×T×Cams, where B is the batch size, C is the number of channels, T is the number of frames considered for a window of time, and Cams is the number of cameras 114. In one implementation, the batch size “B” is 64 and the value of “T” is 110 image frames or the number of image frames in 3.5 seconds of time. It is understood that other values of batch size “B” greater than or less than 64 can be used. Similarly, the value of the parameter “T” can be set greater than or less than 110 images frames or a time period greater than or less than 3.5 seconds can be used to select the number of frames for processing.

For each subject identified per image frame, per camera, a list of 10 logits per hand joint (20 logits for both hands) is produced. The holding and context logits are part of the “L” logits generated by the WhatCNN 1610 as described above.

| [ | |
|---|---|
| holding, | # 1 logit |
| context, | # 3 logits |
| slice_dot(sku, log_sku), | # 1 logit |
| slice_dot(sku, log_other_sku), | # 1 logit |
| slice_dot(sku, roll(log_sku, −30)), | # 1 logit |
| slice_dot(sku, roll(log_sku, 30)), | # 1 logit |
| slice_dot(sku, roll(log_other_sku, −30)), | # 1 logit |
| slice_dot(sku, roll(log_other_sku, 30)) | # 1 logit |

]

The above data structure is generated for each hand in an image frame and also includes data about the other hand of the same subject. For example, if data are for the left hand joint of a subject, corresponding values for the right hand are included as “other” logits. The fifth logit (item number 3 in the list above referred to as log_sku) is the log of the SKU logit in the “L” logits described above. The sixth logit is the log of the SKU logit for the other hand. A “roll” function generates the same information before and after the current frame. For example, the seventh logit (referred to as roll (log_sku,−30)) is the log of the SKU logit, 30 frames earlier than the current frame. The eighth logit is the log of the SKU logit for the hand, 30 frames later than the current frame. The ninth and tenth data values in the list are similar data for the other hand 30 frames earlier and 30 frames later than the current frame. A similar data structure for the other hand is also generated, resulting in a total of 20 logits per subject per image frame per camera. Therefore, the number of channels in the input to the WhenCNN is 20 (i.e. C=20 in the multi-dimensional array B×C×T×Cams), whereas “Cams” represents the number of cameras in the area of real space.

For all image frames in the batch of image frames (e.g., B=64) from each camera, similar data structures of 20 hand logits per subject, identified in the image frame, are generated. A window of time (T=3.5 seconds or 110 image frames) is used to search forward and backward image frames in the sequence of image frames for the hand joints of subjects. At step 1906, the 20 hand logits per subject per frame are consolidated from multiple WhatCNNs. In one implementation, the batch of image frames (64) can be imagined as a smaller window of image frames placed in the middle of a larger window of the image frame 110 with additional image frames for forward and backward search on both sides. The input B×C×T×Cams to the WhenCNN 1612 is composed of 20 logits for both hands of subjects identified in batch “B” of image frames from all cameras 114 (referred to as “Cams”). The consolidated input is given to a single trained convolutional neural network referred to as the WhenCNN model 1608. The output of the WhenCNN model comprises 3 logits, representing confidence in three possible actions of an identified subject: taking an inventory item from a shelf, putting an inventory item back on the shelf, and no action. The three output logits are processed by a softmax function to predict the action performed. The three classification logits are generated at regular intervals for each subject and the results are stored per person along with a time stamp. In one implementation, the three logits are generated every twenty frames per subject. In such an implementation, at an interval of every 20 image frames per camera, a window of 110 image frames is formed around the current image frame.

A time series analysis of these three logits per subject over a period of time is performed (operation 1908) to identify gestures corresponding to true events and their time of occurrence. A non-maximum suppression (NMS) algorithm is used for this purpose. As one event (i.e. the put or take of an item by a subject) is detected by the WhenCNN 1612 multiple times (both from the same camera and from multiple cameras), the NMS removes superfluous events for a subject. The NMS is a rescoring technique comprising two main tasks: “matching loss” that penalizes superfluous detections and “joint processing” of neighbors to know if there is a better detection close by.

The true events of takes and puts for each subject are further processed by calculating an average of the SKU logits for 30 image frames prior to the image frame with the true event. Finally, the arguments of the maxima (abbreviated arg max or argmax) are used to determine the largest value. The inventory item classified by the argmax value is used to identify the inventory item put on or taken from the shelf. The inventory item is added to a log of SKUs (also referred to as shopping cart or basket) of respective subjects in operation 1910. The process operation 1904 to 1910 are repeated, if there are more classification data (checked at operation 1912). Over a period of time, this processing results in updates to the shopping cart or basket of each subject. The process ends at operation 1914.

The following sections present process flowcharts for location-based event detection, item detection in location-based events and fusion of a location-based events stream with a region proposals-based events stream and a semantic diffing-based events stream.

### Process Flowcharts for Proximity Event Detection and Item Detection

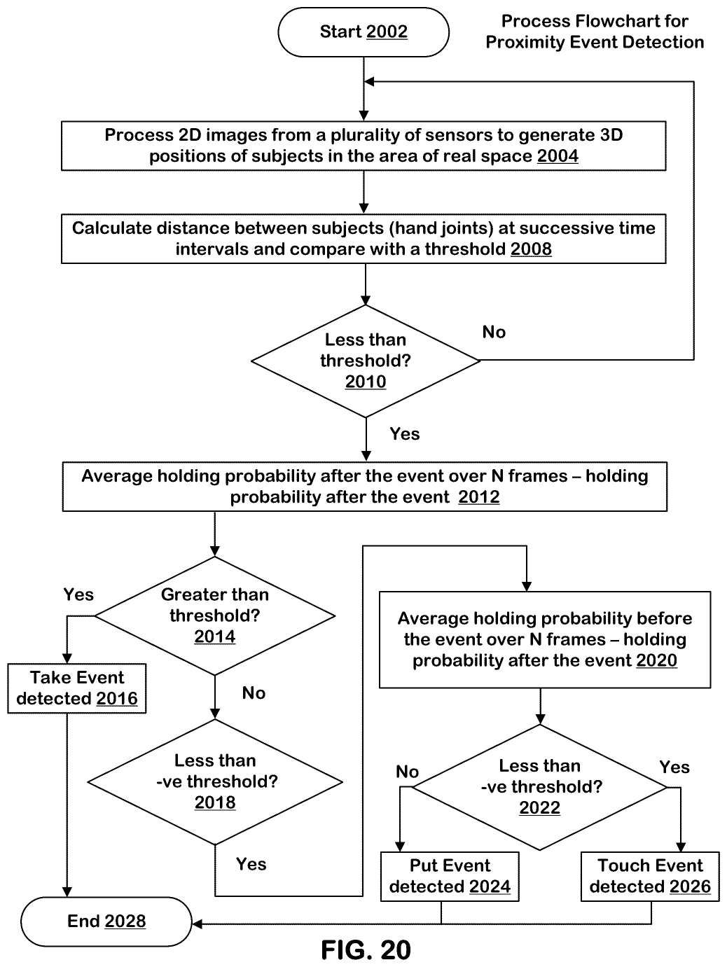

FIG. 20 presents a flowchart of process operations for detecting location-based events in the area of real space. The process starts at an operation 2002. The system processes 2D images from a plurality of sensors to generate 3D positions of subjects in the area of real space (operation 2004). As described above, the system uses image frames from synchronized sensors with overlapping fields of views for 3D scene generation. In one implementation, the system uses joints to create and track subjects in the area of real space. The system calculates distances between hand joints (both left and right hands) (operation 2008) of subjects at regular time intervals and compares the distances with a threshold. If the distance between hand joints of two subjects is below a threshold (operation 2010), the system continues the process operations for detecting the type of the proximity event (put, take or touch). Otherwise, the system repeats operations 2004 to 2010 for detecting proximity events.

At an operation 2012, the system calculates the average holding probability over N frames after the frame in which the proximity event was detected for the subjects whose hands were positioned closer than the threshold. Note that the WhatCNN model described above outputs a holding probability per hand per subject per frame which is used in this process operation. The system calculates the difference between the average holding probability over N frames after the proximity event and the holding probability in a frame following the frame in which proximity event is detected. If the result of the difference is greater than a threshold (operation 2014), the system detects a take event (operation 2016) for the subject in the image frame. Note that when one subject hands-off an item to another subject, the location-based event can have a take event (for the subject who takes the item) and a put event (for the subject who hands-off the item). The system processes the logic described in this flowchart for each hand joint in the proximity event, thus the system is able to detect both take and put events for the subjects in the location-based events. If at the operation 2014, it is determined that the difference between the average holding probability value over N frames after the event and the holding probability value in the frame following the proximity event is not greater than the threshold (operation 2014), the system compares the difference to a negative threshold (operation 2018). If the difference is less than the negative threshold then the proximity event can be a put event, however, it can also indicate a touch event. Therefore, the system calculates the difference between the average holding probability value over N frames before the proximity event and the holding probability value after the proximity event (operation 2020). If the difference is less than a negative threshold (operation 2022), the system detects a touch event (operation 2026). Otherwise, the system detects a put event (operation 2024). The process ends at an operation 2028.

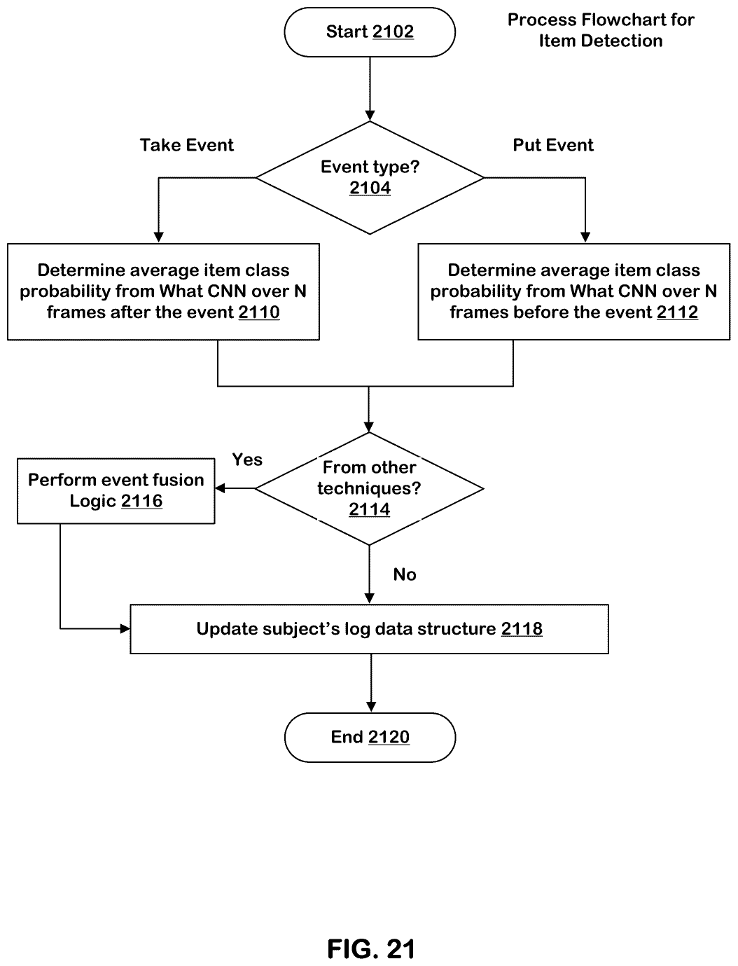

FIG. 21 presents a process flowchart for item detection in a proximity event. The process starts at an operation 2102. The event type is detected at an operation 2104. We have presented detailed process steps above of the event type detection in the process flowchart in FIG. 21. If a take event is detected (operation 2104), the process continues at an operation 2110. The system determines the average item class probability by taking an average of the item class probability values from the WhatCNN over N frames after the frame in which the proximity event is detected. If a put event is detected the process continues at an operation 2112 in the process flowchart. The system determines the average item class probability by taking an average of the item class probability values from the WhatCNN over N frames before the frame in which the proximity event is detected.

At an operation 2114, the system checks if event streams from other event detection techniques have a matching event. We have presented details of two parallel event detection techniques above: a region proposals-based event detection technique (also referred to as second image processors) and a semantic diffing-based event detection technique (also referred to as third image processors). If a matching event is detected from other event detection techniques, the system combines the two events using event fusion logic in an operation 2116. As described above, the event fusion logic can include weighted combination of events from multiple event streams. If no matching event is detected from other events streams, then the system can use the item classification from the location-based event. The process continues at an operation 2118 in which the subject's log data structure is updated using the item classification and the event type. The process ends at an operation 2120.

### Process for Setup and Operations of Monitoring Within an Area of Real Space

FIG. 22 presents a process flowchart for setting up and operating one or more cameras configured to perform monitoring tasks. In many implementations, the technology disclosed allows owners or managers of a store to quickly update their existing stores with additional monitoring functionality (e.g., planogram compliance, inventory stock level monitoring, and various store performance and marketing data analytics) without any changes to structure of the premises or layout of the existing area of real space. The technology disclosed also allows quick setup of the computer vision system at temporary locations such as fairs, sporting events, conventions, conferences or at other types of events for a limited time duration. Temporary operations, like pop-up stores or kiosks, can be setup quickly and be ready in operation for a few days or few weeks and then taken down at the end of the event at which the operations are setup.

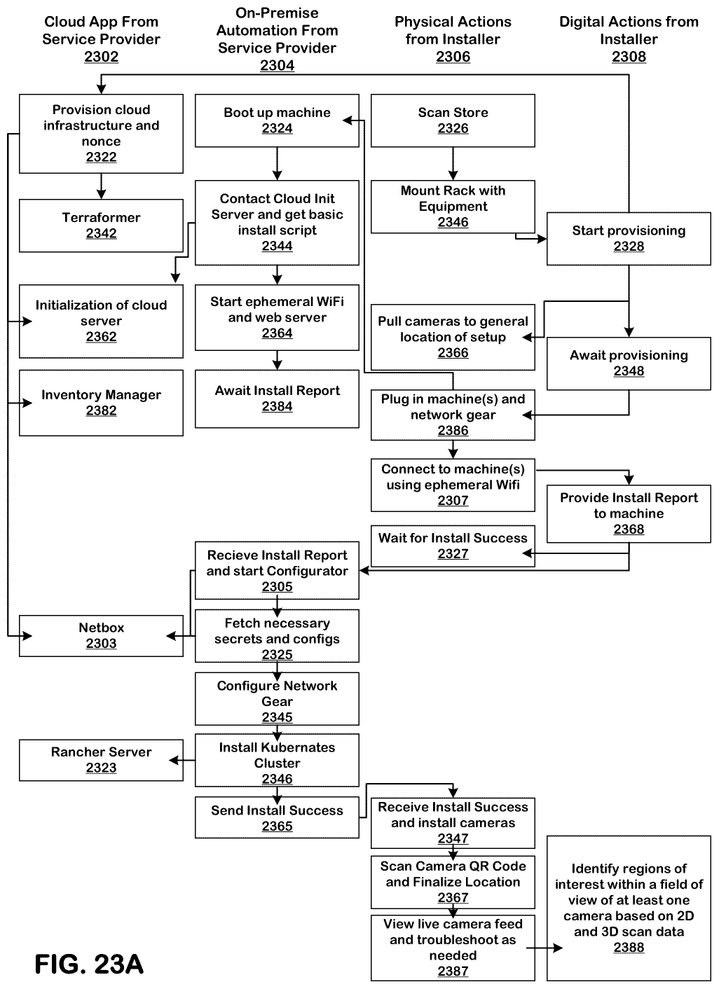

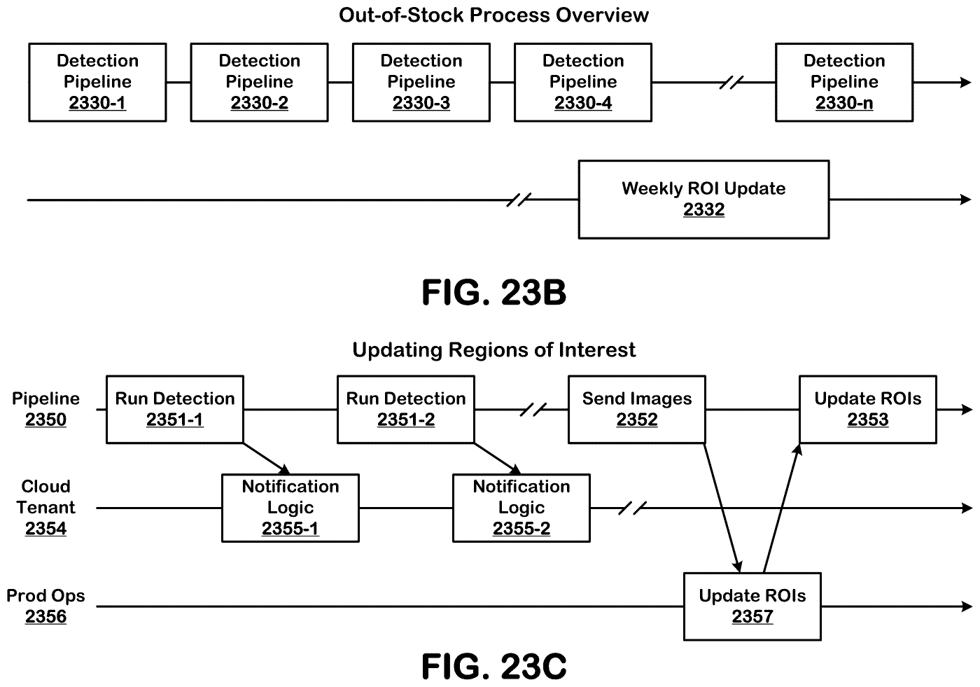

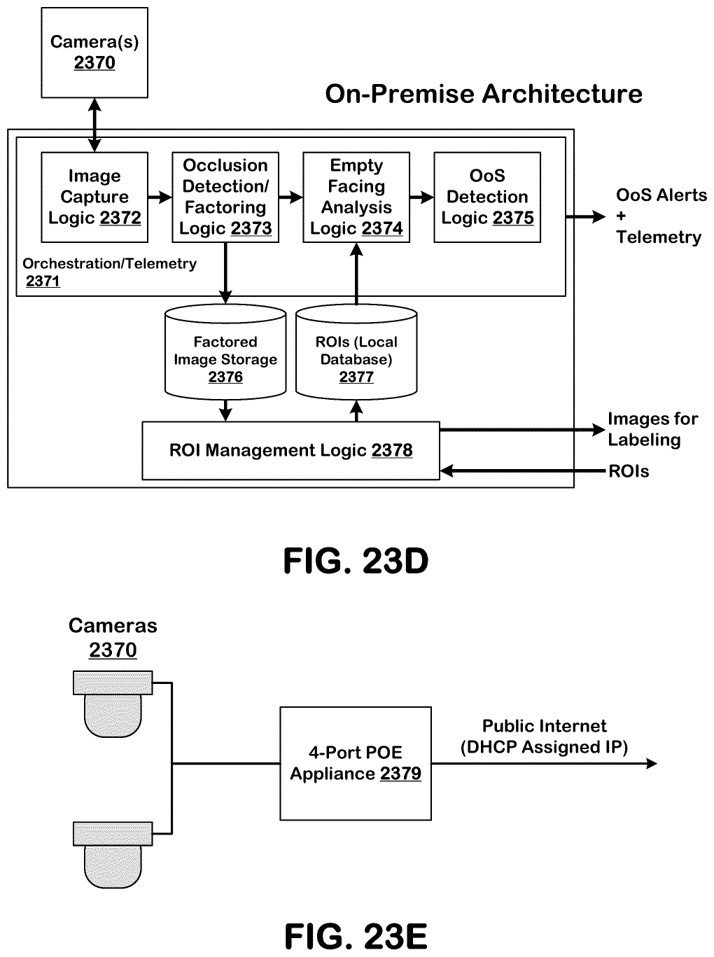

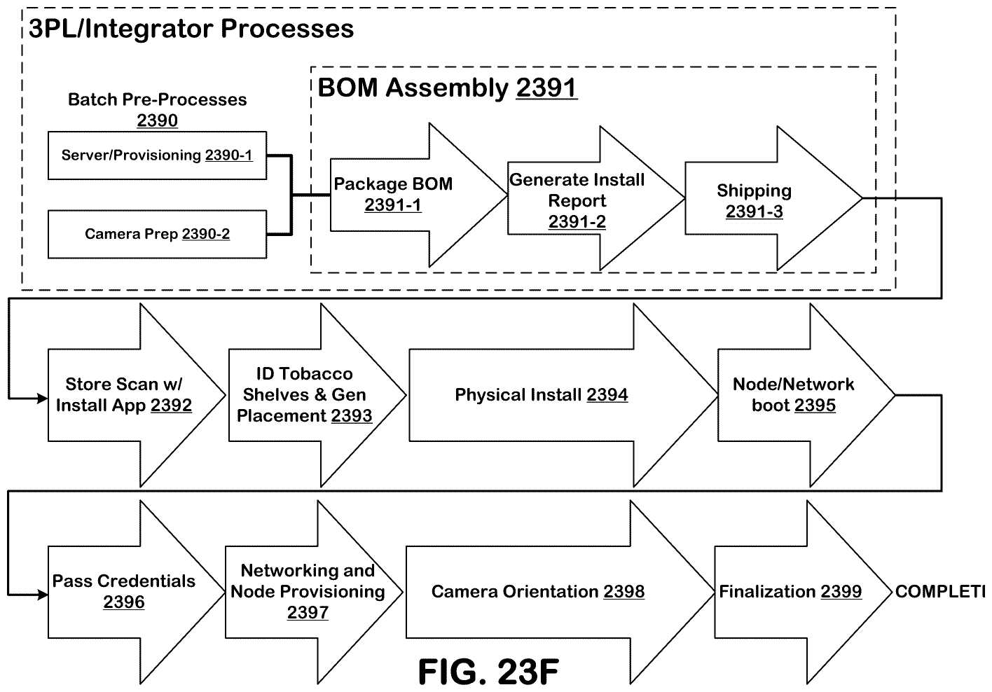

In the descriptions with reference to FIGS. 22 and 23, setup and operation processes are described within the context of a store. The cameras may be configured to assist in security monitoring, monitoring, planogram compliance, marketing data analytics, store performance analytics, and/or the automation of other various store operations. However, in other implementations, the processes depicted within FIGS. 22 and 23 may involve the setup of cameras within other non-retail environments, such as warehouses, office buildings, and personal residences. Aspects of the technology disclosed described herein, such as those related to the identification, re-identification, location tracking, and interaction tracking of objects and subjects, translate to non-retail environments for monitoring systems. For example, inventory monitoring may be performed in warehouse and shipping facilities. Subject tracking for the purposes of security surveillance can be leveraged in a variety of commercial and residential applications, for example, within banks and home security (e.g., using cameras and other smart home IoT devices).

The process starts at an operation 2205 when a camera placement plan is generated for the area of real space. The technology disclosed can use the camera placement plan generation technique presented above. A map of the area of real space can be provided as input to the camera placement generation technique along with any constraints for placement of cameras. The constraints can identify locations at which cameras cannot be installed. The camera placement generation technique outputs one or more camera placement maps for the area of real space. A camera placement map generated by the camera placement technique can be selected for installing cameras in the area of real space. The owner of the store or the manager of the store can order cameras which can be delivered to the store for installation per the selected camera placement map generated by the camera placement generation technique. The cameras can be installed at the ceiling of the store or installed using stands/tripods at outdoor locations. The technology disclosed provides a convenient self-service solution for setting up cameras at the location of the store. The serial number and/or identifier of a camera can be scanned and provided as input to the self-service engine 195 when placing the camera at a particular camera location per the camera placement map. For example, a camera with a serial number “ABCDEF” is registered as camera number “1” when plugged into the location at a location that is designated as a location for camera “1” in the camera placement map. A central server such as a cloud-based server can register the cameras installed in the area of real space and assign them the camera numbers per camera placement map. The technology disclosed allows swapping of existing cameras with new cameras when a camera breaks down or when a new camera with higher resolution and/or processing power is to be installed to replace an old camera. The existing camera can be plugged out of its location and a new camera can be plugged in by an employee of the store. The self-service engine 195 automatically updates the camera placement record in a camera placement record for the area of real space by replacing the serial number of the old camera with the serial number of the new camera. The self-service engine 195 can also send camera setup configuration data to the new camera. Such data can be accessed from the calibration database 150. Further details of an automatic camera placement generation technique are presented above and also in U.S. patent application Ser. No. 17/358,864, entitled. “Systems and Method for Automated Design of Camera Placement and Cameras Arrangements for Autonomous Checkout.” filed on 25 Jun. 2021, now issued as U.S. Pat. No. 11,303,853 which is fully incorporated into this application by reference.

When one or more cameras are installed in the area of real space, the technology disclosed can initiate auto-calibration technique presented above for calibrating the one or more cameras. The technology disclosed can apply the logic implemented in the camera calibration engine 190 to calibrate or recalibrate the cameras in the area of real space (operation 2210). The camera recalibration can be performed at regular intervals or when one or more cameras are moved from their respective locations due to changes or movements in the structure on which they are positioned or due to cleaning etc. The details of an automatic camera calibration and recalibration technique are presented above and also in U.S. patent application Ser. No. 17/357,867, entitled. “Systems and Methods for Automated Recalibration of Sensors for Autonomous Checkout.” filed on 24 Jun. 2021, now issued as U.S. Pat. No. 11,361,468 which is fully incorporated into this application by reference. The technology disclosed can also use the automated camera calibration technique presented in U.S. patent application Ser. No. 17/733,680, entitled. “Systems and Methods for Extrinsic Calibration of Sensors for Autonomous Checkout.” filed on 29 Apr. 2022 which is fully incorporated into this application by reference.

After the cameras are installed per the cameras placement map and calibrated to track subjects in the area of real space, the technology disclosed includes logic to access a global product catalog or a master product catalog. The global product catalog can include SKU data for all (or most) of the inventory items placed in inventory display structures of the store (operation 2215). In one implementation, the technology disclosed includes logic to sync global or master product catalog with one or more local product catalog of the store to include inventory items from the local product catalog to the global or master product catalog that are not already in the global or master product catalog. In some cases, some of the inventory items may not be present in in the global product catalog. In such cases, the technology disclosed can incorporate additional items into the global product catalog by asking the subjects to take images of items that they take items from the inventory display structure and send the images to the self-service engine 195 by uploading the images to a store app or via an email address. In this way, the technology disclosed can continuously update the master product catalog as new items are added to a store.

The technology disclosed can also implement a “gamification” model in which subjects (such as customer or shoppers) are offered incentives when they capture images of items in the store and send those images to the self-service engine 195 (operation 2220). The customers can be offered coupons for discounts on their purchases. They may also be offered specific discounts such as a pre-determined dollar amount off on the item purchased or a pre-determined percentage off on the price of item in the image. It is understood that other gamification models can be implemented by the technology disclosed in which shoppers can be provided incentives such as loyalty points etc. for providing images of items purchased from a store. The technology disclosed includes logic to process the images of inventory items provided by the subjects by labeling the images and/or performing other verification steps before including the new inventory item in a master product catalog. In one implementation, the technology disclosed includes a new item in the master catalog when at least three subjects have provided images of that particular item. Using multiple images of an inventory item captured by one or more than one subject can not only ensure that the item is correctly entered in the master product catalog but also provide multiple images of the item which can be used to train the machine learning algorithm for detecting the inventory item such as the WhatCNN algorithm presented above. The details of a region proposal subsystem (including the WhatCNN) to detect inventory events (or to perform action detection) are presented in U.S. patent application Ser. No. 15/907,112, entitled. “Item Put and Take Detection Using Image Recognition.” filed on 27 Feb. 2018, now issued as U.S. Pat. No. 10,133,933 which is fully incorporated into this application by reference.

The technology disclosed can then initiate the subject tracking logic as implemented by the subject tracking engine 110 to track subjects in the area of real space and to detect actions performed by the subjects (operation 2225). Details of the logic applied by the subject tracking engine 110 to create subjects by combining candidate joints and track movement of subjects in the area of real space are presented in U.S. patent application Ser. No. 15/847,796, entitled. “Subject Identification and Tracking Using Image Recognition Engine.” filed on 19 Dec. 2017, now issued as U.S. Pat. No. 10,055,853, which is fully incorporated into this application by reference. In one implementation, the technology disclosed can implement a semantic diffing subsystem to track subjects and identify inventory events or to perform action detection. Details of “semantic diffing” subsystem are presented in U.S. patent application Ser. No. 15/945,466, entitled. “Predicting Inventory Events using Semantic Diffing.” filed on 4 Apr. 2018, now issued as U.S. Pat. No. 10,127,438, and U.S. patent application Ser. No. 15/945,473, entitled. “Predicting Inventory Events using Foreground/Background Processing.” filed on 4 Apr. 2018, now issued as U.S. Pat. No. 10,474,988, both of which are fully incorporated into this application by reference.

As the subject take items from the inventory display structures and put items back on the inventory display structures, the technology disclosed can detect the inventory events and update inventory log data structures associated with tracked subjects (operation 2225). The technology disclosed can process the shopping carts of subjects as they exit the store to send them respective digital receipts. The above process continues to track subjects and detect actions of subjects as they take items from inventory display structures. In one implementation, when the Internet is not available at the location of the cashier-less store, the technology disclosed can process the generation of digital receipts at another location where the Internet is available at regular time intervals during a day or at the end of the day. Therefore, the technology disclosed can be used to provide cashier-less store with autonomous checkout at locations where no Internet is available.

When a camera is replaced due to e.g., malfunction, upgrade or any other reason, the self-service engine 195 includes logic to detect that a new camera is installed in the area of real space as the serial number or identifier of the camera is updated (operation 2230). The technology disclosed can then perform the auto-recalibration of the cameras when one or more cameras are replaced in the area of real space (operation 2235). Otherwise, the operations of the cashier-less stores are performed as described above including the updating of the master product catalog via gamification (operation 2220) and performing of the subject tracking and the action detection logic (operation 2225).

The technology disclosed can include additional features that enable using processing capabilities at the cameras to process images captured by the camera. For example, the one or more operations of the self-service cashier-less store such as subject identification, subject tracking, subject re-identification (RE-ID), pose detection and/or inventory event detection (or action detection) can be performed locally at the location of the cashier-less store without sending the images/videos to a server such as a cloud-based server. In one implementation, the one or more operations listed above can be performed per camera (or per sensor) or per subsets of cameras (or per subset of sensors). For example, in such an implementation, the camera can include processing logic to process images captured by the camera to detect a pose of the subject or re-identify a subject that was missing in one or more previous subject identification time intervals. Similarly, in such an implementation, action detection techniques can be delegated to the camera such that inventory events are detected per camera.

Many implementations of the technology disclosed relate to low-cost deployment of out-of-stock notifications using a limited number of cameras (e.g., 4 or less cameras) including the generation of out-of-stock notifications at regular intervals (e.g., daily or weekly) at a SKU level, based only on shelf-level data. Once a store has been scanned and a planogram has been generated for the store, as previously described, regions of interest can be identified within the store. A region of interest is a 3D space on a shelf in which a particular SKU is expected to be stocked. The region of interest can be represented as a bounding box in the image plane of one or more cameras monitoring the region of interest and, optionally, the SKU that is intended to be located at the region of interest (i.e., as populated by visual verification, manual input, and/or based on a planogram of the store). An empty facing region of interest is defined as a region of interest not stocked with a SKU. A particular SKU is defined as being out-of-stock when all intended facings of the particular SKU are determined to be empty. This data can be leveraged to maintain planogram compliance, such as the production of a report indicating the number of regions of interest that are stocked with the correct SKU, any regions of interest that are incorrectly stocked, low stock or out-of-stock regions of interest, or regions of interest having other poor shelf conditions.

The monitoring system can include two processes; a detection pipeline that runs at a regular cadence and a weekly (or daily) region of interest update process that includes updating regions of interest for the SKUs selected for monitoring (as shown in FIG. 23B). In one example, the detection pipeline can run against a local database holding regions of interest and generate a report of all empty regions of interest as well as any true out-of-stock SKUs (as defined by all regions of interest labeled with the same SKU being reported as empty). Notifications based on this report can be sent to the store or supplier, as well as the generation of visual display indicators within a digital map of the store.

The monitoring system can further include an additional process for updating the regions of interest that is initiated based on time intervals. The regions of interest may be initiated once daily or once weekly, for example. The process for updating the regions of interest is partially manual in some implementations of the technology disclosed. Updating the regions of interest in a retail store includes uploading recent up-to-date snapshots of the monitored shelf facings to a region of interest labeling service. After region of interest labeling has been performed, the labels are pushed back to the local region of interest database (as shown in FIG. 23C). An installation process for setting up and operating the one or more cameras configured to perform monitoring tasks is described below.

### Setup and Operations for Monitoring Regions of Interest

FIG. 23A is a process flowchart presenting an installation process associated with setting up and operating the one or more cameras configured to perform monitoring tasks, such as monitoring out of stocks. The operations of FIG. 23A may be performed as an alternative to the operations of FIG. 22, or in various combinations with the operations of FIG. 22. FIG. 23A includes one example, for illustrative purposes, of operations performed by a cloud application 2302, provided by a service provider, performed as on-premise automation 2304, from the service provider, physical actions from the installer 2306, and digital actions from the installer 2308. It is to be understood that the use of specific tools and services, such as Kubernetes and Netbox, can be replaced with other equivalent tools that will be readily apparent to a user skilled in the art.

In an operation 2326, a scan of the store is completed to obtain a 3D point cloud representation of the area of real space followed by the physical installation (e.g., mounting a rack with hardware equipment) of a control device in an operation 2346. The installer is then able to begin the provisioning process in operation 2328, triggering the provisioning of a cloud infrastructure and nonce, at the cloud application 2302, in an operation 2322. After operation 2322 has been initiated, additional setup operations at the cloud application 2302 are performed including a terraforming operation 2342, initialization of a cloud server 2362, and initialization of an inventory manager 2382. While the installer is awaiting provisioning (operation 2348), they can begin pulling cameras to their general locations of placement (operation 2366; camera placement described further below) and plug in the control device and network gear (operation 2386). Once the control device has power access, it can be connected to an ephemeral WiFi network (operation 2307) enabling the machine to receive an install report in operation 2368. At an operation 2327, the installer waits to receive notification of successful installation prior to proceeding with further installation of the cameras in a later step 2347. Additionally, once the control device has power access (operation 2324), on-premise automation operations 2304 may begin including contacting the cloud initialization server to receive the basic install script (operation 2344), start the ephemeral WiFi and web server (operation 2364, which also enables operation 2307 to be performed), and awaiting receipt of the install report 2384, as initiated in operation 2368.

Once the install report has been received in an operation 2305, a Configurator is started. The Configurator performs operations 2325, 2345, and 2346, respectively corresponding to fetching all necessary secrets and configs from the service provider's servers, configuring the network gear, and installing a Kubernetes cluster. Once operations 2325, 2345, and 2346 have been successfully completed, a confirmation of successful installation is transmitted in operation 2365. Once the installer has received the successful installation notification in operation 2347, the installer can begin the setup process specific to each camera. In many implementations, camera setup can include scanning a QR code unique to a particular camera with a smartphone (operation 2367) and setting up the camera at its expected location (operation 2387). Operation 2387 may further include adjusting the camera's angle, orientation, and positioning, and further troubleshooting can be performed by the installer while viewing a live camera feed. Operations 2347, 2367, and 2387 are repeated for each camera.

After operation 2305 has been performed (fetching all necessary secrets and configs from the service provider's servers), the cloud application 2302 can further proceed from provisioning of the cloud infrastructure and nonce to setting up a network service, e.g., Netbox, in operation 2303. Additionally, once the Kubernetes cluster has been installed in operation 2346, a Kubernetes Rancher server can also be established via the cloud application 2302 at an operation 2323.

Following setup, system operations for region of interest monitoring can include a detection pipeline and processes for updating the regions of interest to be monitored (operation 2388). In an example for retail applications, the detection pipeline can include detecting empty facing regions of interest on shelving structures and out-of-stock SKU's based on empty regions of interest.

FIG. 23B is a schematic diagram of an out-of-stock detection process. FIG. 23B further includes a detection pipeline 2330 and a region of interest update process 2332 that can be repeated at regular intervals, e.g., daily or weekly. The detection pipeline 2330 runs at a regular cadence that is more frequent than the region of interest update process 2332 (e.g., n instances of the run detection pipeline 2330-1, 2330-2, 2330-3, 2330-4, . . . , 2330-n). During an instance of the run detection pipeline 2330, current data received from the cameras associated with present stock levels of SKUs within respective region of interest can be run against a local database holding the regions of interest, and a report is generated of all empty regions of interest and all out-of-stock SKUs. As previously described, a range of various notification mechanisms can occur based on the data included in the generated report to better inform the store and/or the supplier about present inventory stock levels, inventory stock trends, and other performance analytics. A region of interest update process 2332 is performed at regular intervals, such as weekly intervals. Region of interest update process 2332 is expanded upon in FIG. 23C.

In many implementations, the identification of regions of interest is performed in dependence upon an object classification model trained to process, as input, image data corresponding to a particular area of real space and a 3D point cloud representation of the particular area of real space in order to generate, as output, a classification of an object within the particular area of real space. As the 3D point cloud is collected during the scanning process, RGB data is also obtained, i.e., each point in the 3D point cloud is associated with both spatial information and RGB values. The collected RGB values for each point in the 3D point cloud can be “flattened” to produce a 2D image to be used as input to the classifier. The object classification model is thus able to process the 3D point cloud representation of the area of real space obtained during the setup process and 2D images of the same area of real space, captured by the scanning process, and process both the point cloud data and the image data for the area of real space to classify regions of interest for monitoring. The regions of interest received as output from the object classification model can be leveraged to inform placement and calibration of the cameras while finalizing the camera layout. Furthermore, the outputs of the object classification model can also be used to detect draft and monitor/manage change(s) to the one or more established regions of interest. The labelling of specific subregions as regions of interest can be updated over time as the store layout and placement of items changes via regular repetition of region of interest labelling within collected images.

FIG. 23C is a schematic diagram of a region-of-interest update process, including detection pipeline 2350, cloud tenant 2354, and product operations 2356. In the detection pipeline 2350, instances of the run detection operations 2351 are initiated at regular intervals (e.g., every 5 minutes, 10 minutes, or 15 minutes). A notification logic 2355 of the cloud tenant 2354 is configured to generate one or more notifications indicating empty facing regions of interest, low stock regions of interest, out of stock regions of interest, and so on. Instances of notification logic 2355 are triggered in response to an instance of the run detection pipeline 2351, e.g., notification logic instance 2355-1 following run detection instance 2351-1 and notification logic instance 2355-2 following run detection instance 2351-2. At a lesser frequency (e.g., daily or weekly), images of the shelf facings are sent to a labeling service (operation 2352) for processing in order to update the regions of interest (operation 2357). Once the regions of interest are labeled, the labels can be pushed back to a local region of interest database to update the regions of interest within the database in operation 2353.

The pipeline for detecting out of stock regions of interest further includes a multi-stage process, including image capture, occlusion detection and image factoring, empty facing analysis, and out of stock detection. The image capture stage further includes the capturing of a sequence of still images from each camera. The still images in the sequence are spaced from one another at a regular interval, such as 1 second, 3 seconds, or 5 seconds. Next, during the occlusion detection and image factoring stage, each of the captured images is processed for occlusion (e.g., subjects blocking view of the shelf) and factored (e.g., occlusions are patched to produce a clean image of the shelf facings with humans and other occlusions removed from the scene). During the empty facing analysis stage, a local empty detection model is run for each region of interest in the local region of interest database. The local empty detection model is configured to detect the presence of expected SKUs at each region of interest to detect empty facing regions of interest. In some implementations, the image capture stage further includes capturing images of takes and puts (e.g., triggered by motion) and during a later analysis stage, estimated quantities of an inventory item remaining on a shelf are detected. For each unique SKU in the local region of interest database, the SKU is determined to be out of stock if each region of interest assigned to the SKU is detected to be empty facing in the out of stock detection stage.

FIG. 23D is a block diagram for example on-premise software architecture configured to perform operations associated with the multi-stage out of stock detection process. The on-premise software architecture includes orchestration/telemetry logics 2371, further including an image capture logic 2372, occlusion detection and factoring logic 2373, an empty facing analysis logic 2374, and out-of-stock detection logic 2375. Image capture logic 2372 is configured to perform operations associated with the above-described image capture stage. Similarly, occlusion detection and factoring logic 2373 is configured to perform operations associated with the occlusion detection and factoring stage, empty facing analysis logic 2374 is configured to perform operations associated with the empty facing analysis stage, and out-of-stock detection logic 2375 is configured to perform operations associated with the out-of-stock detection stage. Additional logics may be included to implement additional stages, such as real-time tracking of SKU stock levels in response to detected takes and puts, and/or delivery of out of stock or low stock notifications. Image capture logic 2372 interacts with the one or more operating camera(s) 2370 for the capturing of the sequence of still images from each camera. Once occlusion detection and factoring logic 2373 finishes factoring the captured images, the factored images are to be stored in a factored image storage 2376. The images can be transmitted from storage 2376 to a region of interest management logic 2378 and further transmitted to a labeling service to receive labeled regions of interest (i.e., operations 2352, 2357, and 2353). The updated and labeled regions of interest are stored within a local database 2377 and further transmitted to empty facing analysis logic 2374 to detect empty facing regions of interest. Next, the out of stock detection logic processes the detected empty facing regions of interest to determine any out of stock SKUs.

FIG. 23E is a schematic diagram of an example physical deployment of the hardware configuration for monitoring, as described with reference to FIGS. 23A-D. The on-premises software architecture is low in complexity, and consequently can be performed by a limited number of cameras (e.g., four or fewer 4K narrow-field-of-view (NFOV) cameras connected via Power over Ethernet (POE) to a sitebox having access to power and an external Internet connection (i.e., the control device of FIG. 23A). In other implementations, cameras may be connected via a wireless network and rely on alternative power sources (e.g., grid or battery) rather than a POE connection. FIG. 23E includes two cameras 2370 connected to a POE appliance 2379 (e.g., a network video recorder (NVR) or Embedded PC). POE Appliance 2379 is connected to the Internet, e.g., via a DHCP assigned IP address. The limited number of hardware components, simplified software architecture, and simplified requirements for placement accuracy of the cameras (camera placement plans described further below) enable support for an efficient, asynchronous installation process such as the process of FIG. 23A. Another example workflow for installation using third party logistics (3PL) is shown in FIG. 23F.

Operations within FIG. 23F performed by a 3PL installer are indicated by boxes with broken line boundaries. The 3PL processes include batch pre-processes 2390 and bill of materials (BOM) assembly 2391. Batch pre-processes 2390 can include server and provisioning operations 2390-1 and camera preparation operations 2390-2. Next, BOM assembly processes 2391 are performed including operations such as the packaging of the BOM 2391-1, generation of the install report 2391-2, and shipping of the BOM 2391-3. Once the shipped package is received on-site, the store scan is performed in an operation 2392, e.g., using an installation app and the camera on a smart phone device. Using the store scan, targeted areas for zoned monitoring (e.g., the tobacco shelves) are identified and a camera placement is generated accordingly in operation 2393. The physical installation process is performed in operation 2394, described in further detail above with reference to FIG. 23A. Initialization and booting of the network/network node are performed in operation 2395 followed by operation 2396 for passing credentials, also described in further detail above with reference to FIG. 23A. Next, networking and node provisioning are performed in operation 2397. Camera orientation is calibrated, including troubleshooting using a live view of the camera POV via the installation app, in operation 2398. Following any additional finalization operations 2399 (e.g., further troubleshooting and location/application specific requirements), the system is fully set-up for operations.

### Computer System Implementing Proximity Events Detection

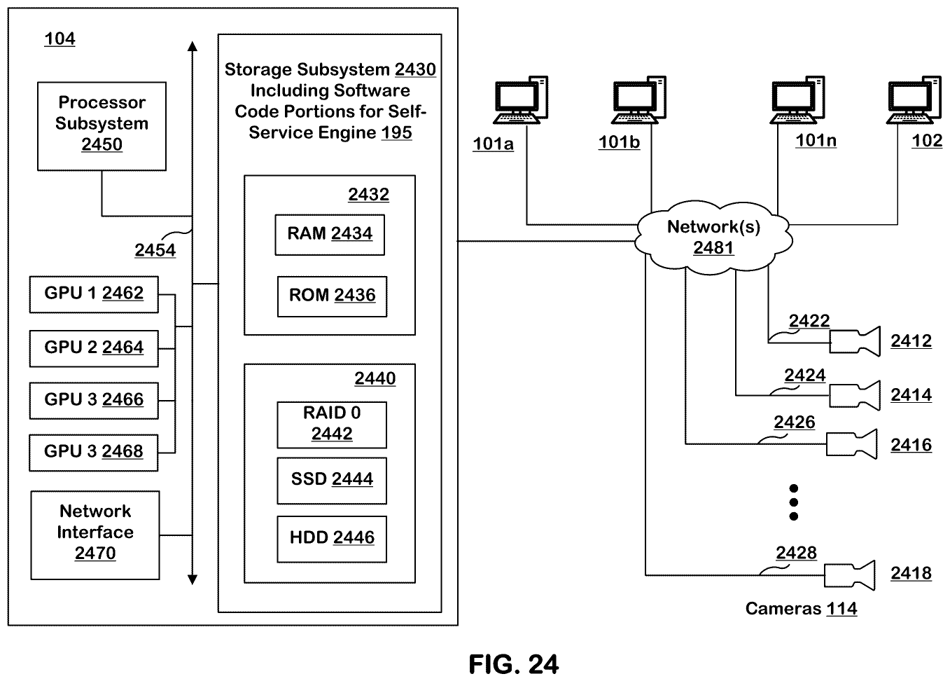

FIG. 24 presents an architecture of a network hosting image recognition engines. The system includes a plurality of network nodes 101a-101n in the illustrated implementation. In such an implementation, the network nodes are also referred to as processing platforms. Processing platforms 101a-101n and cameras 2412, 2414, 2416 . . . 2418 are connected to the network(s) 2481. FIG. 24 shows a plurality of cameras 2412, 2414, 2416 . . . 2418 connected to the network(s). A large number of cameras can be deployed in particular systems. In one implementation, the cameras 2412 to 2418 are connected to the network(s) 2481 using Ethernet-based connectors 2422, 2424, 2426, and 2428, respectively. In such an implementation, the Ethernet-based connectors have a data transfer speed of 1 gigabit per second, also referred to as Gigabit Ethernet. It is understood that in other implementations, the cameras 114 are connected to the network using other types of network connections which can have faster or slower data transfer rates than Gigabit Ethernet. Also, in alternative implementations, a set of cameras can be connected directly to each processing platform, and the processing platforms can be coupled to a network.

The storage subsystem 2430 stores the basic programming and data constructs that provide the functionality of certain implementations of the present invention. For example, the various modules implementing the functionality of the self-service engine 195 may be stored in the storage subsystem 2430. The storage subsystem 2430 is an example of a computer readable memory comprising a non-transitory data storage medium, having computer instructions stored in the memory executable by a computer to perform all or any combinations of the data processing and image processing functions described herein, including logic to identify changes in the real space, to track subjects, to detect puts and takes of inventory items, and to detect the hand off of inventory items from one subject to another in an area of real space by processes as described herein. In other examples, the computer instructions can be stored in other types of memory, including portable memory, that comprise a non-transitory data storage medium or media, readable by a computer. These software modules are generally executed by a processor subsystem 2450. The processor subsystem 2450 can include sequential instruction processors such as CPUs and GPUs, data flow instruction processors, such as FPGAs configured by instructions in the form of bit files, dedicated logic circuits supporting some or all of the functions of the processor subsystem, and combinations of one or more of these components. The processor subsystem may include cloud-based processors in some implementations.

A host memory subsystem 2432 typically includes a number of memories including a main random access memory (RAM) 2434 for the storage of instructions and data during program execution and a read-only memory (ROM) 2436 in which fixed instructions are stored. In one implementation, the RAM 2434 is used as a buffer for storing video streams from the cameras 114 connected to the platform 101a. A file storage subsystem 2440 provides persistent storage for program and data files. In an example implementation, the storage subsystem 2440 includes four 120 Gigabyte (GB) solid state disks (SSD) in a RAID 0 2442 (redundant array of independent disks) arrangement. In the example implementation, in which a CNN is used to identify joints of subjects, the RAID 0 2442 is used to store training data. During training, the training data which is not in the RAM 2434 is read from the RAID 0 2442. Similarly, when images are being recorded for training purposes, the data which are not in the RAM 2434 are stored in the RAID 0 2442. In the example implementation, the hard disk drive (HDD) 2446 is a 10 terabyte storage. It is slower in access speed than the RAID 0 2442 storage. The solid state disk (SSD) 2444 contains the operating system and related files for the image recognition engine 112a.

In an example configuration, three cameras 2412, 2414, and 2416, are connected to the processing platform 101a. Each camera has a dedicated graphics processing unit GPU 1 2462, GPU 2 2464, and GPU 3 2466, to process images sent by the camera. It is understood that fewer than or more than three cameras can be connected per processing platform. Accordingly, fewer or more GPUs are configured in the network node so that each camera has a dedicated GPU for processing the image frames received from the camera. The processor subsystem 2450, the storage subsystem 2430 and the GPUs 2462, 2464, and 2466 communicate using the bus subsystem 2454. Some implementations of the technology disclosed involve “appliance-grade” hardware that is CPU-only, rather than relying on both CPUs and GPUs for computing. A number of peripheral devices such as a network interface 2470 subsystem, user interface output devices, and user interface input devices are also connected to the bus subsystem 2454 forming part of the processing platform 101a. These subsystems and devices are intentionally not shown in FIG. 24 to improve the clarity of the description. Although the bus subsystem 2454 is shown schematically as a single bus, alternative implementations of the bus subsystem may use multiple busses. In one implementation, the cameras 2412 can be implemented using Chameleon3 1.3 MP Color USB3 Vision (Sony ICX445), having a resolution of 1288×964, a frame rate of 30 FPS, and at 1.3 MegaPixels per image, with a Varifocal Lens having a working distance (mm) of 300-x, and a field of view with a ⅓″ sensor of 98.2°-24.8°.

### System Overview: Age Verification of Subjects

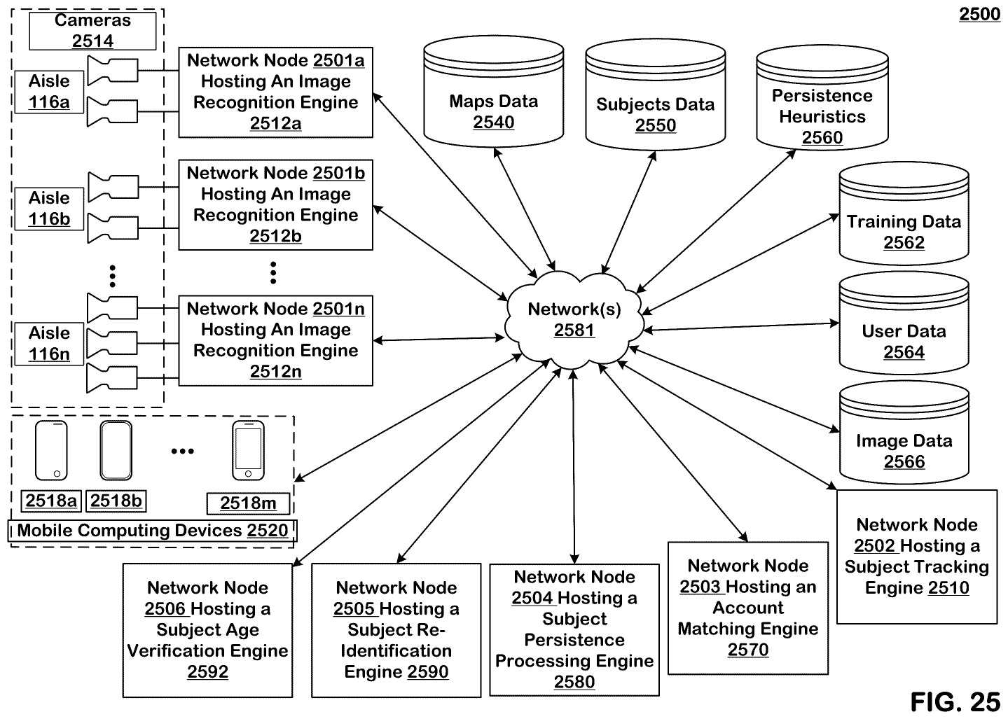

A system and various implementations of the monitoring environment are described with reference to FIGS. 25-33. Certain system and processes are described with reference to FIG. 25, an architectural level schematic of a system in accordance with an implementation. Because FIG. 25 is an architectural diagram, certain details are omitted to improve the clarity of the description. The system 2500 is substantially similar to the system 100 and the description above with reference to system 100 of FIG. 1 overlaps with the system 2500 and the corresponding components. Shared descriptions of overlapping components are omitted for the sake of redundancy; rather, analogous components between systems 100, 2500 will be summarized. Cameras 114 of system 100 are analogous to cameras 2514 of system 2500. Network 181 of system 100 is analogous to network 2581 of system 2500. Network nodes 101a, 101b, 101n, respectively hosting image recognition engines 112a, 112b, and 112n, of system 100 are analogous to network nodes 2501a, 2501b, 2501n, respectively hosting image recognition engines 2512a, 2512b, 2512n, of system 2500. Network node 102, hosting the tracking engine 110, of system 100 is analogous to network node 2502, hosting the tracking engine 2510, of system 2500. The subject database 140 of system 100 is analogous to the subject database 2540 of system 2500. For all analogous components of respective systems 100, 2500, it is to be understood that descriptions of system 100 translate accordingly to system 2500. Moreover, for all components that are only represented within one of systems 100, 2500, but not the other, such components may be implemented within the other system in various alternative implementations (e.g., system 2500 may comprise proximity events database 160, or system 100 may comprise training data database 2562). Descriptions enumerating various combinations of overlapping and non-overlapping components of systems 100, 2500 are not listed at length for clarity and conciseness.

In contrast to system 100, system 2500 also comprises a maps database 2540, a persistence heuristic database 160, a training data database 2562, a user data database 2564, an image data database 2566, mobile computing devices 2520, a network node 2503 hosting an account matching engine 2570, a network node 2504 hosting a subject persistence processing engine 2580, a network node 2505 hosting a subject re-identification engine 2590, and a network node 2506 hosting a subject age verification engine 2592. The respective network nodes can host only one engine, or several engines as described herein. The depicted mobile computing devices 2520, further comprise a mobile computing device 2518a, a mobile computing device 2518b, and a mobile computing device 2518m. The system 2500 can also include a feature descriptor and keypoints database (not shown in FIG. 25) and a camera coverage maps database (not shown in FIG. 25). The system 2500 can also include other databases such as a layout database, an inventory database, a catalog database, a joints heuristics database, and other supporting data. The system 2500 can include additional processing engines such as a camera placement engine or a cart injection engine, or an ultra-wideband communication (UWB) logic (not illustrated).

In many implementations, each image recognition engine 2512a, 2512b, and 2512n is implemented as a deep learning algorithm such as a CNN trained using the training database 2562. In an implementation described herein, image recognition of subjects in the real space is based on identifying and grouping joints recognizable in the images, where the groups of joints can be attributed to an individual subject. For this joints-based analysis, the training database 2562 has a large collection of images for each of the different types of joints for subjects. In the example implementation of a store, the subjects are the customers moving in the aisles between the shelves. In an example implementation, during training of the CNN, the system 2500 is referred to as a “training system”. After training the CNN using the training database, the CNN is switched to production mode to process images of customers in the store in real time. In an example implementation, during production, the system 2500 is referred to as a runtime system (also referred to as an inference system). The CNN in each image recognition engine produces arrays of joints data structures for images in its respective stream of images. In an implementation as described herein, an array of joints data structures is produced for each processed image, so that each image recognition engine 2512a-2512n produces an output stream of arrays of joints data structures. These arrays of joints data structures from cameras having overlapping fields of view are further processed to form groups of joints, and to identify such groups of joints as subjects. The cameras 2514 are calibrated before switching the CNN to production mode. The technology disclosed can include a calibrator that includes a logic to calibrate the cameras and stores the calibration data in a calibration database.

The tracking engine 2510, hosted on the network node 2502, receives continuous streams of arrays of joints data structures for the subjects from image recognition engines 2512a-112n. The tracking engine 2510 processes the arrays of joints data structures and translates the coordinates of the elements in the arrays of joints data structures corresponding to images in different sequences into candidate joints having coordinates in the real space. For each set of synchronized images, the combination of candidate joints identified throughout the real space can be considered, for the purposes of analogy, to be like a galaxy of candidate joints. For each succeeding point in time, movement of the candidate joints is recorded so that the galaxy changes over time. The output of the tracking engine 2510 is stored in the subject database 2540.

The tracking engine 2510 uses logic to identify groups or sets of candidate joints having coordinates in real space as subjects in the real space. For the purposes of analogy, each set of candidate joints is like a constellation of candidate joints at each point in time. The constellations of candidate joints can move over time. The logic to identify sets of candidate joints comprises heuristic functions based on physical relationships amongst joints of subjects in real space. These heuristic functions are used to identify sets of candidate joints as subjects. The heuristic functions are stored in the heuristics database 2560. The output of the subject tracking engine 2510 is stored in the subject database 2550. Thus, the sets of candidate joints comprise individual candidate joints that have relationships according to the heuristic parameters with other individual candidate joints and subsets of candidate joints in a given set that has been identified, or can be identified, as an individual subject.

The technology disclosed includes logic to detect a same event in the area of real space using multiple parallel image processing pipelines or subsystems or procedures. These redundant event detection subsystems provide robust event detection and increase the confidence detection of puts and takes by matching events in multiple event streams. The system can then fuse events from multiple event streams using a weighted combination of items classified in event streams. In case one image processing pipeline cannot detect an event, the system can use the results from other image processing pipelines to update the log data structure of the shoppers. These events of puts and takes in the area of real space can be referred to as “inventory events”. An inventory event can include information about the source and sink, classification of the item, a timestamp, a frame identifier, and a location in three dimensions in the area of real space. The multiple streams of inventory events can include a stream of location based-events, a stream of region proposals-based events, and a stream of semantic diffing-based events. Details of the system architecture are provided, including the machine learning models, system components, and processing operations in the three image processing pipelines, respectively producing the three event streams. Logic to fuse the events in a plurality of event streams is also described.

In one implementation, the one or more operations of the self-service store such as subject identification, subject tracking, subject re-identification (RE-ID), pose detection and/or inventory event detection (or action detection) can be performed locally at the location of the cashier-less store without sending the images/videos to a server such as a cloud-based server. In one implementation, the one or more operations of the cashier-less store, listed above, can be performed per camera (or per sensor) or per subset of cameras (or per subset of sensors). For example, in such an implementation, the camera can include processing logic to process images captured by the camera to detect a pose of the subject or re-identify a subject that was missing in one or more previous subject identification time intervals. Similarly, in such an implementation, action detection techniques can be delegated to the camera such that inventory events are detected per camera.

The technology disclosed presents a method for verifying the age of subjects to support a cashier-less store with an autonomous checkout for age-restricted items. The disclosed method can be used to store a verified age attribute in association with a subject account, allowing for future instances of the subject performing self-service check out within the cashier-less store with age-restricted items without the need to re-verify age. For example, the technology disclosed can be used to verify that the subject is over the age of twenty-one, assign access rights for the subject to pick out alcoholic beverages within a cashier-less store, associate the authorization with an authentication factor, and in response to receiving the authentication factor, validate the identity of the subject and enable the client application to successfully update the shopper's cart with an alcoholic product without requiring assistance from an outside entity, such as a customer service representative within the cashier-less shopping environment.

In many implementations of system 2500, the cashier-less store inventory comprises items with age-restrictions, such as items that a subject must legally be over eighteen years old to purchase (e.g., certain over-the-counter medications or lottery tickets) or over twenty-one years old to purchase (e.g., alcohol or tobacco products). In certain implementations, these age-restricted products are located within a display or store area that is not accessible to the subject without assistance from an employee or customer service representative (CSR) to perform age verification through a documentation review, such as checking the driver's license of the subject. In other implementations, these age-restricted products are accessible for the subject to pick up, but an interaction of the subject with the age-restricted product triggers a flag in the system, communicated to both the subject via the client application on the shopper mobile device and a CSR, or other trusted source or authority figure, via the client application on a store device. The flag states that the subject is attempting to take an age-restricted item and must request assistance from a CSR for age verification through documentation review to proceed. In the event that the documentation review is not performed, checkout will not be allowed and further consequences may follow.

Within certain implementations, the disclosed method comprises a method for long-term age verification that can be accessible across a plurality of shopping trips. The subject age verification engine 2592 further comprises components configured for the confirmation and storage of an age and identity of the subject to be associated with the subject account (as well as any access privileges for particular age-restricted functions that the subject is of a legal age to perform). An age-restricted function is defined as any interaction between a subject and a product, wherein the product is a good or service that is associated with a minimum age to interact with the product. Age-restricted functions can include the purchase of a good, the purchase of a service, the viewing of a performance, the registration for an activity, or the entry to an establishment or sublocation of an establishment. The subject age verification engine 2592 also comprises components configured to check, in response to the subject performing an age-restricted function (e.g., picking up a bottle of alcohol from a shelf and placing the bottle in their physical shopping cart), if an age verification process has successfully been completed previously. If the age verification has not been successfully completed, the subject will be notified that age verification is necessary, and that age verification may be stored to by-pass manual documentation review in future trips by associating their age with an authentication factor that may be used to identify the subject. If the age verification has been successfully completed, the subject will be prompted to input an authentication factor, such as an inherence factor (e.g., facial recognition or fingerprint input), and following authentication, authorize the subject to autonomously add the alcohol product to their cart.

In one implementation, age verification may be routinely repeated at regular intervals for security and integrity. In another implementation, age verification may be repeated for random shopper interactions for security and integrity. In yet another implementation, subjects may be suspended from using autonomous age verification services if a certain, pre-defined number threshold of failed or fraudulent age verification events have occurred. Many implementations comprise a combination of components within the above described implemented security features to re-verify and monitor autonomous age verification services. Within many of the implementations described herein, age verification comprises mediation by an in-store CSR responsible for reviewing the proof-of-age documentation for the subject and the authentication factor for the subject, as well as providing a confirmation that the authentication factor is initialized by the same subject identified within the proof-of-age documentation. For simplicity, this authentication factor will often be referred to as facial recognition scanning, or simply Face-ID. However, it is to be understood that this is one of many authentication factors that may be implemented within the technology disclosed and a user skilled in the art will recognize the range of alternative authentication factors, as well as the manner in which alternative authentication factors can be implemented without departing from the spirit or scope of the technology disclosed.

The authentication factor input from the subject for identity verification purposes can be, in certain implementations, a knowledge factor. The knowledge factor can be a passcode, a password, a personal identification number, a security image, and so on. In other implementations, the authentication factor can be a possession factor. The possession factor can be a badge, a physical keystore, a wristband, a digital pass to be stored upon the subject mobile device (e.g., a pass to be stored in an Apple™ iPhone Wallet, wherein the subject unlocks their wallet using Face-ID to access the pass), and so on. In many implementations, the authentication factor can be an inherence factor that cannot easily be dishonestly used by an individual other than the subject. The inherence factor can be a Face-ID scan, a retinal scan, a voice recognition, a fingerprint scan, or another biometric input. Certain implementations further comprise multi-factor authentication, requiring a combination of two or more authentication factors. The aforementioned scenario comprising a mobile wallet pass, for example, involves a first authentication factor (Face-ID, an inherence factor) and a second authentication factor (a mobile wallet pass, a possession factor). In the following description, details relating to various techniques and subsystems for setup and operations of the subject age verification method are described. First, techniques and subsystems configured to identify and track subjects, store items, and interactions between the subjects are store items are elaborated upon. Next, the access management system associated with initial verification of the subject age to allow cashier-less shopping for age-restricted items or services is introduced. Within the access management system, techniques for implementing authentication and authorization in response to subject access requests are also described. Next, an example interface associated with the disclosed age verification method is presented.

### Computer System for the Implementation of a Subject Re-Identification Engine

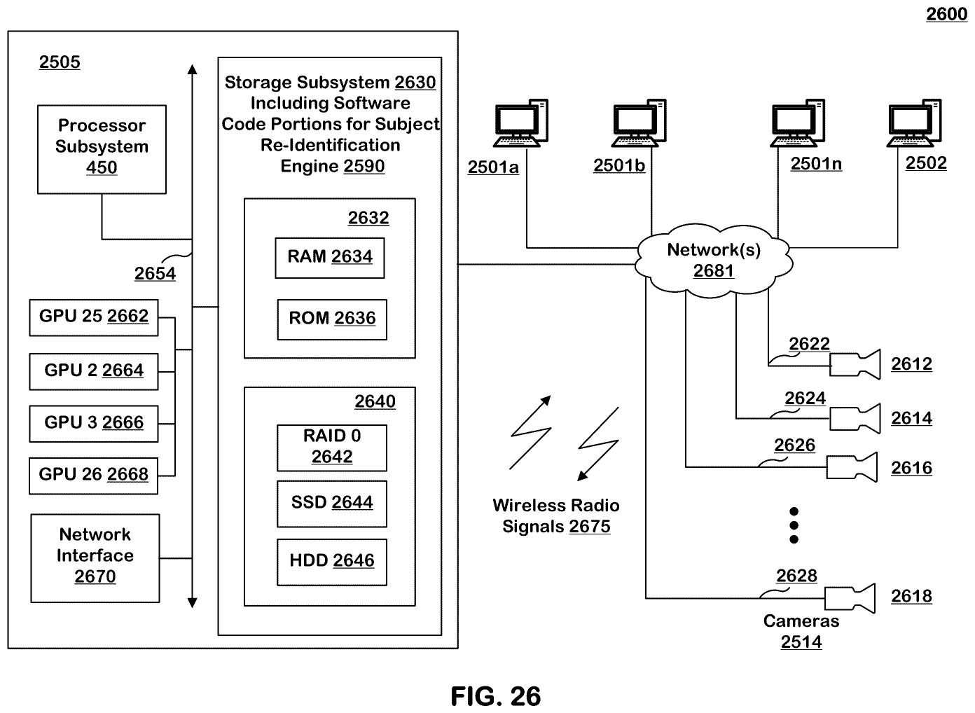

FIG. 26 is a camera and computer hardware arrangement configured for hosting the subject re-identification engine of FIG. 25. FIG. 26 further presents architecture of a network hosting the subject re-identification engine 190 which is hosted on the network node 2505. The system includes a plurality of network nodes 2501a, 2501b, 2501n, and 2502 in the illustrated implementation. In such an implementation, the network nodes are also referred to as processing platforms. Processing platforms (network nodes) 2501a, 2501b, 2501n, 2502, 2503, 2504, and 2505 and cameras 2612, 2614, 2616 . . . 2618 are connected to network(s) 2681. FIG. 26 shows a plurality of cameras 2612, 2614, 2616 . . . 2618 connected to the network(s). A large number of cameras can be deployed in particular systems. In one implementation, the cameras 2612 to 2618 are connected to the network(s) 2681 using Ethernet-based connectors 2622, 2624, 2626, and 2628, respectively. In such an implementation, the Ethernet-based connectors have a data transfer speed of 1 gigabit per second, also referred to as Gigabit Ethernet. It is understood that in other implementations, cameras 2514 are connected to the network using other types of network connections which can have a faster or slower data transfer rate than Gigabit Ethernet. Also, in alternative implementations, a set of cameras can be connected directly to each processing platform, and the processing platforms can be coupled to a network.

Storage subsystem 2630 stores the basic programming and data constructs that provide the functionality of certain implementations of the technology disclosed. For example, the various modules implementing the functionality of the subject re-identification engine 2590 may be stored in storage subsystem 2630. The storage subsystem 2630 is an example of a computer readable memory comprising a non-transitory data storage medium, having computer instructions stored in the memory executable by a computer to perform all or any combination of the data processing and image processing functions described herein including logic to detect tracking errors and logic to re-identify subjects with incorrect track_IDs, logic to link subjects in an area of real space with a user account, to determine locations of tracked subjects represented in the images, match the tracked subjects with user accounts by identifying locations of mobile computing devices executing client applications in the area of real space by processes as described herein, as well as age-restricted function access management and verification as described herein. In other examples, the computer instructions can be stored in other types of memory, including portable memory, that comprise a non-transitory data storage medium or media, readable by a computer.

These software modules are generally executed by a processor subsystem 2650. A host memory subsystem 2632 typically includes a number of memories including a main random access memory (RAM) 2634 for storage of instructions and data during program execution and a read-only memory (ROM) 2636 in which fixed instructions are stored. In one implementation, the RAM 2634 is used as a buffer for storing re-identification vectors generated by the subject re-identification engine 2590. A file storage subsystem 2640 provides persistent storage for program and data files. In an example implementation, the storage subsystem 2640 includes four 2520 Gigabyte (GB) solid state disks (SSD) in a RAID 0 (redundant array of independent disks) arrangement identified by a numeral 2642. In the example implementation, maps data in the maps database 2540, subjects data in the subjects database 150, heuristics in the persistence heuristics database 2560, training data in the training database 2562, account data in the user database 2564 and image/video data in the image database 2566 which is not in RAM, is stored in RAID 0. In the example implementation, the hard disk drive (HDD) 2646 is slower in access speed than the RAID 0 2642 storage. The solid state disk (SSD) 2644 contains the operating system and related files for the subject re-identification engine 2590.

In an example configuration, four cameras 2612, 2614, 2616, 2618, are connected to the processing platform (network node) 2503. Each camera has a dedicated graphics processing unit GPU 1 2662, GPU 2 2664, GPU 3 2666, and GPU 4 2668, to process images sent by the camera. It is understood that fewer than or more than three cameras can be connected per processing platform. Accordingly, fewer or more GPUs are configured in the network node so that each camera has a dedicated GPU for processing the image frames received from the camera. The processor subsystem 2650, the storage subsystem 2630 and the GPUs 2662, 2664, and 2666 communicate using the bus subsystem 2654.

A network interface subsystem 2670 is connected to the bus subsystem 2654 forming part of the processing platform (network node) 2504. Network interface subsystem 2670 provides an interface to outside networks, including an interface to corresponding interface devices in other computer systems. The network interface subsystem 2670 allows the processing platform to communicate over the network either by using cables (or wires) or wirelessly. The wireless radio signals 2675 emitted by the mobile computing devices 2520 in the area of real space are received (via the wireless access points) by the network interface subsystem 2670 for processing by the account matching engine 2570. A number of peripheral devices such as user interface output devices and user interface input devices are also connected to the bus subsystem 2654 forming part of the processing platform (network node) 2504. These subsystems and devices are intentionally not shown in FIG. 26 to improve the clarity of the description. Although bus subsystem 2654 is shown schematically as a single bus, alternative implementations of the bus subsystem may use multiple busses. In one implementation, the cameras 2514 can be implemented using Chameleon3 1.3 MP Color USB3 Vision (Sony ICX445), having a resolution of 1288×964, a frame rate of 30 FPS, and at 1.3 MegaPixels per image, with Varifocal Lens having a working distance (mm) of 300-x, a field of view field of view with a ⅓″ sensor of 98.2°-23.8°. The cameras 2514 can be any of Pan-Tilt-Zoom cameras, 360-degree cameras, and/or combinations thereof that can be installed in the real space.

### Subject Identification Analysis

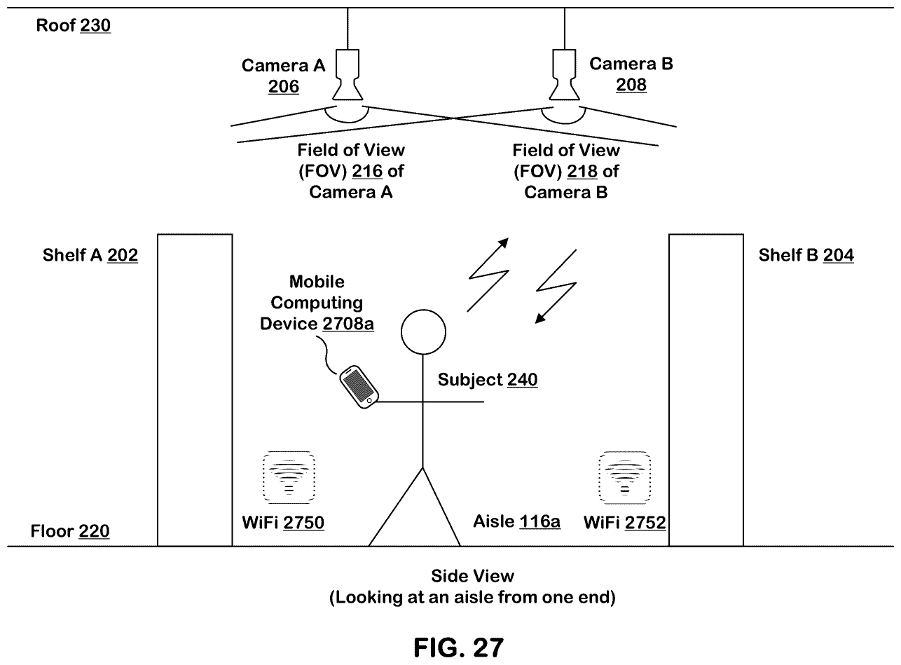

Within certain implementations of the technology disclosed, the technology disclosed links located subjects in the current identification interval to tracked subjects in preceding identification intervals by performing subject persistence analysis. In the case of a cashier-less store the subjects move in the aisles and open spaces of the store and take items from shelves. The technology disclosed associates the items taken by tracked subjects to their respective shopping cart or log data structures. The technology disclosed uses one of the following check-in techniques to identify tracked subjects and match them to their respective user accounts. The user accounts have information such as preferred payment method for the identified subject. The technology disclosed can automatically charge the preferred payment method in the user account in response to identified subject leaving the store. In one implementation, the technology disclosed compares located subjects in current identification interval to tracked subjects in previous identification intervals in addition to comparing located subjects in current identification interval to identified (or checked in) subjects (linked to user accounts) in previous identification intervals. In another implementation, the technology disclosed compares located subjects in current identification interval to tracked subjects in previous intervals in alternative to comparing located subjects in current identification interval to identified (or tracked and checked-in) subjects (linked to user accounts) in previous identification intervals. FIG. 27 is a side view of an aisle in a store illustrating a subject with a mobile computing device and a camera arrangement.

In a store, the shelves and other inventory display structures can be arranged in a variety of manners, such as along the walls of the store, or in rows forming aisles or a combination of the two arrangements. FIG. 27 comprises an arrangement of shelves, forming an aisle 116a, viewed from one end of the aisle 116a. Two cameras, camera A 206 and camera B 208 are positioned over the aisle 116a at a predetermined distance from a roof 230 and a floor 220 of the store above the inventory display structures, such as shelves. The cameras 2514 comprise cameras disposed over and having fields of view encompassing respective parts of the inventory display structures and floor area in the real space. The coordinates in real space of members of a set of candidate joints, located as a subject, identify locations of the subject in the floor area. In FIG. 27, the subject 240 is holding the mobile computing device 2708a and standing on the floor 220 in the aisle 116a. The mobile computing device can send and receive signals through the wireless network(s) 2581. In one example, the mobile computing devices 2520 communicate through a wireless network using for example a Wi-Fi protocol, or other wireless protocols like Bluetooth, UWB, and ZigBee, through wireless access points (WAP) 2750 and 2752.

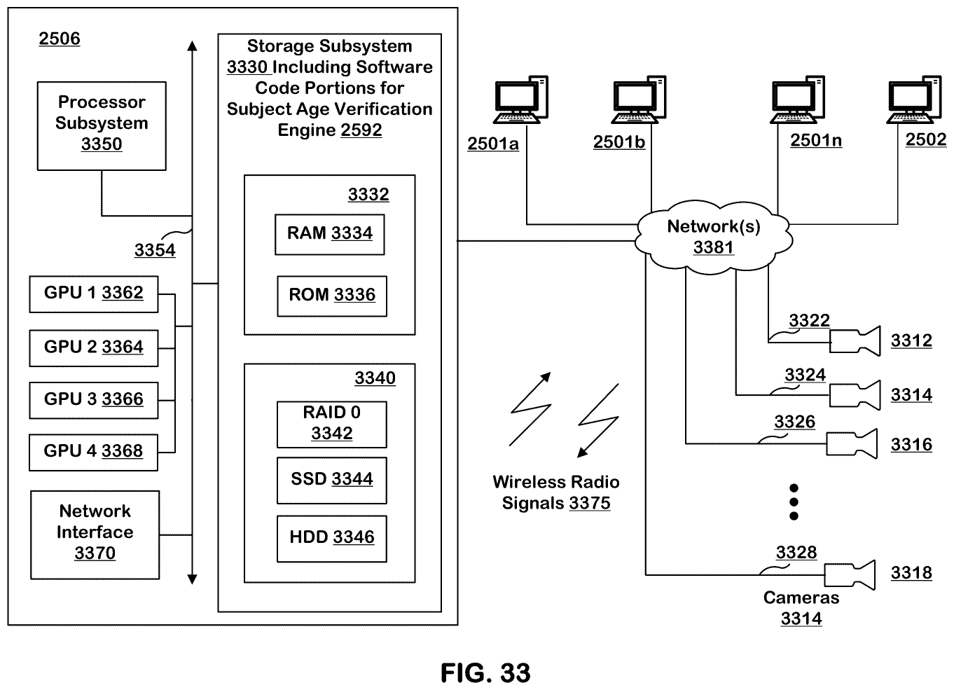

In the example implementation of the store, the real space can include all of the floor 220 in the store from which inventory can be accessed. Cameras 2514 are placed and oriented such that areas of the floor 220 and shelves can be seen by at least two cameras. The cameras 2514 also cover at least part of the shelves 202 and 204 and floor space in front of the shelves 202 and 204. Camera angles are selected to have both steep perspective, straight down, and angled perspectives that give more full body images of the customers. In one example implementation, the cameras 2514 are configured at an eight (8) foot height or higher throughout the store. In FIG. 33, the cameras 206 and 208 have overlapping fields of view, covering the space between a shelf A 202 and a shelf B 204 with overlapping fields of view 216 and 218, respectively. A location in the real space is represented as a (x, y, z) point of the real space coordinate system. “x” and “y” represent positions on a 2D plane which can be the floor 220 of the store. The value “z” is the height of the point above the 2D plane at floor 220 in one configuration.

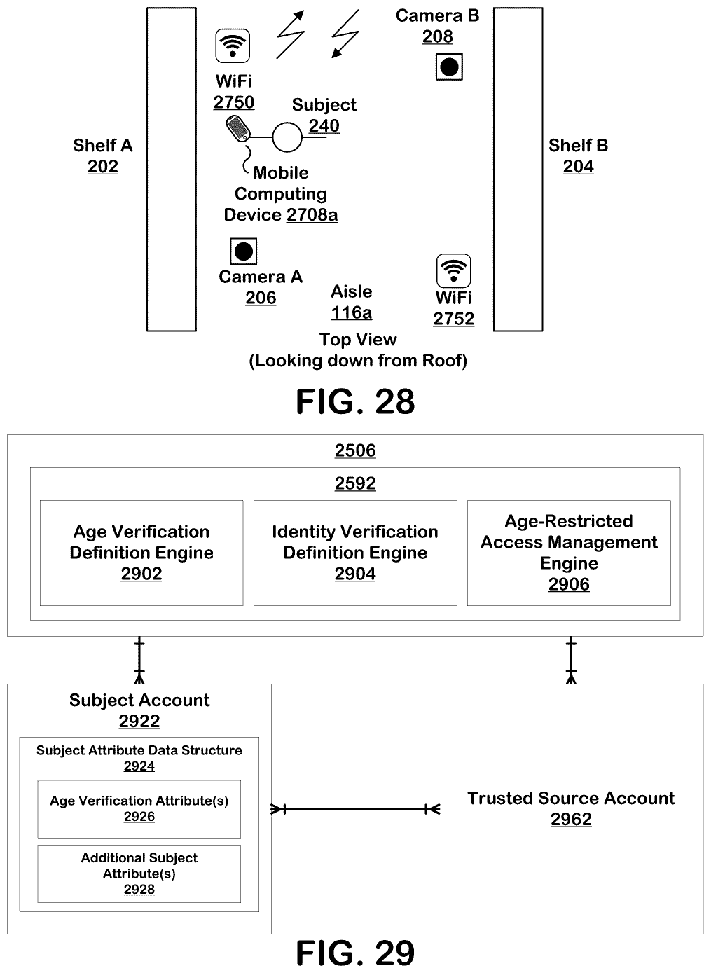

FIG. 28 is a top view of the aisle of FIG. 27 in a store illustrating the subject with the mobile computing device and the camera arrangement. In further detail, FIG. 28 illustrates the aisle 116a viewed from the top of FIG. 27, showing an example arrangement of the positions of cameras 206 and 208 over the aisle 116a. The cameras 206 and 208 are positioned closer to opposite ends of the aisle 116a. The camera A 206 is positioned at a predetermined distance from the shelf A 202 and the camera B 208 is positioned at a predetermined distance from the shelf B 204. In another implementation, in which more than two cameras are positioned over an aisle, the cameras are positioned at equal distances from each other. In such an implementation, two cameras are positioned close to the opposite ends and a third camera is positioned in the middle of the aisle. It is understood that a number of different camera arrangements are possible.

The disclosed age verification method allows for an initial age verification process wherein the age verification determination is stored in association with the subject account, by-passing further age verification in succeeding shopping trips. While many implementations may further comprise re-verification of the age of the shopper at random or regularly-spaced intervals, the disclosed age verification method enables shoppers to independently perform subsequent age verification during a plurality of succeeding trips to cashier-less shopping environments associated with the client application for which the subject account has completed age verification. Hence, the disclosed age verification method further allows for self-service checkout following the self-service age verification, such that the remainder of the autonomous shopping method remains similar to the previously described method of subject tracking above.

### Age Verification Engine Entity Relationships

FIG. 29 is an entity-relationship diagram describing the relationship between entities interacting with the subject age verification engine of FIG. 25. First, the entities constituting FIG. 29 will be presented. Next, the relationships between the entities will be further described. FIG. 29 illustrates the network node 2506, which includes the subject age verification engine 2592, as well as a subject account 2922 and a trusted source account 2962. The subject age verification engine 2592 further comprises a plurality of subcomponents: an age verification definition engine 2902, an identity verification definition engine 2904, and an age-restricted access management engine 2906.

The age verification definition engine 2902 is configured to verify the age (or other data associated with the age) of a subject using various age-related attributes associated with the subject. Specifically, the age verification definition engine 2902 is configured to manage the receival, definition, storage, and/or transmission of data associated with the age verification for a subject, wherein the subject is associated with subject account 2922. The age verification definition engine 2902 receives, establishes, or processes at least one definition of one or more age verification attributes 2926 within the subject attribute data structure 2924. Transmission of a definition for an age verification attribute 2926, comprising a biological age of the subject, a date of birth of the subject, and/or a binary variable indicating whether the subject exceeds the pre-defined age threshold required to access the age-restricted function, may be performed by a trusted source such as a CSR, regulatory authority, or a computational system such as a neural network associated with the client application, system 2500, or a regulatory authority. In some implementations, an age verification attribute 2926 is an age descriptor that includes one or more pieces of information indicating the age of the subject. In other implementations, an age verification attribute 2926 is an age verification confirmation attribute that includes one or more pieces of information corresponding to the confirmation of the age of the subject, such as an indicator of whether or not the age verification process has been confirmed by a trusted source, or an indicator of whether or not the subject is enabled to access a particular age-restricted product.

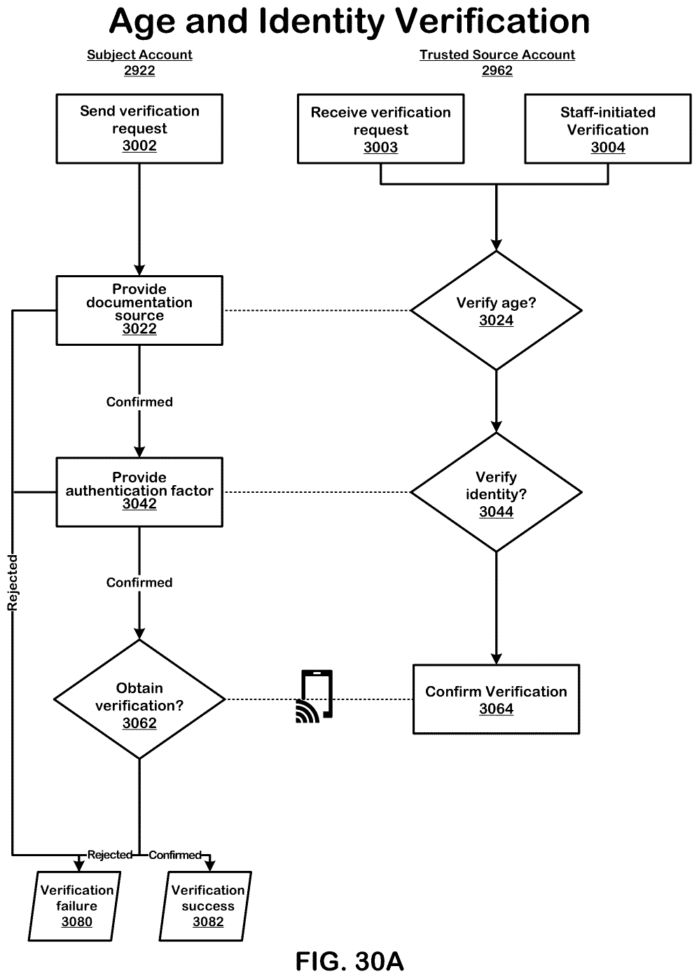

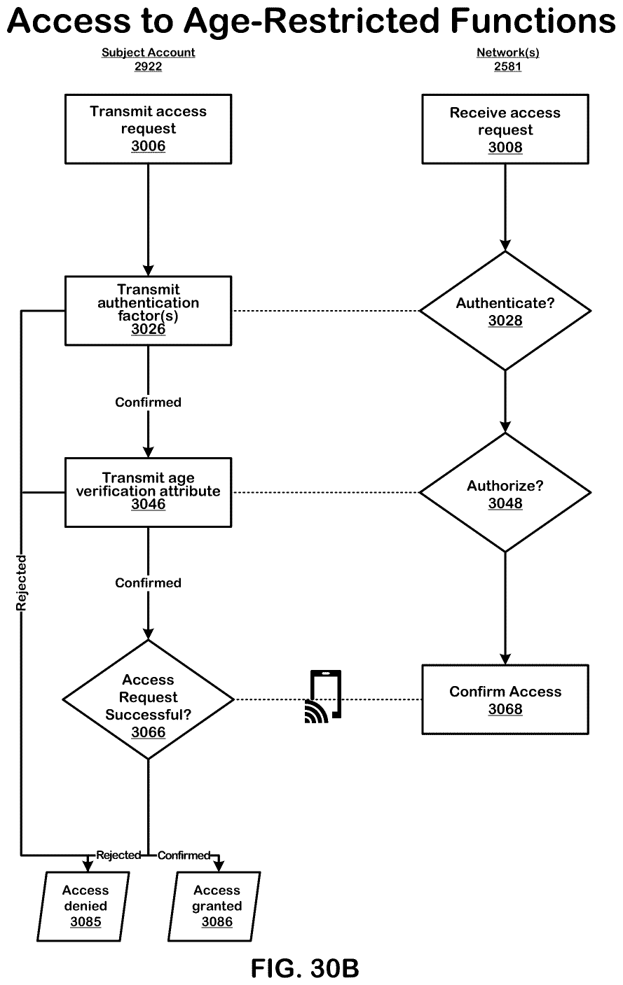

The age verification definition engine 2902, the operations of which are further expanded upon in FIG. 30A, defines or receives a definition of an age verification attribute 2926 in response to the review of a documentation source indicating the date of birth, or present age, of the subject. The documentation source may be a driver's license, passport, state identification card, and/or birth certificate, that can be further validated by a government or regulatory agency authority. In certain implementations, a plurality of documentation sources may be reviewed to verify the age of the subject. Additionally, certain implementations comprise the definition of a plurality of age verification attributes 2926, wherein a first age verification attribute and a second age verification attribute within the plurality of age verification attributes may comprise non-overlapping information (e.g., a date of birth versus a binary variable indicating if the subject is at least twenty-one) or correspond to non-overlapping age-restricted functions (e.g., purchase of tobacco versus purchase of regulated over-the-counter medicine).

The identity verification definition engine 2904 is configured to verify the identity (or other data associated with the identity) of a subject using various identity-related attributes associated with the subject. Specifically, the identity verification definition engine 2904 is configured to manage the receival, definition, storage, and/or transmission of data associated with the identity verification for a subject, wherein the subject is associated with subject account 2922. The identity verification definition engine 2904 is configured to receive, establish, or process at least one definition of one or more authentication factors associated with the subject account 2922 or subject attribute data structure 2924.

Transmission of a definition for an authentication factor, comprising a knowledge factor, a possession factor, and/or an inherence factor, may be performed by a trusted source such as a CSR, regulatory authority, or a computational system such as a neural network associated with the client application, system 2500, or a regulatory authority. A knowledge factor may contain information that the subject knows and may use as a form of identity verification, such as a password/passphrase or a security question. A possession factor is an entity held or owned by the subject such as a physical key, security badge, or an authentication token-generating software such as mobile authentication applications. An inherence factor is a characteristic inherently unique to the subject such as a biometric reading (e.g., facial structure scan, retinal scan, or fingerprint scan).

The identity verification definition engine 2904, the operations of which are further expanded upon in FIG. 30A, defines or receives the definition of at least one authentication factor to be stored in association with the subject account 2922, wherein a trusted source such as a CSR, regulatory authority, or a computational system such as a neural network associated with the client application, system 2500, or a regulatory authority has confirmed a connection between the authentication factor and the subject. The connection between the authentication factor and the subject is further defined as a proven relationship, as endorsed by the trusted source, between the authentication factor and the subject wherein the trusted source has confirmed that the subject associated with the subject account was responsible for the creation of the authentication factor. In certain implementations, a plurality of authentication factors may be defined and linked to the subject account 2922.

Additionally, certain implementations comprise the definition of non-overlapping authentication protocols for non-overlapping age-restricted functions, non-overlapping subject accounts, or non-overlapping instances of access requests to age-restricted functions. In a first example implementation, a first age-restricted function requires two-factor authentication comprising an inherence factor and a knowledge factor, whereas a second age-restricted function requires single-factor authentication comprising an inherence factor. In a second example implementation, a first subject account associated with a first subject is required to input two-factor authentication comprising an inherence factor and a knowledge factor for a third age-restricted function, whereas a second subject account associated with a second subject is required to input single-factor authentication comprising an inherence factor. Within the two example implementations, the differing authentication protocols may be due to differences in local laws and regulations, store policies, or data associated with the age-restricted function and/or the subject accounts (e.g., how recently a respective subject has performed age verification for a respective age-restricted function).

The age-restricted access management engine 2906 is configured to manage the access delegation, authentication, and authorization to age-restricted functions corresponding to the subject account 2922. Access delegation performed by the age-restricted access management engine 2906 further comprises a determination of appropriate access privileges for the subject account 2922 in view of the age verification attribute(s) 2926 associated with the subject account 2922. For example, one or more age verification attribute(s) 2926 associated with a subject account, such as a date of birth, a present age, and/or a binary variable indicating if the subject meets a specific pre-defined age threshold (e.g., a binary variable that can be set to indicate that the subject is under the age of twenty-one, or that the subject is twenty-one or older), may be processed to generate an access privilege delegation for the subject account respective to n available age-restricted functions that the subject meets the minimum age requirement for, wherein n is a nonnegative integer.

The age-restricted access management engine 2906 is configured to receive the information used for authentication, such as identifiers for a subject account 2922, age verification attribute(s) 2926, additional subject attribute(s) 2928, and/or data associated with a specific access privilege or function in some implementations. The age-restricted access management engine 2906 may also manage the storage, transmission, and/or logging of any actions associated with the access management system. In many implementations, the age-restricted access management engine 2906 performs the delegation and revocation of access privileges/permissions to the subject account 2922. In the disclosed implementations described, authentication and authorization processes are performed for a subject account 2922 to enable the subject to access certain restricted functions associated with the client application and/or system 2500. Hence, access management transactions such as delegation, revocation, or authorization of access privileges involve the subject account 2922 and are more specifically leveraged by the subject. However, for simplicity, the descriptions of access management and access management-related processes may refer directly to the subject account 2922 without mentioning the subject or refer directly to the subject without mentioning the subject account 2922. A user skilled in the art will recognize the relationship between an individual and an account associated with that individual, as well as the storage and usage of data associated with the subject or subject account 2922.

In certain implementations, the age-restricted access management engine 2906 is also configured to perform authentication for the subject account 2922. Access authentication performed by the age-restricted access management engine 2906 further comprises an authentication of the identity of the subject attempting to access an age-restricted function within the client application. For example, one or more authentication factor(s) associated with a subject account, such as a Face-ID scan, fingerprint scan, or passphrase, may be processed to successfully authenticate the subject identity. Alternatively, if the authentication factor(s) provided to the client application do not match the authentication factor(s) stored in association with the subject account, authentication is unsuccessful, and the age-restricted function access is denied. In some implementations, failed authentication may invoke further downstream effects, such as logging out the subject account from the client application on the mobile device, locking down the subject account, prompting the subject to seek assistance from a CSR, and/or transmitting a flag to a trusted authority or reviewer corresponding to the failed authentication attempt. In certain implementations, the age-restricted access management engine 2906 is also configured to perform authorization for the subject account 2922.

Following successful authentication of the identity of the subject, access authorization may be performed by the age-restricted access management engine 2906. The access authorization further comprises an authorization of the access request by the subject, wherein the access request indicates the subject is attempting to access an age-restricted function within the client application. A subject previously delegated access privileges, as informed by the age verification attribute(s) 2926 will be authorized to perform the age-restricted function. A subject who has not been delegated access privileges to the age-restricted function will be denied access to perform the age-restricted function. In response to a denied access request, or a failed authentication attempt, the subject can request help (either independently, or in response to a notification presented to the subject via the client application) from a CSR in some implementations. For example, a subject, previously verified to be over the age of twenty-one within their associated subject account, picking up a bottle of wine and adding it to their cart invokes an access request to an alcohol purchase function, wherein access is delegated to the subject account 2922 associated with a subject verified to be over the age of twenty-one. Following successful authentication of the identity of the subject (i.e., confirming that a bad actor is not impersonating the subject, leveraging access privileges delegated to the subject account 2922 to purchase the alcohol), the subject will be authorized to purchase alcohol. Accordingly, the bottle of wine will be successfully added to their inventory cache and the subject may proceed with checkout at any time. Alternatively, if the subject has not performed successful age verification, or previous age verification indicates that the subject is under the age of twenty-one, authorization will fail and the subject will not be granted permission to purchase alcohol.

In some implementations, failed authentication or authorization may invoke further downstream effects, such as logging out the subject account 2922 from the client application on the mobile device, locking down the subject account 2922, prompting the subject to seek assistance from a CSR, preventing the subject from performing checkout, suspending or erasing one or more age verification attribute(s) 2926, suspending or revoking one or more age-restricted function access privileges previously delegated to subject account 2922, requiring the age verification process to be repeated, and/or transmitting a flag to a trusted authority or reviewer corresponding to the failed authentication and/or authorization attempt. A flag event, for example, may include alerting a customer service representative or other store employee of the failed authentication and/or authorization attempt. Alternatively, a flag event may include alerting a reviewer to perform a more detailed review process in response to the flag-initiating event. The subject account 2922 further comprises a subject attribute data structure 2924. In the implementation illustrated within FIG. 29, the subject attribute data structure 2924 is stored directly within subject account 2922. In other implementations not shown, the subject attribute data structure 2924 is stored in association with the subject account 2922 in an alternative location, such as a network node or database described within system 2500 or associated with system 100. The subject attribute data structure 2924 further comprises a plurality of subject attributes, comprising the age verification attribute(s) 2926 defined by the subject age verification engine 2592 and one or more additional subject attribute(s) 2928. Additional subject attribute(s) can include subject identifier attribute(s) (e.g., user ID, email address, subject name), subject authentication factor(s) (e.g., account log-in authentication factor(s) and/or access-related authentication factor(s), wherein an account log-in authentication factor and an access-related authentication factor can be overlapping or non-overlapping), subject preference(s), subject order history and digital receipt(s), and additional metadata associated with the subject.

A trusted source account 2962 is also illustrated within FIG. 29. In some implementations, the trusted source account 2962 is respective to one specific entity or individual, such as a store CSR. In other implementations, the trusted source account is a store-wide account respective to a plurality of individuals physically present or otherwise interacting directly with the cashier-less shopping environment. In yet other implementations, the trusted source account 2962 is associated with an external client, supporting and/or partner entity, or trusted authority entity (i.e., a regulatory entity associated with performing age verification checks). Given the broad range of trusted sources that can frequently interact with autonomous age verification methods in various implementations, no further subcomponent data structures are illustrated within the trusted source account 2962 within FIG. 29.

In one example implementation, the trusted source account 2962 is associated with a CSR and the trusted source account 2962 further comprises a CSR attribute data structure storing one or more data attributes associated with the CSR such as access privileges to store inventory, subject data, or certain administrative functions such as confirming age verification or initiating cart injection. In a second example implementation, the trusted source account 2962 is associated with a plurality of in-store CSR, remotely-located administrators, and/or reviewers associated with the client application and the trusted source account 2962 further comprises a store attribute data structure storing one or more data attributes associated with the store such as available functions at a particular store location, access to view or modify store inventory, or certain administrative functions such as confirming age verification or initiating cart injection. A user skilled in the art will recognize that the listed implementations are listed purely as representative examples and should not be considered a limitation of the technology disclosed.

Next, the relational characteristics of the entities illustrated within FIG. 29 will be described further. Further entities, as previously introduced within systems 100, 2500, can interact with the entities listed in FIG. 29, but are not illustrated within FIG. 29 for the sake of clarity. The entities illustrated within FIG. 29, as well as other related entities not shown, can be related via direct relationships or indirect relationships. Indirect relationships are not illustrated for the sake of clarity, but will briefly be discussed. The relationship between a first entity and a second entity (e.g., subject account 2922 and trusted source account 2962) may be further mediated by a network node within system 2500, network(s) 2581, one or more mobile devices used to access one entity, both entities, or additional mediating entities such as network(s) 2581, a client application, one or more endpoint application(s) or cloud-based server(s), or otherwise comprise data transmission via a third alternative entity. Moreover, the functions described respective to a particular entity within FIG. 29 may be invoked, managed, or modified by one or more user(s) interacting with the particular entity.

The association between the subject age verification engine 2592 and the subject account 2922 is a one-to-at least one relationship; hence, in most implementations, a single subject age verification engine 2592 may interact with i subject account(s) 2922, where i is a nonnegative integer. The association between the subject age verification engine 2592 and the trusted source account 2962 is also a one-to-at least one relationship; hence, in most implementations, a single subject age verification engine 2592 may interact with j trusted source account(s) 2962, where j is a nonnegative integer. Next, the association between the subject account 2922 and the trusted source account 2962 is an at least one-to-at least one relationship; hence, in most implementations, k subject account(s) 2922 may interact with m trusted source account(s) 2962, wherein k and m are respective nonnegative integers. In some implementations, relationships between the entities illustrated within FIG. 29 are further limited or characterized by at least one access privilege. For example, the trusted source account 2962 may be delegated access privileges to interact with the age verification definition engine 2902, enabling the trusted source to delegate access privileges. Another trusted source account 2962 may be unable to access the age verification definition engine 2902. For example, certain states or local municipalities require that a store employee be over twenty-one years old to confirm the age of a shopper.

### Age and Identity Verification of Subjects

FIG. 30A is a flow chart describing a method for verifying the age of a subject. First, the disclosed age verification method will be presented from the perspective of a subject account. Next, the disclosed age verification method will be presented from the perspective of a trusted source account, wherein the trusted source is a staff member such as a CSR. Within the described operations of FIGS. 30A and 30B, the performed actions are initiated by the indicated entity (e.g., the shopper/subject, CSR, or an account associated with the subject or CSR) by leveraging the engines previously described within system 2500 and entity-relationship diagram 2900. For clarity, the operations are described from the function of the individual and/or the associated account of the individual initiating the operation and details with regard to the corresponding system engine are omitted. Next, the paired operations corresponding to each respective perspective will be highlighted. The illustrated method within FIG. 30A, from the perspective of the subject account 2922 (FIG. 29), and the subject account 2922 associated with a particular subject, client application, mobile device, and/or cashier-less store. The subject account 2922 begins with an operation 3002 comprising the transmission of a verification request, wherein the verification request may be transmitted directly via local communication to the trusted source account 2962 and/or transmitted indirectly via a subsystem within system 2500 such as network(s) 2581 or an alternative cloud-based server.

Following the initiation of age verification within the operation 3002, age verification begins with an operation 3022, wherein the subject account 2922 is prompted to provide a documentation source, wherein the documentation source may be obtained by the subject or other entity such as a database system. The documentation source is an identification source associated with the subject that provides one or more proof-of-age data attributes indicating the date of birth and/or present age of the subject. The documentation source, in various implementations, may be a state identification card, a passport, a driver's license, a birth certificate, a digital or virtual identification card in compliance with local regulation, or alternative legally-compliant documentation providing evidence of the subject age, wherein the documentation can be verified by a government-sanctioned authority figure (e.g., a police officer, a government agency representative) or a government-sanctioned technology (e.g., a scanner or instrument with access to trusted identification databases, an algorithm configured to detect fraudulent identification sources, or a database comprising externally-validated dates of birth).

In response to the operation 3022, review of the documentation source by one or more trusted source(s) may result in age verification being confirmed or rejected. Review of the documentation source may result in rejected age verification in the event that the proof-of-age is not sufficient (i.e., not a compliant or accepted documentation source, not legible, not clearly associated with the subject, or otherwise incompatible with the review process) or in the event that the documentation source indicates the subject is below a particular minimum age requirement. In the event that the age verification is rejected, the verification process is stopped and directly results in failure of the age verification attempt in an operation 3080. In the event that the age verification is confirmed, the flow continues to an operation 3042. Within the operation 3042, the subject account 2922 is prompted to provide one or more authentication factor(s) associated with the subject account 2922, wherein the authentication factor(s) may be obtained by the subject or other entity such as a database system. The authentication factor(s) may be respectively defined by the subject (i.e., entry of authentication factor data performed by the subject), and/or defined by an alternative entity and provided to the subject (i.e., generation of authentication factor data assigned to the subject).

In certain implementations, the authentication factor may be a previously defined authentication factor previously stored in association with the subject, the subject mobile device (e.g., a Face-ID input previously stored in association with a smart phone or a previously-established account associated with an external authentication application accessible to the subject via the use of a computing device) or the subject account 2922 associated with the client application (e.g., a password previously stored in association with the subject account). The authentication factor(s) may comprise a knowledge factor, a possession factor, and/or an inherence factor. A single authentication factor may be requested in certain implementations, while a plurality of authentication factors may be requested in other implementations. In the event that a plurality of authentication factors are provided by the subject account 2922, a particular authentication factor within the within the plurality of authentication factors may or may not be implemented within future authentication requests. In response to the operation 3042, review of the authentication factor by one or more trusted source(s) may result in identity verification being confirmed or rejected in an operation 3044, which is discussed in further detail below. In the event that the identification verification is rejected, the verification process is stopped and directly results in failure of the age verification attempt in the operation 3080. Review of the authentication factor(s) may result in rejected identity verification in the event that the proof-of-identity is not sufficient (i.e., not a compliant or accepted authentication factor in terms of format or content, poor quality, not clearly associated with the subject, or otherwise incompatible with the review process). Alternatively, review of the authentication factor(s) may also result in rejected identity verification in the event that the authentication factor is suspected to have been generated by an individual other than the subject identified within the documentation source evaluated within the operation 3022 (e.g., the individual identified within a Face-ID input is suspected to be a different individual identified within the documentation source, or the authentication factor is suspected to be easily comprised by an individual other than the subject). In the event that the age verification is confirmed, the flow continues to an operation 3062.

Within the operation 3062, the subject account 2922 undergoes a final verification following the trusted source review operations, in which the subject account 2922 receives a verification decision from the trusted source account 2962. In the event that the trusted source determines that the age verification is valid, the identity verification is valid, and the subject associated with the age verification documentation source is the same subject associated with the identity verification authentication factor, the age verification confirmation (i.e., one or more age verification attribute(s) 2926) is stored in association with the subject account 2922. Next, the flow advances to an operation 3082, indicating a successful age verification for the subject account 2922. As a result, one or more age verification attribute(s) 2926 is stored in the subject account data structure 2924, one or more access privileges associated with respective age-restricted functions is delegated to the subject account 2922, and/or the age verification attribute(s) 2926 is/are linked to the authentication factor(s) such that the linkage relationship is stored in association with the subject account 2922.

In the event that the trusted source determines that the age verification is invalid or incomplete in operation 3024, the identity verification is invalid or incomplete in operation 3044, and/or the subject associated with the age verification documentation source cannot clearly be identified as the same subject associated with the identity verification authentication factor in operation 3064, the age verification attempt will be rejected. Next, the flow advances to an operation 3080, indicating a failed age verification for the subject account 2922. In certain implementations, one or more data attributes may be stored in association with the subject account comprising information such as a quantitative variable indicating previous age verification attempts, an output or decision generated by a failed age verification attempt, a qualitative variable indicating a previously suspicious or flagged age verification attempt, and/or a verified date of birth or present age of the subject wherein the subject is determined by the review process to be under a particular age threshold. In other implementations, failed age verification does not result in the storage of any data associated with the subject account 2922.

The illustrated process will now be presented from the perspective of the trusted source account 2962 (the trusted source account 2962 being associated with a particular individual or enterprise associated with the client application, mobile device, and/or cashier-less store), begins with an operation 3003 comprising the notification of a verification request in response to an action associated with the subject account 2922, or with an operation 3004 wherein the trusted source (e.g., cashier-less store staff member or CSR) initiates verification for the subject account 2922. For either the operation 3003 or the operation 3004, the initiation of subject age verification may be transmitted directly via local communication to the subject account 2922 and/or transmitted indirectly via a subsystem within system 2500 such as network(s) 2581 or an alternative cloud-based server. Following the initiation of age verification from operations 3003 and/or 3004, age verification begins with an operation 3024, wherein the trusted source account 2962 is prompted to review a documentation source, wherein the documentation source may be provided by the subject or other entity such as a database system. The documentation source is an identification source associated with the subject that provides one or more proof-of-age data attributes indicating the date of birth and/or present age of the subject. A review process associated with the trusted source, such as inspection of a driver's license, generates a confirmation or rejection of the documentation source. The age verification confirmation decision in view of the documentation source may be formatted to include a binary confirmation indicator (the verification confirmed or rejected), a binary age threshold indicator (whether the subject is at a particular age), a numerical value input comprising the present age of the subject in years, and/or the date of birth of the subject indicated by the documentation source.

In response to the operation 3024, review of the documentation source by one or more trusted source(s) may result in age verification being confirmed or rejected. In the event that the age verification is rejected, the verification process is stopped and directly results in failure of the age verification attempt. In certain implementations wherein the documentation source is determined to be valid, but the subject does not meet a minimum age requirement, the trusted source may store the date of birth of the subject in association with the subject account 2922, or alternative data as described previously. In other implementations wherein the documentation source is determined to be valid but the subject does not meet a minimum age requirement, no data may be stored in association with the subject account 2922. In the event that the age verification is confirmed, the flow continues to an operation 3044. Within the operation 3044, review of authentication factor(s) associated with the subject account 2922 by one or more trusted source(s) may result in age verification being confirmed or rejected. In the event that the age verification is rejected, the verification process is stopped and directly results in failure of the age verification attempt, in operation 3080. In certain implementations wherein the authentication factor(s) is/are determined to be valid, but the subject does not meet a minimum age requirement, the trusted source may store the date of birth of the subject in association with the subject account, or alternative data as described previously.

In response to the operation 3044, review of the authentication factor by one or more trusted source(s) may result in identity verification being confirmed or rejected. In the event that the identification verification is rejected, the verification process is stopped and directly results in failure of the age verification attempt in the operation 3080. In the event that the age verification is confirmed, the flow continues to an operation 3064. Within the operation 3064, the trusted source account 2962 is prompted to perform a final verification review following the previous review operations, transmitting a verification decision to the subject account 2922. In the event that the trusted source determines that the age verification is valid, the identity verification is valid, and the subject associated with the age verification documentation source is the same subject associated with the identity verification authentication factor, the age verification confirmation is stored in association with the subject account 2922. As a result, one or more age verification attribute(s) 2926 is stored in the subject account data structure 2924, one or more access privileges associated with respective age-restricted functions is delegated to the subject account 2922, and/or the age verification attribute(s) 2926 is/are linked to the authentication factor(s) such that the linkage relationship is stored in association with the subject account 2922. In the event that the trusted source determines that the age verification is invalid or incomplete in operation 3024, the identity verification is invalid or incomplete in operation 3044, and/or the subject associated with the age verification documentation source cannot clearly be identified as the same subject associated with the identity verification authentication factor in operation 3064, the age verification attempt will be rejected.

The operations associated with the subject account 2922 and the operations associated with the trusted source account 2962 comprise paired operations. Paired relationships between operations are indicated within FIG. 30A by broken lines. For example, operation 3022 and operation 3024 are linked, such that the age verification from the perspective of the trusted source account 2962 processes the documentation source provided in association with the subject account 2922. As well, operation 3022 and operation 3024 are performed by age verification definition engine 2902. Similarly, operation 3042 and operation 3044 are linked, such that the identity verification from the perspective of the trusted source account 2962 processes the authentication factor provided in association with the subject account 2922. Operation 3042 and operation 3044 are performed by identity verification definition engine 2904. Additionally, operation 3062 and operation 3064 are linked, such that the final verification confirmation from the perspective of the trusted source account 2962 determines the final age verification output in association with the subject account 2922. Operations 3062 and 3064 may invoke actions performed by age-restricted access management engine 2906, such that the final verification confirmation is processed to generate one or more access delegations associated with respective age-restricted functions for the subject account 2922.

Within the linked operations 3062 and 3064, a mobile phone with a signal transmission icon is superimposed over the broken horizontal line, indicating that the communication between the subject account 2922 and the trusted source account 2962 can be transmitted via local communication methods, such as an NFC tap between mobile computing devices associated with the subject account 2922 and the trusted source account 2962, respectively. Although the implementation illustrated within FIG. 30A indicates that the communication is both local and direct between operation 3062 and operation 3064 via mobile computing devices, other implementations comprise alternative communication configurations. As previously described within FIG. 29, the relationship between the subject account 2922 and the trusted source account 2962 may be directly or indirectly connected, and the relationship between the subject account 2922 and the trusted source account 2962 may also occur via local or cloud-based channels. In certain implementations, operations 3022 and 3024 are connected via a local and/or direct communication method such as an NFC tap, operations 3042 and 3044 are connected via a local and/or direct communication method such as an NFC tap, and/or operations 3062 and 3064 are connected via a local and/or direct communication method such as an NFC tap.

Following the initial age and identity verification processes, the generated data attributes associated with the subject account 2922 may be further leveraged to enable access for the subject account 2922 to one or more age-restricted functions, as previously described within the discussion of age-restricted access management engine 2906. Next, a process for authenticating and authorizing the subject account 2922 for an age-restricted function following the age verification and access delegation for the subject account is further described.

### Access Management to Age-Restricted Functions

FIG. 30B is a flow chart describing a series of operations for managing subject access to an age-restricted function. First, the disclosed access request method will be presented from the perspective of a subject account 2922 (FIG. 29). Next, the disclosed access request method will be presented from the perspective of the network(s) 2581. Next, the paired operations corresponding to each respective perspective will be described. The illustrated operation within FIG. 30B, from the perspective of the subject account 2922 (the subject account 2922 associated with a particular subject, client application, mobile device, and/or cashier-less store), begins with an operation 3006 comprising the transmission of an access request, wherein the access request may be transmitted directly via local communication to the network(s) 2581 and/or transmitted indirectly via a subsystem within system 2500 such as network(s) 2581 or an alternative cloud-based server. The access request is related to a specific age-restricted function and initiated by an action performed by the subject. The subject action initiating an access request may include a request input via the client application, a request input directed to the trusted source or network(s) 2581 or attempting to perform the age-restricted function. For example, this may be picking up an age-restricted item or requesting that a CSR provide, to the subject, the age-restricted item.

Following the initiation of an access request performed in operation 3006, authentication of the subject begins with an operation 3026, wherein the subject account 2922 is prompted to provide at least one authentication factor, wherein the authentication factor(s) is/are provided downstream to the action-based invocation of the access request. The authentication factor(s) may comprise a knowledge factor, a possession factor, and/or an inherence factor. A single authentication factor may be requested in certain implementations, while a plurality of authentication factors may be requested in other implementations. In the event that a plurality of authentication factors are associated with the subject account 2922, a particular authentication factor within the within the plurality of authentication factors may or may not be requested for the given authentication process.

In response to the operation 3026, review of the authentication factor by the network(s) 2581 or a subsystem associated with the network(s) 2581 may result in subject authentication being confirmed or rejected within operation 3028. In the event that the authentication factor is rejected, the access request process is stopped and directly results in denial of the access attempt in the operation 3085. Review of the authentication factor(s) may result in rejected identity verification in the event that the proof-of-identity is not sufficient (i.e., not a correct or accepted authentication factor in terms of format or content, poor quality, not clearly associated with the subject, or otherwise incompatible with the review process) or in the event that the authentication factor is suspected to have been generated by an individual other than the subject associated with the subject account 2922 (e.g., the individual identified within an authentication factor input is suspected to be a different individual than the subject, or the authentication factor is suspected to be comprised by an individual other than the subject). In the event that the subject authentication is successful, the flow continues to an operation 3046.

Within the operation 3046, the age verification attribute(s) 2926 is detected within the subject attribute data structure 2924 associated with the subject account 2922 and/or an access privilege attribute is detected within the subject attribute data structure 2924 associated with the subject account 2922 in which an access privilege status (i.e., the subject has been delegated access to the age-restricted function or the subject has not been delegated access to the age-restricted function) is determined. In other implementations, the subject attributes associated with access privilege status are detected within an identity and access management database. In the event that the subject account 2922 is determined in operation 3048 to possess access privileges associated with the age-restricted function, the access request is successful. Next, the flow advances to an operation 3086, indicating authorization of the subject to perform the age-restricted function and access is granted.

In the event that the subject account 2922 is determined to lack access privileges associated with the age-restricted function in operation 3048, the access request will be rejected. Next, the flow advances to an operation 3085, indicating failed authorization of the subject to perform the age-restricted function and access is denied. In certain implementations, one or more data attributes may be stored in association with the subject account comprising information such as a quantitative variable indicating previous access request attempts, an output or decision generated by a failed access request attempt, and/or a qualitative variable indicating a previously suspicious or flagged access request attempt. In other implementations, a failed access request process does not result in the storage of any data associated with the subject account.

The illustrated functions will now be presented from the perspective of the network(s) 2581 (or, in alternative implementations, a trusted source account, network node, subsystem, client application, mobile device, and/or cashier-less store associated with network(s) 2581). The functions begin with operation 3008, which includes the notification of an access request for the age-restricted function in response to an action associated with the subject account 2922. The subject access request for the age-restricted function may be transmitted via direct communication to network(s) 2581, local communication to a physical hardware component connected to network(s) 2581, and/or transmitted indirectly via a component associated with system 100, 2500 such as network(s) 2581 or an alternative cloud-based server.

Following the initiation of an access request in, for example, operation 3006, access review begins with an operation 3028, wherein the network(s) 2581, or a subsystem associated with network(s) 2581, is prompted to validate an authentication factor provided by the subject. Within the operation 3028, review of the authentication factor(s) associated with the subject account 2922 may result in successful or failed authentication of the subject identity. In the event that the authentication fails, the access request process is stopped and directly results in denial of access to the age-restricted function. In certain implementations wherein the authentication factor(s) is/are determined to be valid but the subject does not meet a minimum age requirement, the trusted source may store the access attempt by the subject in association with the subject account 2922, or alternative data as described previously.

In the event that the identification verification is rejected, the verification process is stopped and directly results in failure of the age verification attempt in the operation 3085. In the event that the age verification is confirmed, the flow continues to an operation 3048. Within the operation 3048, the network(s) 2581, or a subsystem associated with network(s) 2581, is prompted to detect at least one age verification attribute 2926 associated with the subject account 2922 and/or an access privilege attribute is detected associated with the subject account 2922, in which an access privilege status (i.e., the subject has been delegated access to the age-restricted function or the subject has not been delegated access to the age-restricted function) is determined. In the event that the subject account 2922 is determined to possess access privileges associated with the age-restricted function, the authorization is successful. Next, the flow advances to an operation 3068, indicating authorization of the subject to perform the age-restricted function and confirmation of the access request.

In the event that the subject account 2922 is determined to lack access privileges associated with the age-restricted function, the access request is rejected. Next, the flow advances to an operation 3085, indicating failed authorization of the subject to perform the age-restricted function and access is denied. In certain implementations, one or more data attributes may be stored in association with the subject account 2922 comprising information such as a quantitative variable indicating previous access request attempts, an output or decision generated by a failed access request attempt, and/or a qualitative variable indicating a previously suspicious or flagged access request attempt. In other implementations, a failed access request process does not result in the storage of any data associated with the subject account 2922.

Inherently, the operations associated with the subject account 2922 and the operations associated with the network(s) 2581 comprise paired operations. Paired relationships between operations are indicated within FIG. 30B by broken horizontal lines. For example, operations 3026 and 3028 are linked, such that the authentication from the perspective of the network(s) 2581 processes the authentication factor(s) provided in association with the subject account 2922. Similarly, operations 3046 and 3048 are linked, such that the authorization of access from the perspective of the network(s) 2581 processes the subject account data attribute(s) provided in association with the subject account 2922. Functions included within FIG. 30B are performed by age-restricted access management engine 2906 in many implementations, such that the final access decision is processed to grant access associated with respective age-restricted functions for the subject account 2922. Within the linked operations 3066 and 3068, a mobile phone with a signal transmission icon is superimposed over the broken horizontal line, indicating that the communication between the subject account 2922 and the network(s) 2581 can be transmitted via local communication methods, such as an NFC tap between mobile computing devices associated with the subject account 2922 and the trusted source account 2962, respectively. Although the implementation illustrated within FIG. 30B indicates that the communication is both local and direct between operations 3066 and 3068 via mobile computing devices involving the subject interacting with the trusted source, other implementations comprise alternative communication configurations.

As previously described within FIG. 29, the relationship between the subject account 2922 and various subsystems within system 2500 may be directly or indirectly connected, and the relationship between the subject account 2922 and various subsystems within system 2500 may also occur via local or cloud-based channels. In certain implementations, operations 3026 and 3028 further comprise a local and/or direct communication method such as an NFC tap, operations 3046 and 3048 further comprise a local and/or direct communication method such as an NFC tap, and/or operations 3066 and 3068 further comprise a local and/or direct communication method such as an NFC tap. In one implementation, all three related pairs of operations within FIG. 30B further comprise a local and/or direct communication method such as an NFC tap. In another implementation, no related pairs of operations within FIG. 30A further comprise a local and/or direct communication method such as an NFC tap.

### Example Graphical User Interface for Subject Age Verification

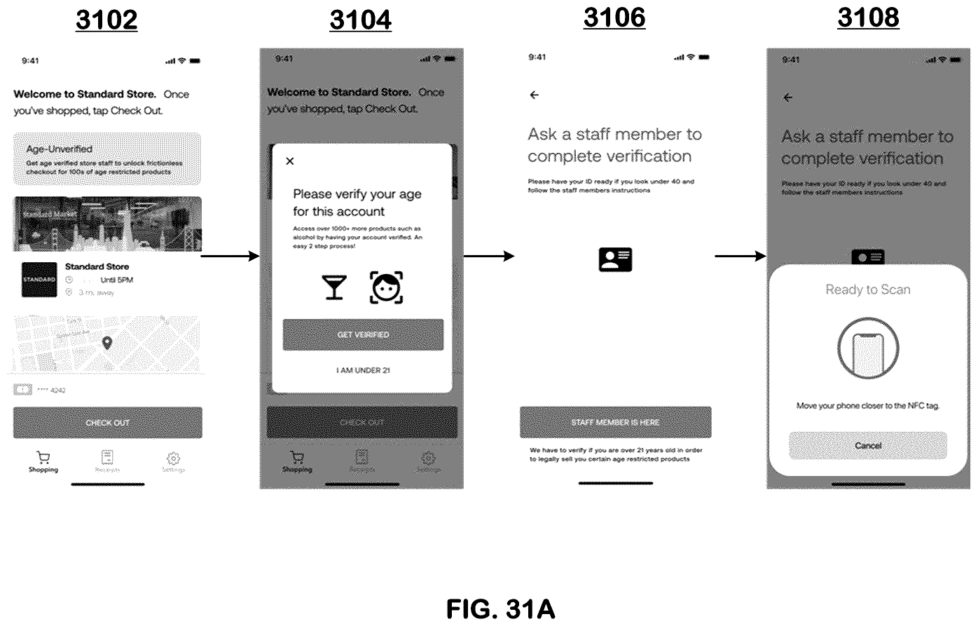

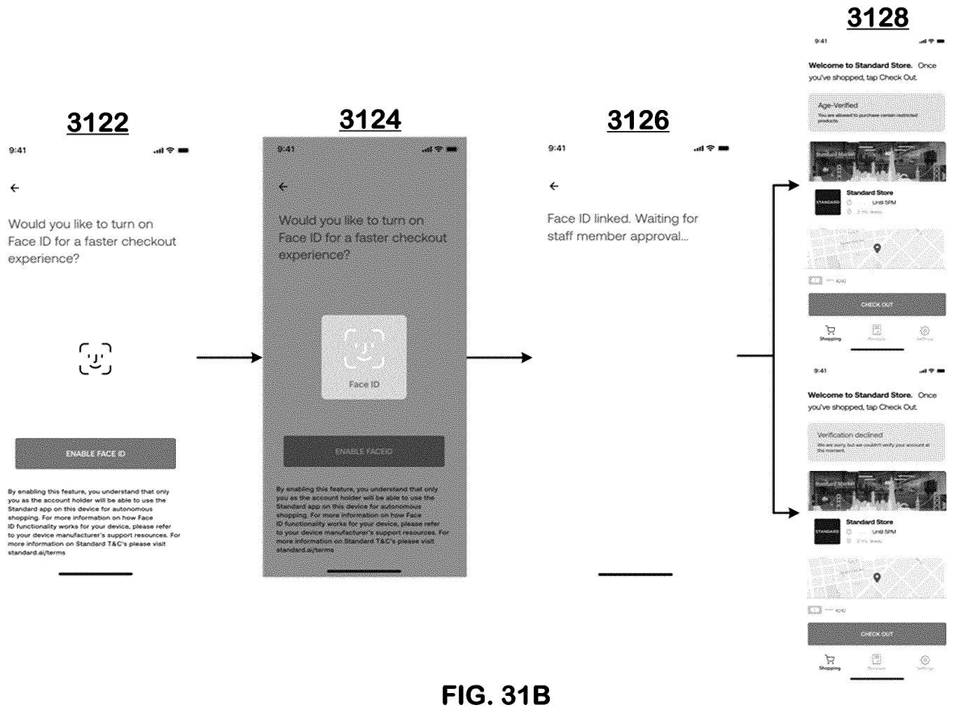

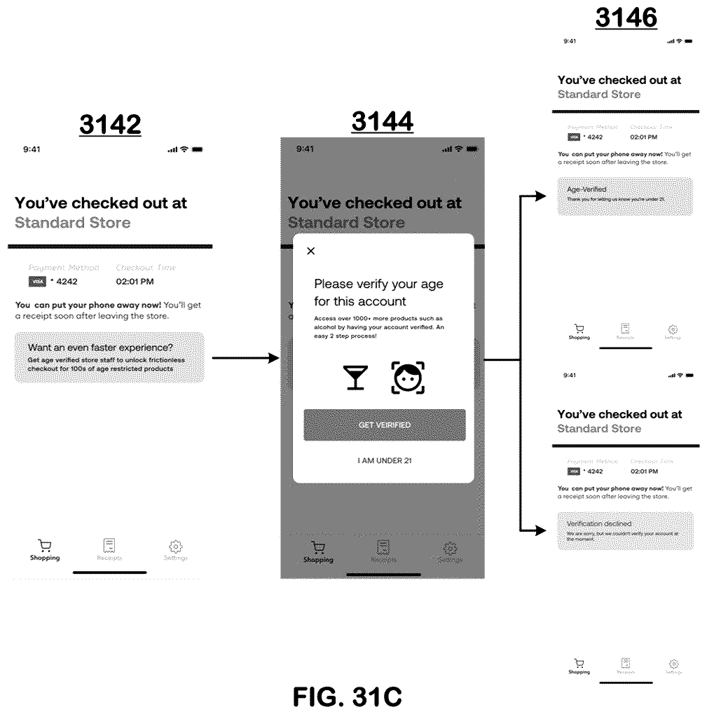

FIG. 31A shows an example graphical user interface for initiating subject age verification while shopping, from the perspective of the subject mobile computing device. Interface screen 3102 illustrates a graphical user interface (GUI) wherein the subject is logged in to their subject account 2922 within the client application and checked in at a cashier-less store. In addition to graphics indicating the store at which the subject is shopping, the payment method being used, and an option to check out, the subject is also presented with a notification indicating that the subject has not performed age verification, further inviting the subject to do so. Next, interface screen 3104 within the GUI comprises a notification presented to the subject requesting the subject initiate age verification, wherein the subject can select an option initiating age verification, or an option indicating that the subject does not qualify for age verification. Following selection of the option initiating age verification, interface screen 3106 within the GUI instructs the user to interact with a CSR to perform the age verification process and provides a selection option to the user to indicate that the CSR is present and ready to engage in an age verification for the subject. In between interface screens 3106 and 3108, the CSR evaluates a documentation source, such as a driver's license, to determine the date of birth and/or current age of the subject, and confirms within the respective CSR client application that the subject is of age. Next, interface screen 3108 within the GUI illustrates instructions to perform an NFC tag scan via close-range communication between the subject mobile computing device and the CSR mobile computing device, transmitting the age verification confirmation from the CSR mobile computing device to the subject mobile computing device. As a result, any initiated age-restricted functions will be allowed to proceed for the subject account 2922.

FIG. 31B shows an example graphical user interface for initializing an authentication factor for subject age verification, from the perspective of the subject mobile computing device. Following age verification of the subject within the subject account 2922, the subject may wish to perform further identity verification as previously described within the age verification method, preventing further manual age verification checks in order to obtain certain age-restricted items. First, interface screen 3122 within the GUI presents the subject with the option to perform further identity verification through recording of a Face-ID inherence factor to be linked to the verified age of the subject. Following selection of the option to enable Face-ID, interface screen 3124 within the GUI requests input of a Face-ID inherence factor from the subject. Once a Face-ID inherence factor associated with the subject has been linked to the subject account 2922, interface screen 3126 within the GUI communicates to the subject that the CSR must confirm the relationship between the age verification confirmation and the identity verification confirmation, enabling one or more future inputs of the subject Face-ID to grant the subject access to at least one age-restricted function for subsequent age-restricted actions. Next, interface screens 3128 within the GUI illustrate the notification presented to the subject communicating the decision of the CSR to approve or decline the age verification for the subject in view of the provided documentation source and/or Face-ID input.

FIG. 31C shows an example graphical user interface for initiating subject age verification following checkout, from the perspective of the subject mobile computing device. In contrast to the process illustrated within FIG. 31A and FIG. 31B, wherein age verification is initiated by the subject initiating an age-restricted function, FIG. 31C illustrates a process in which age verification is initiated by a notification presented to the subject by the client application following checkout. Interface screen 3142 within the GUI illustrates a graphic presented to the subject following a successful checkout and notifying the subject that a digital receipt will be sent to the subject account 2922 soon. Interface screen 3142 further illustrates a notification presented to the subject asking if the subject would like to perform age verification independent of a specific age-restricted function, enabling the future access approval for autonomous age verification in association with one or more age-restricted functions or products. Following the subject communicating a wish to perform age verification to a CSR, interface screen 3144 within the GUI and interface screen 3146 reflect similar interface screens and corresponding processes to interface screen 3104 and 3128, respectively.

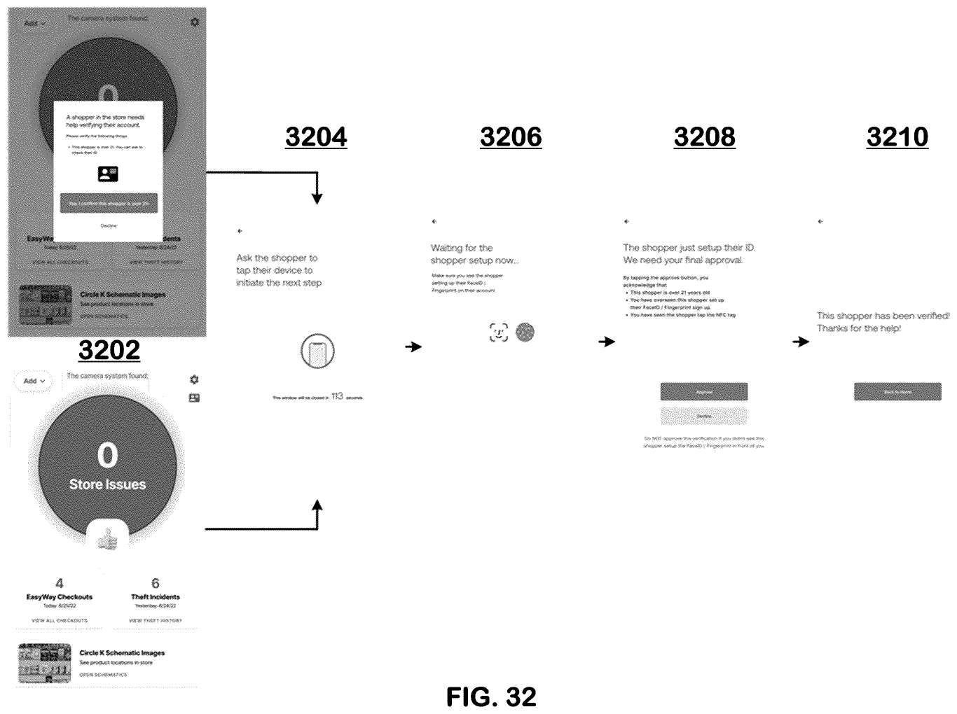

FIG. 32 shows an example graphical user interface for initiating subject age verification, from the perspective of the trusted source mobile computing device. Interface screens 3202 within the trusted source (e.g., the CSR) client application GUI illustrate the CSR interface prior to initiation of age verification for a subject. In some implementations, the CSR is notified via the GUI that a subject requires age verification. In other implementations, the CSR will initiate the age verification process in response to a verbal request from a subject. Following screens 3202 and prior to screen 3204, the CSR reviews a documentation source providing a proof-of-age for the subject and determines that the subject is above a minimum age threshold. Next, interface screen 3204 within the GUI instructs the CSR to guide the subject through the NFC tap to communicate the age verification confirmation. Following the local transfer of the age verification confirmation, interface screen 3206 within the GUI informs the CSR that the subject will now provide an inherence factor to be associated with the subject account, such as a Face-ID or fingerprint scan, and the CSR is instructed to supervise the inherence factor input to ensure that the inherence factor is associated with the same subject whom the CSR reviewed a documentation source for and confirmed the age verification in response to. Next, interface screen 3206 within the GUI instructs the CSR to input a final approval, confirming the validity of the age verification, the identity verification, and the connection linked between the age verification and the identity verification for the subject. Following final approval of the age verification process, interface screen 3210 within the GUI informs the CSR that the age verification has successfully been completed and the age of the subject is now verified.

FIG. 33 is a camera and computer hardware arrangement configured for hosting the subject age verification engine of FIG. 25. The system 3300 is similar to the system 2600 and the description above for system 2600 overlaps with the system 2600 and the corresponding components. Shared descriptions of overlapping components are omitted for the sake of redundancy. In contrast to system 2600, system 3300 comprises a network node 3330 hosting the age verification engine 2592.

### Cart Injection

In some implementations, the alternative to the computer vision system(s) may be implemented in the place of at least one function that one or more computer vision system(s) is/are associated with or configured to perform. In other implementations, the alternative to the computer vision system(s) may be implemented as an augmentation to at least one function that one or more computer vision system(s) is/are associated with or configured to perform. Herein, the alternative to the computer vision system(s) is primarily presented within the context of a plurality of implementations for a cart injection method. The described implementations for the cart injection method are intended to be exemplary implementations to elaborate upon certain functionality and use cases for the disclosed method, and should not be interpreted as a limitation to the scope or spirit of the disclosed method. Within the described implementations herein, a single computer vision system is described for simplicity. However, the operations associated with the disclosed cart injection technology may interact with a plurality of computer vision systems in various implementations. Moreover, one or more computer vision systems associated with the disclosed technology may comprise nonoverlapping configurations in differing implementations.

In some implementations, the disclosed cart injection technology interacts in some combination of functionality and/or structure with the computer vision system(s). In other implementations, the disclosed cart injection technology operates in the place of one or more components within the computer vision system(s). Certain implementations comprise further technology for the augmentation of an autonomous shopping environment in association with computer vision system(s), wherein the further technology may or may not be associated with the disclosed cart injection technology.

For example, the computer vision system may not be configured to recognize and/or classify certain items or item interactions, the computer vision system may not perform as expected or achieve infallible accuracy, and/or certain item interactions may be associated with certain characteristics that are not compatible with computer-vision systems. These scenarios will now be detailed further, as well as the introduction of particular implementations for a cart injection method further comprising operations to update a subject inventory cache while potentially bypassing computer vision-systems or computer vision-dependent channels. The disclosed cart injection technology is related to a plurality of items referred to herein as “specialty items.” A specialty item may be an item incompatible with computer vision technology, wherein compatibility is defined by at least one performance metric of the computer vision system(s) function such as precision, accuracy, computational cost, and/or temporal metrics. A temporal performance metric may be at least one of a metric associated with response time, processing time, and/or another period of time associated with at least one component of at least one computer vision system. Examples of specialty items can include, but are not limited to, a customized product, a food item wherein ingredients are not visually identifiable and/or compatible with computer vision technology, a product that is stored out of the reach of a shopper, or products that may require further revision or added detail by a customer service representative. In addition to a customer service representative, other individuals or entities may be delegated privileges to perform cart injection and other shopping cart revision processes. Examples of specialty items can further include deli options that may be highly similar such as a turkey or ham sandwich. Examples of specialty items may also further include fountain drinks, wherein the cup or liquid contained in the cup is not distinguishable as a specific beverage (e.g., if the drink is Coke™ or Diet Coke™).

Additional examples of specialty items may further include age-restricted products kept behind a counter such as lottery tickets, wherein the ticket itself is not reachable by the shopper, the cash value purchased by the shopper is not detectable by computer vision, the cash value purchased by the shopper must be manually input by a customer service representative, and the physical ticket is incompatible with computer vision recognition models. Alternative examples of specialty items held behind the counter may be tobacco products, wherein a first brand and type of tobacco (e.g., a package of cigarettes or cannister of chewing tobacco) is highly similar in shape and appearance to a second brand and type of tobacco, and the customer service representative must determine that a customer is of a valid age to purchase the tobacco, obtain the requested brand and type of tobacco for the customer, and manually inject the tobacco product into the shopper's cart.

A specialty product can also exist as a pre-ordered or carryout ordered item, such as a customer ordering a product to be reserved behind the counter and picked up using a proof of identification operation, or a food order placed in advance to be picked up once the food item is prepared. For example, a customer may use an ordering operation (e.g., calling the store, using a website, or using a mobile device application) to order a deli or hot food item in advance and receive the already-prepared and packaged food upon arrival, wherein the food items are injected into the customer's cart following the hand off. Alternatively, the food items may be injected into the customer's cart prior to arrival at the store, triggered by an event such as the placement of an order or an acknowledgement of the order within the store. Furthermore, the disclosed cart injection technology enables shoppers to further modify food orders following placement. For example, the customer may have previously ordered a particular food combination containing two items but upon arriving to the store, requests that a third item be added.

In some implementations, the disclosed cart injection technology is augmented by at least one component of at least one computer vision system. As a first example implementation, the computer vision system may recognize and classify an interaction wherein a customer service representative hands a tobacco product to a shopper and the customer service representative further specifies the type of tobacco. In a second example, the computer vision system may broadly recognize and classify interactions that are complex and/or potentially incorrect and automatically notify or flag a customer service representative and/or reviewer that the interaction should contain a cart injection or may potentially contain a cart injection. These interactions may include a shopper picking up an item that cannot be labelled by the computer vision system, picking up an item that was labelled with low confidence by the computer vision system, picking up an item that does not match the item that was expected to be in the retrieved location, a shopper obtaining an item associated with a cart injection data label (e.g., inventory systems associated with the autonomous shopping environment indicate that deli items require cart injection so that upon recognition by the computer vision system, a shopper interaction with the deli item is recognized as a cart injection-associated interaction), a shopper interacting with a customer service representative to obtain an item, or a customer service representative entering a restricted area of the store or opening a restricted storage area within the store.

Although specific examples are listed for illustrative purposes of both specialty items and cart injection procedures designed to interact with specialty items, these examples should not be considered limitations. The specialty item examples listed above and elaborated upon further below represent common use cases to which the technology disclosed may be applied; however, any autonomous shopping environment may define any product or service obtainable by a shopper as a specialty item. Furthermore, any autonomous shopping environment may implement the disclosed cart injection technology in relation to any shopper or shopping cart interaction.

Additionally, while many implementations described herein refer to cart injection as being performed by the CSR, cart injection need not be performed by the CSR. In addition to user entities and trusted authorities initiating and/or supervising cart injection processes, engines and machine learning models may also be configured to initiate, supervise, and/or otherwise interact with a cart injection process. For example, in one implementation, a computer vision system recognizes and classifies the CSR handing a package of cigarettes from a locked case behind the counter to the shopper, wherein the package of cigarettes is identified as a specific item within the store inventory. A machine learning model then processes the classification data from the computer vision system and generates a cart injection as output, adding the package of cigarettes to the shopper's cart. Within the following description of various implementations for the disclosed cart injection method, previously aforementioned methods of camera arrangement, image processing, subject tracking, UWB location tracking, and/or age verification may be included within certain implementations.

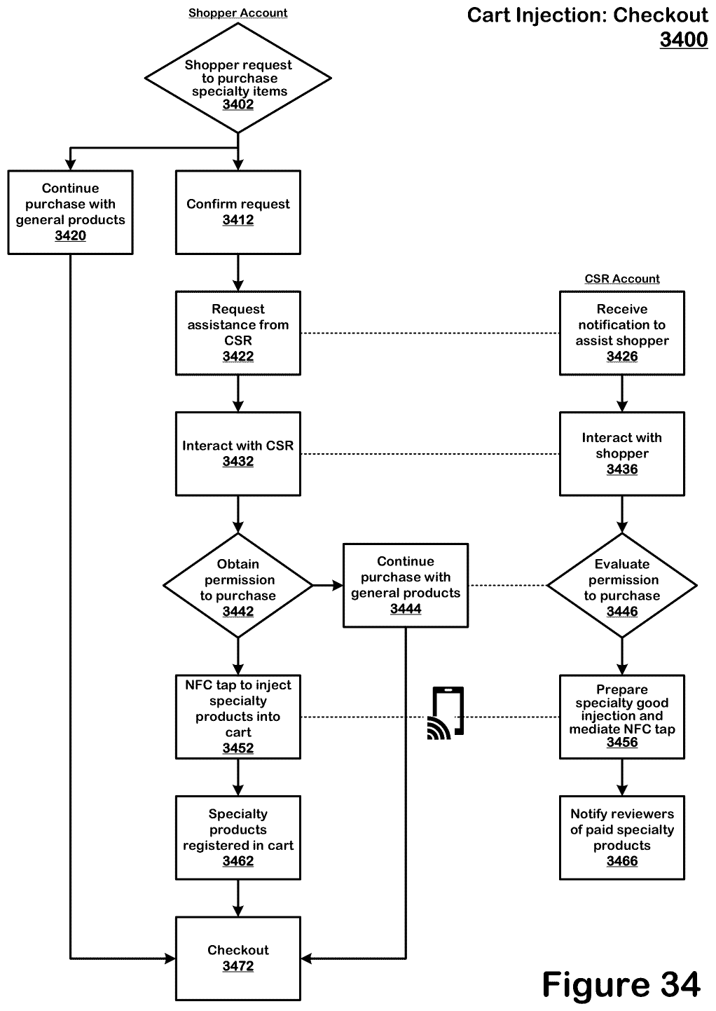

FIG. 34 is a flow chart describing a method for injecting items into a subject inventory cache. The flow process begins with a shopper decision to initiate an interaction with one or more specialty items in an operation 3402. In response to the shopper interaction with a specialty item, a notification can be presented to the shopper confirming that the shopper would like to request access to the specialty item, in one implementation. If the shopper decides they would not like to proceed with the access request for the specialty item, they may continue with general item interaction procedures in an operation 3420. Alternatively, if the shopper decides they would like to proceed with the access request for the specialty item, they are instructed to request access from a CSR in an operation 3412. In response, the CSR receives a notification to assist the shopper with the specialty item access request in an operation 3426. The interaction is performed by the shopper and the CSR, respectively, within operations 3432 and 3436, confirming the specialty item the shopper would like to access and one or more prerequisites in association with the access of the specialty item. In other implementations, the shopper and/or the CSR may not receive notifications to trigger cart injection and the process is either user-initiated or the process is automatically performed by an additional entity, such as an engine or classifier configured to perform cart injection.

Access to the specialty item, in many implementations of the disclosed cart injection method, is a restricted access function. The restricted access function associated with the specialty item can be an age-restricted function, a qualification-restricted function, or a medically-restricted function. For certain restricted specialty items, the prerequisite for the restricted function is an availability prerequisite. Access management to the restricted specialty item when an availability prerequisite is required further comprises detecting an availability status associated with the restricted function and evaluating the availability status to confirm whether the prerequisite is met, wherein the prerequisite is met when the availability status indicates the restricted function is available. For example, a particular specialty item may not be sold at the store where the shopper is located, out of stock at the store where the shopper is located, or not available for sale at certain times of the day or days of the week.

For other restricted specialty items, the prerequisite for the restricted function is a subject access privilege prerequisite. Access management to the restricted specialty item when a subject access privilege prerequisite is required further comprises an authentication and authorization process, as previously described within the disclosed method for age-restricted items. For example, in addition to age-restricted functions, a particular specialty item may require a license for purchase (e.g., certain beauty supply or scientific supply goods), a pre-ordered item only available for pickup by a pre-authorized subject account, or a specialty product requiring a prescription or insurance authorization (e.g., contact lenses, medication, or diabetes supplies). Some restricted specialty items may require a conditional definition prerequisite. Access management to the restricted specialty item when a conditional definition prerequisite is required further comprises detecting a conditional definition associated with the restricted function, wherein the conditional definition comprises at least one further descriptor associated with defining a condition of access, and evaluating the conditional definition to confirm whether the prerequisite is met. For example, certain products may require further conditional definition of a qualitative or a quantitative feature associated with the specialty item. A qualitative feature associated with the specialty item may comprise selection of meal ingredients, customization of a coffee beverage, or a type of gasoline to be pre-purchased. A quantitative feature associated with the specialty item may comprise a quantity of the specialty item, a size of the specialty item, or a cost of purchase for the specialty item (e.g., amount of money to be placed on a gasoline pump or cash value of lottery tickets).

Alternatively, some specialty items are restricted based on a function associated with the autonomous shopping environment, wherein the function may bypass camera detection (e.g., obtaining a specialty item that is difficult to detect by computer vision systems or a specialty item that is blocked by a partition preventing detection by computer vision systems) or require an interaction with an external authority (e.g., specialty items requiring further authorization to access, customization prior to access, or specialty items contained in locked or employee-access only areas).

Following CSR evaluation of relevant prerequisites associated with access to the specialty item within an operation 3446, the subject account requests permission to purchase the specialty item within an operation 3442. In the event that the prerequisite for access to the specialty item is not met, the access request is denied and the subject may continue their shopping trip with general products in an operation 3444. In the event that the prerequisite for access to the specialty item is met, the access request is approved and the CSR begins to prepare a cart injection comprising item data associated with the specialty item and conditional definitions for the specialty item in an operation 3456. Also within the operation 3456, the CSR mediates an NFC tap between the respective mobile computing devices of the CSR and the shopper to initiate the cart injection of the specialty item. Following the NFC tap on the shopper device in an operation 3452, the specialty product(s) are injected into the shopper cart. In an operation 3462, the specialty products are registered within the cart, and the shopper may proceed with checkout in an operation 3472.

In various implementations of the disclosed cart injection method, the subject inventory cache is updated to include an addition, a revision, and/or a removal of the specialty item, wherein the specialty item is incompatible with the computer vision system. As previously described within the processes constituting FIG. 34, a specialty item and related subject inventory cache updates to the specialty item are defined as incompatible with the computer vision system due to an access restriction associated with the item, a specialty feature associated with the item, a configuration of an autonomous shopping environment inventory cache, and/or a status associated with the computer vision system. The prerequisite or precondition restricting access to the specialty item may further comprise a minimum age restriction associated with the purchase of the item in one implementation, wherein the precondition is the minimum age restriction associated with a set of one or more precondition term(s) comprising an age verification for the subject. The set of precondition terms are fulfilled when a documentation source comprising a proof-of-age for the subject is reviewed and verified by a trusted source. Examples may include alcohol, tobacco, or age-restricted medications.

In another implementation, the prerequisite or precondition restricting access to the specialty item may further comprise an authority approval restriction associated with the purchase of the item, wherein the precondition is an approval to purchase by a designated authority associated with a set of one or more precondition term(s) comprising an approval to purchase by a designated authority. The set of precondition terms are fulfilled when the designated authority approves the removal of a restriction to purchase for the subject and/or transmits a confirmation input approving the purchase. Examples may include locked items, security-tagged items, items unreachable by the customer, or items that require obtaining a precursor item such as a coffee cup prior to obtaining coffee.

In yet another implementation, the prerequisite or precondition restricting access to the specialty item may further comprise a qualification restriction associated with the purchase of the item, wherein the precondition is a license, certification, qualification, and/or authorization required to qualify for the purchase of the item associated with a set of one or more precondition term(s) comprising a qualification verification for the subject by a designated authority. The set of precondition terms are fulfilled when a documentation source comprising a proof-of-qualification for the subject is reviewed and verified by the trusted source and/or designated authority. Examples may include regulated beauty products, prescriptions, or state-specific products that are limited by licensing such as ammunition.

In a last described implementation, the prerequisite or precondition restricting access to the specialty item may further comprise a identity restriction associated with the purchase of the item, wherein the precondition is the identity of the subject associated with a set of one or more precondition term(s) an identity verification for the subject. The set of precondition terms are fulfilled when a documentation source comprising a proof-of-identity for the subject is reviewed and verified by a trusted source and/or designated authority. Examples may include a pre-paid item for pickup, a carryout order, a prescription medication, or a food delivery service order.

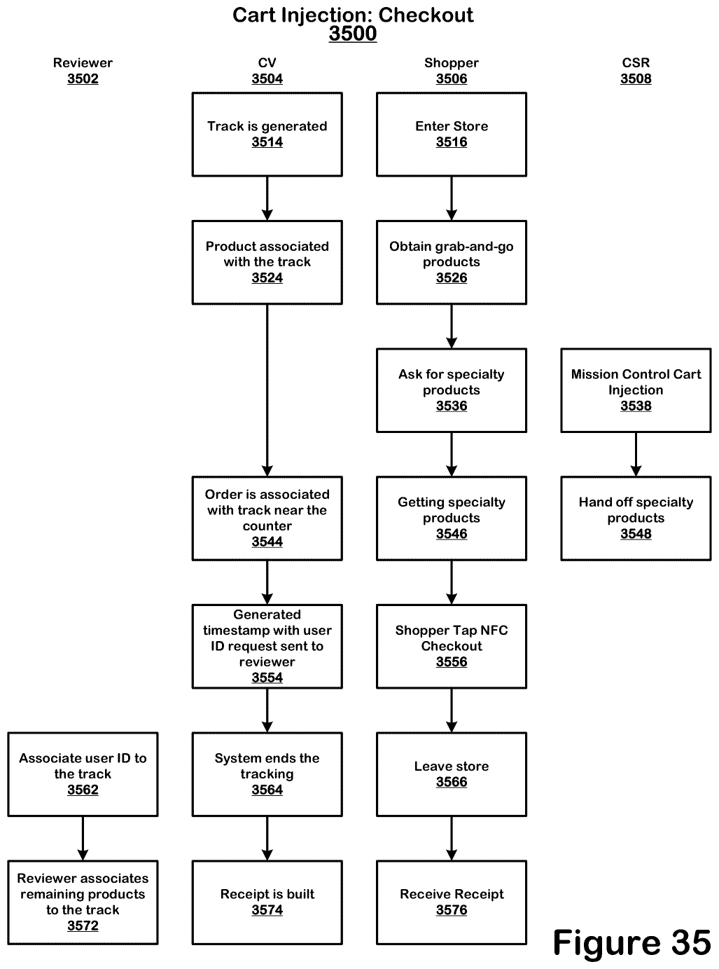

FIG. 35 is a schematic diagram describing a method for injecting items into a subject inventory cache from a plurality of entity perspectives. At the time that a shopper 3506 enters a cashier-less shopping environment at an operation 3516, a computer vision system 3504 generates a track for the tracking of subject/item interactions in an operation 3514. As the shopper 3506 interacts with the cashier-less shopping environment, they obtain one or more “grab-and-go” products in an operation 3526, wherein the items picked up by the shopper 3506 are associated with the track in an operation 3524 by the computer vision system 3504. In the described implementation of the cashier-less shopping method, the shopper 3506 wishes to obtain a specialty product in an operation 3536. Following the procedure presented within FIG. 34, the CSR 3506 interacts with a mission control system associated with the client application and cashier-less shopping environment to inject the requested specialty product into the shopper cart in an operation 3538. Following cart injection, the CSR 3506 physically transfers the specialty product in an operation 3548. Upon receival of the specialty product by the shopper 3506 in an operation 3546, the computer vision system 3504 associates the interaction near the CSR counter with the shopper track in an operation 3544. Upon checkout by the shopper 3506 in an operation 3556, the computer vision system 3504 generates a timestamp for the checkout, as well as a user ID request associated with the cart injection to be sent to a reviewer in an operation 3554. The computer vision system 3504 subsequently ends the tracking process in an operation 3564 in response to the shopper 3506 leaving the store in an operation 3566. At this stage, a reviewer 3502 associates the user ID and cart injection interaction with the shopping track in an operation 3562. Next, in an operation 3572, the reviewer 3502 associates the remaining products to the shopper track. The receipt is built in operation 3574, and the shopper receives the receipt in operation 3576.

### Example Graphical User Interface for Cart Injection

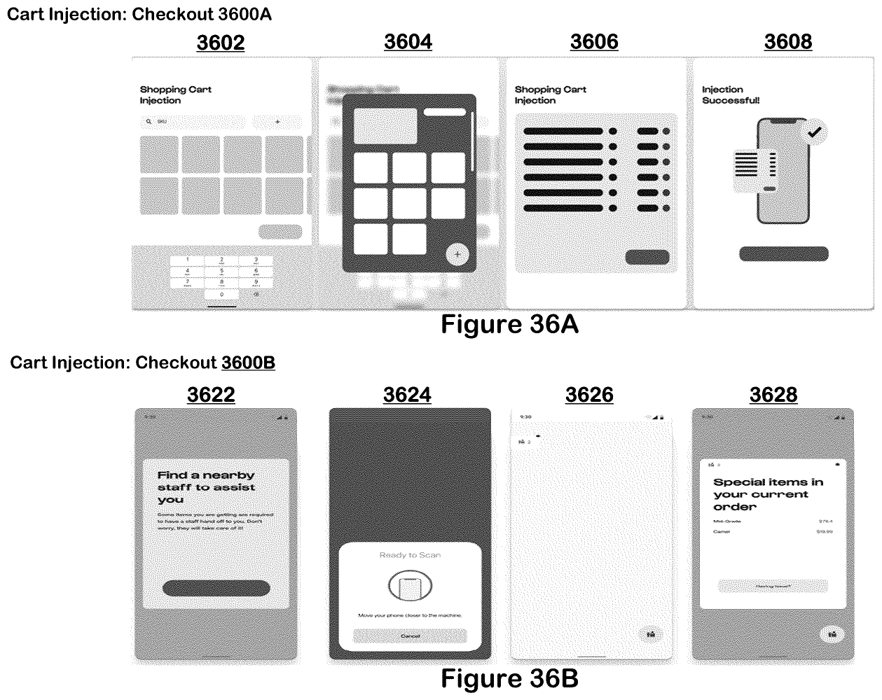

FIG. 36A shows an example graphical user interface for cart injection, from the perspective of a customer service representative mobile computing device, in accordance with various implementations of the technology disclosed. In a first interface screen 3602, the CSR is presented with a GUI for identifying specialty items for cart injection. Within the example process described within FIG. 36A, it is assumed to be true that the CSR has correctly identified the appropriate subject account within the system component configured to perform cart injection or within an operation associated with the system component configured to perform cart injection. Next, in a second interface screen 3604, the CSR is presented with a GUI for providing additional conditional definitions associated with the specialty items to be injected. In a third interface screen 3606, the CSR can review the cart injection and execute the cart injection. Next, in interface screen 3608, confirmation of the successful cart injection is presented to the CSR.

FIG. 36B shows an example graphical user interface for cart injection, from the perspective of a subject mobile computing device, in accordance with various implementations of the technology disclosed. In a first interface screen 3622, the subject is presented with a GUI for requesting specialty items for cart injection. Next, in a second interface screen 3624, the subject is instructed to tap their device to the CSR device to transmit the cart injection using NFC tags or similar close-range communication techniques. In a third interface screen 3626, the GUI processes the received cart injection. Next, in interface screen 3628, the specialty items injected into the shopper's cart are presented to the shopper for review. In various implementations, the interface screen 3622 is not required. In some implementations, the subject makes a selection via the client application on their mobile computing device that indicates a selection of a specialty item. The subject may be prompted to hold their phone near a sensor or communication device (e.g., devices configured to mediate close-range communication, computer vision recognition, and so on) in one implementation, whereas in another implementation, the subject is not required to perform any further actions to initiate cart injection following the selection of a specialty item.

### Particular Implementations

Some particular implementations and features for the disclosed technologies are described in the following discussion. The method described in this section and other sections of the technology disclosed can include one or more of the following features and/or features described in connection with additional methods disclosed. In the interest of conciseness, the combinations of features disclosed in this application are not individually enumerated and are not repeated with each base set of features. The reader will understand how features identified in this method can readily be combined with sets of base features identified as implementations.

The disclosed method for self-service installation of monitoring operations in an area of real space, the method including: scanning the area of real space, using a sensor, to generate a 3D representation of the area of real space; placing a camera at an initial location and orientation for monitoring a zone within the area of real space; configuring a computing device to be (i) connected to a cloud network hosting an image processing service and (ii) couplable to the camera via a local connection, where the configuration enables the computing device to mediate communications between the image processing service and the camera; coupling the camera to the computing device in dependence upon the local connection and a unique identifier associated with the camera; and finetuning a placement of the camera to a calibrated location and orientation, where the finetuning is assisted by information received from a cloud-based application associated with the image processing service.

The method can further include identifying regions of interest within the monitored zone based on an output received from an object classification model, where: a particular region of interest is a 3D space at which a particular object is expected to be located, and the output of the object classification model is determined by processing, as input, the 3D representation of the area of real space and 2D image data generated from RGB data associated with corresponding points in the 3D representation. The method can further include identifying updated regions of interest based on updated images of the area of real space. The method can further include, for a monitored zone within a field of view of the camera, where the monitored zone may include locations within display shelving at which corresponding inventory items are expected to be found: receiving, from the camera, a sequence of images; processing the received sequence of images using the object classification model to identify a region of interest within the monitored zone, where the region of interest corresponds to a location for an expected inventory item; generating a label for the region of interest may include one or more of (i) a set of boundaries indicating a location of the region of interest and (ii) an identifier of the expected inventory item for the region of interest; and projecting, onto subsequent images captured by the camera, a rendering of the label for the region of interest at the location of the region of interest within the field of view of the camera. The method can further include processing the subsequent images, labelled for the region of interest, to detect the presence of inventory items at the region of interest; determining, in response to a detection of no inventory item present at the region of interest, that the region of interest is empty facing; and generating a report for the empty facing region of interest. The method can further include processing the subsequent images, labelled for a plurality of regions of interest corresponding to a plurality of locations for a particular inventory item; in response to determining that each of the plurality of regions of interest is empty facing, further determining that the particular inventory item is out of stock; and generating a report for the out of stock inventory item. The method can further include processing the subsequent images, labelled for the region of interest, to detect the presence of inventory items at the region of interest; determining, in response to a detection of an inventory item present at the region of interest, whether the detected inventory item matches the expected inventory item, where (i) in response to the detected inventory item matching the expected inventory item, further determining that the expected inventory item is in stock, or (ii) in response to the detected inventory item not matching the expected inventory item, further determining that the detected inventory item is incorrectly stocked; and generating a report for one or more of an in stock inventory item and an incorrectly stocked inventory item.

The method can further include provisioning and initializing an instance of the cloud network; configuring network and IP management processes for the cloud network; installing a node cluster configured to schedule and run a plurality of cloud containers; and connecting the computing device to the cloud network using an ephemeral wireless connection. The method can further include, for a plurality of cameras with overlapping corresponding fields of view connected to the computing device: processing respective sequences of frames of the overlapping corresponding fields of view to detect an occlusion in at least one field of view corresponding to a camera of the plurality of cameras, and generating factored images in which the detected occlusion is patched based on at least one other field of view corresponding to another camera of the plurality of cameras. The method can further include storing, in an image storage, images captured by the camera or storing, in a region of interest database, at least one identified region of interest within the monitored zone.

Other implementations of the methods described in this section can include a tangible non-transitory computer-readable storage medium storing program instructions loaded into memory that, when executed on processors, cause the processors to perform any of the methods described above. Yet another implementation of the methods described in this section can include a device including memory and one or more processors operable to execute computer instructions, stored in the memory, to perform any of the methods described above.

In other implementations of the technology disclosed, the store does not leverage autonomous checkout and rather; uses a traditional employee-mediated check-out process. In addition to autonomous shopping, the disclosed setup and operation processes for a set of cameras may be implemented within a store for the purpose of zoned monitoring, security surveillance, collection of data analytics, planogram compliance (i.e., maintaining an updated map including the locations of items within various display structures such as shelving within the store), or monitoring of inventory stock. For example, cameras may be set up within only a portion of the store, such as a walk-in cooler for alcoholic beverages (“beer cooler”) or the check-out counter. While any portion of a store may be established as a monitored zone with an implemented computer vision system comprising one or more cameras (the cameras being set-up and operated as disclosed herein), particularly evocative examples include regions of the store that are more difficult for manual employee monitoring (like a beer cooler), regions that contain higher cost items, regions that contain items subject to heightened restrictions such as age-or otherwise legally-restricted items, or high risk areas such as the checkout counter where a cash register, tobacco products, lottery products, and so on may be stored.

In the figure descriptions, the disclosed setup and operation processes are primarily described within the context of a store. The cameras may be configured to assist in security monitoring, out of stock monitoring, planogram compliance, marketing data analytics, store performance analytics, and/or the automation of other various store operations. However, in other implementations, the technology disclosed may include the setup of cameras within other non-retail environments, such as warehouses, office buildings, and personal residences. The setup of cameras can also be performed in outdoor environments, such as farmers markets, outdoor concerts, and street fairs. Aspects of the technology disclosed described herein, such as those related to the identification, re-identification, location tracking, and interaction tracking of objects and subjects, translate to non-retail environments for monitoring systems. For example, inventory monitoring may be performed in warehouse and shipping facilities. Subject tracking for the purposes of security surveillance can be leveraged in a variety of commercial and residential applications, for example, within banks and home security (e.g., using cameras and other smart home IoT devices).

In other implementations, data collected by the disclosed system can be presented, as well as additional data produced by downstream analyses of the collected data, in the form of data analytics reporting on overall sales performance, marketing data, employee performance, shrinkage, and so on. Other implementations include a method of verifying an age of a subject to be linked with a subject account, the subject account being linked with a client application executable on a mobile computing device, the method including verifying the age of the subject and verifying an identity of the subject. The age verification operations can further include receiving a verification request in dependence on an action performed by the subject, inspecting a documentation source that identifies the subject, the documentation source further comprising a validation of the age of the subject, and transmitting an age verification confirmation to be stored in association with the subject account. The identity verification operations can further include receiving an authentication factor from the subject, confirming a connection between the authentication factor and the subject, wherein the connection is a proven relationship between the authentication factor and the subject, and transmitting an identity verification confirmation to be stored in association with the subject account.

In one implementation, the age verification method further includes authorizing the subject for one or more age-restricted functions, wherein an age-restricted function is an interaction associated with the client application. In another implementation of the technology disclosed, age verification further includes binding the age verification confirmation to the authentication factor within the subject account, wherein the age verification input authorizes the subject to access the age-restricted function and the authentication factor authenticates the subject to access the age-restricted function. Other implementations may further include authorization and authentication for the subject to access an age-restricted function wherein the subject account interacts with a product or a service within a cashier-less shopping environment, and wherein the age-restricted function is an interaction between the subject account and the product or service with a pre-defined age threshold required to access the interaction. Some implementations may further include authorization and authentication for the subject to access an age-restricted function wherein the subject is associated with a subject attribute data structure storing one or more subject attributes, and wherein a subject attribute is at least one of a subject identifier or credential, the age verification confirmation, the identity verification confirmation, an authentication factor, and additional subject metadata.

Some implementations include a method of age verification wherein the age verification confirmation is an authorization status for the age-restricted function, and wherein the age verification confirmation is at least one of a biological age of the subject, a date of birth of the subject, and a binary variable indicating whether the subject exceeds the pre-defined age threshold required to access the age-restricted function, as informed by the documentation input. The documentation source can be, for example, an identification document, such as a driver's license, passport, state identification card, or birth certificate, that can be further validated by a government or regulatory agency authority.

Various implementations comprising age verification can require an authentication factor from the subject, the authentication factor is at least one of an inherence factor such as a fingerprint, a retina scan, a voice verification, a facial recognition, and a palm scan. Authentication of the subject to access the age-restricted function may further include a multi-factor authentication protocol, and the multi-factor authentication protocol can include an inherence factor. As previously indicated, this method and other implementations of the technology disclosed can include one or more of the following features and/or features described in connection with additional methods disclosed. In the interest of conciseness, the combinations of features disclosed in this application are not individually enumerated and are not repeated with each base set of features. The age verification and/or the identity verification can be performed by a trusted source, wherein the trusted source can be, for example, at least one of an individual, an enterprise, an algorithm associated with at least one of the client application, an external age verification compliance agency, and a government agency.

Many implementations include a method of verifying an age of a subject to be linked with a subject account, the subject account being linked with a client application executable on a mobile computing device, wherein the method further includes verifying the age of the subject and verifying the identity of the subject. The age verification for the subject can further include receiving a verification request in dependence on an action performed by the subject, inspecting a documentation source that identifies the subject, the documentation source further comprising a proof of age of the subject, and transmitting an age verification confirmation to be stored in association with the subject account. The identity verification for the subject can further include receiving an identification input associated with the subject, the identification input further comprising a knowledge factor, a possession factor, or an inherence factor, transmitting an identity verification confirmation to be stored in association with the subject account, and binding the age verification confirmation and the identity verification confirmation to generate a relationship between the identification input and the age of the subject, wherein the relationship between the identification input and the age of the subject indicates that the identification input can be used to verify the age of the subject.

Various implementations further include an age verification process for a subject wherein the documentation source is at least one of a state-issued identification card, a driver's license, and an alternate proof-of-age documentation format, and wherein the documentation source is verifiable by at least one of a government entity and an alternate regulatory body bestowed an authority to confirm proof-of-age in accordance with at least one law, ordinance, or rule. The documentation source can be used to confirm the age of the subject, wherein the age verification confirmation is at least one of a date of birth of the subject, a present age of the subject, and a binary variable related to the age of the subject meeting a minimum required age, wherein the binary variable is an indicator that the present age of the subject is equivalent to or older than the minimum required age associated with an age-restricted action, or that the present age of the subject is younger than the minimum required age associated with the age-restricted action.

Many implementations of the technology disclosed may include the shopper initiating a function within their client application on their mobile device (e.g., mediated by a server). A shopper may explicitly initiate a function, such as the input of a made-to-order food item. A shopper may also implicitly initiate a function, such as the act of taking an item off the shelf and placing it into their cart or basket, thereby initiating the addition of the item into an item log data structure (i.e., a digital cart that tracks items taken by the shopper in order to facilitate autonomous checkout). Some shopper functions may require an access permission associated with an access management process.

In one implementation, the access management to a function is associated with an autonomous shopping environment. The autonomous shopping method includes tracking the subject in an area of real space such that at least two cameras with overlapping fields of view capture images of inventory locations and subjects' paths in the area of real space, accessing a master product catalog to detect items taken by the subject from inventory locations in the area of real space wherein a master product catalog contains attributes of inventory items placed on inventory display structures in the area of real space, receiving images and data of items captured by the subject, using a mobile device, in the area of real space and processing the images and the data of items received from the subject to update the master product catalog, processing images received from the cameras to detect items taken by the subject in the area of real space and updating a respective item log data structure of the subject to record items taken by the subject, detecting exit of the subject from the area of real space, and generating respective digital receipts for the subject including data of items taken by the subject in the area of real space wherein the data of items includes at least one of an item identifier, an item label, a quantity per item, a price per item. The function associated with the client application may correspond to an addition of an item to the respective item log data structure of the subject.

In certain implementations, the subject may attempt to perform an age-restricted action (e.g., purchasing of alcohol or tobacco) that is managed by an access permission. Managing of the permission associated with the age-restricted action can further include defining the minimum required age to initiate the age-restricted action, wherein a subject at the same age or an older age than the minimum required age can be provisioned the permission associated with the age-restricted action, granting the subject the permission associated with the age-restricted action, and implementing an identification check as a prerequisite to initiate the age-restricted function. The identification check can include, for example, requesting (from the subject) the identification input, processing the identification input to receive, as output, the age of the subject bound to the identity of the subject, transmitting an approval for the identification check, and allowing the subject to initiate the age-restricted function. In such implementations, the age-restricted action enables the subject to initiate the age-restricted product or service while bypassing exchange of the documentation source with an entity for manual review. In practice, this may involve the server triggering an authentication request in response to the shopper placing a bottle of wine in their shopping cart, the shopper providing a Face-ID input to their mobile computing device in order to authenticate their identity, and if authentication is successful, the server will grant permission for the shopper to purchase the wine if the shopper has been previously authorized following age verification. In various implementations, the identification input is at least one of a facial structure measurement, a fingerprint measurement, a retinal measurement, voice recognition, a physical keystore, a passcode, a password, and a personal identification number.

In some implementations, an authentication and authorization protocol is used by the server to monitor subjects interacting with an age-restricted function. In other implementations, the age verification process is further monitored using a zone monitoring technique. For example, areas of the store that contain alcohol can be monitored as a tracking zone using zone monitoring in order to review and audit subject interactions with alcohol products and flag interactions that involve an alcoholic product and an identified subject that has not successfully completed age verification. In another example, the checkout counter can be monitored using zone monitoring in order to review and audit employee checkout processes involving age restricted products and flag interactions that involve an employee facilitating a checkout process without confirming the age of the subject.

Some customers that provide an autonomous (i.e., cashier-less) shopping environment to their shoppers may opt to not include an age verification technique for cashier-less purchase of age-restricted products (e.g., a lack of practicality due to low sales of said products, cost or bandwidth concerns, local legality limitations, and so on) and instead choose to provide a semi-autonomous experience wherein customers may shop autonomously if they are not purchasing restricted items, but customers must engage in some level of interaction with a store employee or CSR in order to purchase a restricted item. In some implementations, this may involve manual review of the subject's age and identity by a CSR, followed by the CSR approving the restricted item in the subject's cart and enabling the subject to continue shopping autonomously. In other implementations, this may involve executing the sales transaction for the restricted item at the checkout with facilitation from a CSR. In many implementations, zone monitoring can be implemented as a form of security review and auditing for checkout counters and/or areas of the store displaying restricted products.

A method is disclosed herein for managing subject access to a restricted function, the subject linked to a subject account and the subject account linked to a client application associated with the restricted function, including receiving, from the client application, an access request to the restricted function, determining a prerequisite associated with the restricted function, evaluating the access request to determine when the prerequisite for the restricted function is met, and granting the subject access to the restricted function. The prerequisite for the restricted function is a subject access privilege prerequisite, and the access management can include authentication, authorization, and granting the subject access to the restricted function. Authentication further includes obtaining an authentication factor associated with the subject, processing the authentication factor to verify the identity of the subject, and approving the authentication of the identity of the subject. Authorization further includes detecting an access privilege associated with the subject account, evaluating the access privilege to confirm whether the prerequisite is met, wherein the prerequisite is met when the access privilege indicates the subject account has been delegated access to the restricted function, and granting the subject access to the restricted function.

In another implementation, a function associated with the shopper placing an item in their cart can be restricted if the action bypasses successful computer vision detection (e.g., the item cannot clearly be identified). Such an implementation may further include optimization of the camera map and/or the adjustment of camera masking. Some implementations may include restricted functions that require an external interaction with a CSR prior to obtaining a purchased item, such as items stored in locked cases like tobacco products, pre-ordered hot food items, or third-party mediated orders that involve a delivery courier picking up a shopping order on behalf of the shopper. Some implementations include recording the restricted function within the respective item log data structure for the subject, wherein the recording of the restricted function further comprises recording data associated with the interaction with the external authority. For example, updating the respective item log data structure of the subject can further include the external authority injecting the restricted function into the respective item log data structure, bypassing camera detection (e.g., a CSR taking an order for a made-to-order hot food item or manually overriding a system error resulting in inconsistency between the shopper's physical cart and the item log in their digital cart).

Any data structures and code described or referenced above are stored according to many implementations on a computer readable storage medium, which may be any device or medium that can store code and/or data for use by a computer system. This includes, but is not limited to, volatile memory, non-volatile memory, application-specific integrated circuits (ASICs), field-programmable gate arrays (FPGAs), magnetic and optical storage devices such as disk drives, magnetic tape, CDs (compact discs), DVDs (digital versatile discs or digital video discs), or other media capable of storing computer-readable media now known or later developed.

The preceding description is presented to enable the making and use of the technology disclosed. Various modifications to the disclosed implementations will be apparent, and the general principles defined herein may be applied to other implementations and applications without departing from the spirit and scope of the technology disclosed. Thus, the technology disclosed is not intended to be limited to the implementations shown, but is to be accorded the widest scope consistent with the principles and features disclosed herein. The scope of the technology disclosed is defined by the appended claims.

1. A method for self-service installation of monitoring operations in an area of real space, the method including:
scanning the area of real space, using a sensor, to generate a three-dimensional (3D) representation of the area of real space;
placing a camera at an initial location and orientation for monitoring a zone within the area of real space;
configuring a computing device to be (i) connected to a cloud network hosting an image processing service and (ii) couplable to the camera via a local connection, wherein the configuration of the computing device enables the computing device to mediate communications between the image processing service and the camera;
coupling the camera to the computing device using the local connection and a unique identifier associated with the camera; and
finetuning a placement of the camera to a calibrated location and orientation for monitoring the zone within the area of real space, wherein the finetuning is assisted by information received from a cloud-based application associated with the image processing service.

2. The method of claim 1, further including identifying a region of interest within the monitored zone based on an output received from an object classification model, wherein: the region of interest is a 3D space at which a particular object is expected to be located, and the output of the object classification model is determined by processing, as input, the 3D representation of the area of real space and a flattened 2D image produced from RGB data corresponding to respective points in the 3D representation of the area of real space.

3. The method of claim 2, further including identifying updated regions of interest based on one or more updated images of the area of real space.

4. The method of claim 2, wherein the monitored zone comprises a location within shelving at which a corresponding inventory item is expected to be found, and wherein the method includes:
receiving the 3D representation of the area of real space and the flattened 2D image of the area of real space;
processing the received the 3D representation of the area of real space and the flattened 2D image of the area of real space using the object classification model to identify a region of interest within the monitored zone, wherein the region of interest corresponds to a location for an expected inventory item;
generating a label for the region of interest comprising one or more of (i) a set of boundaries indicating a location of the region of interest and (ii) an identifier of the expected inventory item for the region of interest; and
storing the label for the region of interest at the location of the region of interest within a field of view of the camera.

5. The method of claim 4, further including:
processing captured images, labelled with the label for the region of interest, to detect a presence of an inventory item at the region of interest;
in response to a detection of no inventory item being present at the region of interest, determining, that the region of interest is empty facing; and
generating a report for the empty facing region of interest.

6. The method of claim 5, further including:
processing the subsequent image, that is labelled for a plurality of regions of interest corresponding to a plurality of locations for a particular inventory item;
in response to determining that each of the plurality of regions of interest is empty facing, further determining that the particular inventory item is out of stock; and
generating a report for the out of stock inventory item.

7. The method of claim 4, further including:
processing the subsequent images, labelled for the region of interest, to detect a presence of an inventory item at the region of interest;
in response to a detection of the inventory item being present at the region of interest, determining whether the detected inventory item matches the expected inventory item, wherein (i) in response to the detected inventory item matching the expected inventory item, further determining that the expected inventory item is correctly stocked, and (ii) in response to the detected inventory item not matching the expected inventory item, further determining that the detected inventory item is incorrectly stocked; and
generating a report for one or more of: (i) a correctly inventory item and (ii) an incorrectly stocked inventory item.

8. The method of claim 1, further including: provisioning and initializing an instance of the cloud network, configuring network and IP management processes for the cloud network; installing a node cluster configured to schedule and run a plurality of cloud containers; and connecting the computing device to the cloud network using an ephemeral wireless connection.

9. The method of claim 1, further including, for a plurality of cameras with overlapping corresponding fields of view connected to the computing device: processing respective sequences of frames of the overlapping corresponding fields of view to detect an occlusion in at least one field of view corresponding to a camera of the plurality of cameras, and generating a factored image, wherein the generation of the factored images includes factoring that results in the detected occlusion being patched based on at least one other field of view corresponding to another camera of the plurality of cameras.

10. The method of claim 1, further including storing, in an image storage, images captured by the camera.

11. The method of claim 1, further including storing, in a region of interest database, at least one identified region of interest within the monitored zone.

12. The method of claim 1, wherein the computing device is a power over ethernet (POE) sitebox.

13. A system including one or more processors and memory accessible by the processors, the memory loaded with computer instructions self-service installation of monitoring operations in an area of real space, which computer instructions, when executed on the processors, implement actions comprising:
scanning the area of real space, using a sensor, to generate a three-dimensional (3D) representation of the area of real space;
placing a camera at an initial location and orientation for monitoring a zone within the area of real space;
configuring a computing device to be (i) connected to a cloud network hosting an image processing service and (ii) couplable to the camera via a local connection, wherein the configuration of the computing device enables the computing device to mediate communications between the image processing service and the camera;
coupling the camera to the computing device using the local connection and a unique identifier associated with the camera; and
finetuning a placement of the camera to a calibrated location and orientation for monitoring the zone within the area of real space, wherein the finetuning is assisted by information received from a cloud-based application associated with the image processing service.

14. The system of claim 13, further including identifying a region of interest within the monitored zone based on an output received from an object classification model, wherein: the region of interest is a 3D space at which a particular object is expected to be located, and the output of the object classification model is determined by processing, as input, the 3D representation of the area of real space and a flattened 2D image produced from RGB data corresponding to respective points in the 3D representation of the area of real space.

15. The system of claim 14, wherein the monitored zone comprises a location within shelving at which a corresponding inventory item is expected to be found, and further including:
receiving the 3D representation of the area of real space and the flattened 2D image of the area of real space;
processing the 3D representation of the area of real space and the flattened 2D image using the object classification model to identify a region of interest within the monitored zone, wherein the region of interest corresponds to a location for an expected inventory item;
generating a label for the region of interest comprising one or more of (i) a set of boundaries indicating a location of the region of interest and (ii) an identifier of the expected inventory item for the region of interest; and
storing the label for the region of interest at the location of the region of interest within a field of view of the camera.

16. The system of claim 15, further including:
processing captured images, labelled with the label for the region of interest, to detect a presence of an inventory item at the region of interest;
in response to a detection of no inventory item being present at the region of interest, determining, that the region of interest is empty facing; and
generating a report for the empty facing region of interest.

17. A non-transitory computer readable storage medium impressed with computer program instructions for self-service installation of monitoring operations in an area of real space, which computer program instructions when executed implement a method comprising:
scanning the area of real space, using a sensor, to generate a three-dimensional (3D) representation of the area of real space;
placing a camera at an initial location and orientation for monitoring a zone within the area of real space;
configuring a computing device to be (i) connected to a cloud network hosting an image processing service and (ii) couplable to the camera via a local connection, wherein the configuration of the computing device enables the computing device to mediate communications between the image processing service and the camera;
coupling the camera to the computing device using the local connection and a unique identifier associated with the camera; and
finetuning a placement of the camera to a calibrated location and orientation for monitoring the zone within the area of real space, wherein the finetuning is assisted by information received from a cloud-based application associated with the image processing service.

18. The non-transitory computer readable medium of claim 17, further including identifying a region of interest within the monitored zone based on an output received from an object classification model, wherein: the region of interest is a 3D space at which a particular object is expected to be located, and the output of the object classification model is determined by processing, as input, the 3D representation of the area of real space and a flattened 2D image produced from RGB data corresponding to respective points in the 3D representation of the area of real space.

19. The non-transitory computer readable medium of claim 17, further including: provisioning and initializing an instance of the cloud network, configuring network and IP management processes for the cloud network; installing a node cluster configured to schedule and run a plurality of cloud containers; and connecting the computing device to the cloud network using an ephemeral wireless connection.

20. The non-transitory computer readable medium of claim 17, further including, for a plurality of cameras with overlapping corresponding fields of view connected to the computing device: processing respective sequences of frames of the overlapping corresponding fields of view to detect an occlusion in at least one field of view corresponding to a camera of the plurality of cameras, and generating a factored image, wherein the generation of the factored images includes factoring that results in the detected occlusion being patched based on at least one other field of view corresponding to another camera of the plurality of cameras.
